(19) United States
(12) Patent Application Publication
(10) Pub. No.: US 2021/0329214 A1
(43) Pub. Date: Oct. 21, 2021

(54) AN APPARATUS FOR TRANSMITTING A VIDEO, A METHOD FOR TRANSMITTING A VIDEO, AN APPARATUS FOR RECEIVING A VIDEO, AND A METHOD FOR RECEIVING A VIDEO

(71) Applicant: LG ELECTRONICS INC., Seoul (KR)

(72) Inventors: Hyunmook OH, Seoul (KR); Sejin OH, Seoul (KR)

(21) Appl. No.: 17/267,724

(22) PCT Filed: Oct. 1, 2019
(86) PCT No.: PCT/KR2019/012800

§ 371 Date: Feb. 10, 2021

(30) Foreign Application Priority Data
Oct. 4, 2018 (KR) 10-2018-0118453

(51) Int. Cl. H04N 13/161; H04N 13/194; H04N 13/178; H04N 13/156; H04N 13/111

(52) U.S. Cl. CPC H04N 13/161; H04N 13/194; H04N 13/111; H04N 13/156; H04N 13/178

(57) ABSTRACT

In accordance with embodiments, a decoder may be referred to as a receiver to decode video data and/or signaling information in accordance with embodiments. The decoder may be interpreted on the ground of some embodiments of the disclosure and can provide effects of efficient decoding performance and regenerating view performance.

In accordance with embodiments, an encoder may be referred to as a transmitter to encode video data and/or signaling information in accordance with embodiments. The encoder may be interpreted on the ground of some embodiments of the disclosure and can provide effects of efficient encoding performance and transmitting performance.

### TECHNICAL FIELD

Embodiments is related to an apparatus for transmitting a video, a method for transmitting a video, an apparatus for receiving a video, and a method for receiving a video.

### BACKGROUND ART

A virtual reality (VR) system provides a user with sensory experiences through which the user may feel as if he/she were in an electronically projected environment. A system for providing VR may be further improved in order to provide higher-quality images and spatial sound. Such a VR system may enable the user to interactively enjoy VR content.

### DISCLOSURE

### Technical Problem

VR systems need to be improved in order to more efficiently provide a user with a VR environment. To this end, it is necessary to propose plans for data transmission efficiency for transmitting a large amount of data such as VR content, robustness between transmission and reception networks, network flexibility considering a mobile reception apparatus, and efficient reproduction and signaling.

Also, since general Timed Text Markup Language (TTML) based subtitles or bitmap based subtitles are not created in consideration of 360-degree video, it is necessary to extend subtitle related features and subtitle related signaling information to be adapted to use cases of a VR service in order to provide subtitles suitable for 360-degree video.

### Technical Solution

In order to solve the technical problem, Embodiments provides an apparatus for transmitting video data, the apparatus comprising: a packer configured to pack pictures in video data for viewing positions; and/or an encoder configured to encode the packed pictures based on signaling information, and an apparatus for receiving a video, the apparatus comprising: a decoder configured to decode a bitstream based on viewing position information and viewport information; an un-packer configured to un-pack pictures in the decoded bitstream based on packing metadata; a view regenerator configured to regenerate pictures for viewing position from the un-packed pictures based on reconstruction parameters; and a view synthesizer configured to synthesize a picture of a target viewing position from the regenerated pictures based on view synthesis parameters.

### Advantageous Effects

The apparatus for transmitting a video and the apparatus for receiving a video according to the embodiments of embodiments may provide effects as follows:

In accordance with embodiments, a decoder may be referred to as a receiver to decode video data and/or signaling information in accordance with embodiments. The decoder may be interpreted on the ground of some embodiments of the disclosure and can provide effects of efficient decoding performance and regenerating view performance.

In accordance with embodiments, an encoder may be referred to as a transmitter to encode video data and/or signaling information in accordance with embodiments. The encoder may be interpreted on the ground of some embodiments of the disclosure and can provide effects of efficient encoding performance and transmitting performance.

### DESCRIPTION OF DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates an architecture for providing 360 video according to embodiments.

FIG. 2 illustrates a 360 video transmission apparatus according to one aspect of embodiments.

FIG. 3 illustrates a 360 video reception apparatus according to another aspect of embodiments.

FIG. 4 illustrates a 360 video transmission apparatus/360 video reception apparatus according to embodiments.

FIG. 5 illustrates the concept of aircraft principal axes for describing a 3D space of embodiments.

FIG. 6 illustrates projection schemes according to embodiments.

FIG. 7 illustrates tiles according to embodiments.

FIG. 8 illustrates 360 video related metadata according to embodiments.

FIG. 9 is a view showing a viewpoint and viewing position additionally defined in a 3DoF+ VR system;

FIG. 10 is a view showing a method for implementing 360-degree video signal processing and related transmission apparatus/reception apparatus based on 3DoF+ system;

FIG. 11 is a view showing an architecture of a 3DoF+ end-to-end system;

FIG. 12 is a view showing an architecture of a Frame for Live Uplink Streaming (FLUS);

FIG. 13 is a view showing a configuration of 3DoF+ transmission side;

FIG. 14 is a view showing a configuration of 3DoF+ reception side;

FIG. 15 is a view showing an OMAF structure;

FIG. 16 is a view showing a type of media according to movement of a user;

FIG. 17 is a view showing the entire architecture for providing 6DoF video;

FIG. 18 is a view showing a configuration of a transmission apparatus for providing 6DoF video services;

FIG. 19 is a view showing a configuration of 6DoF video reception apparatus;

FIG. 20 is a view showing a configuration of 6DoF video transmission/reception apparatus;

FIG. 21 is a view showing 6DoF space; FIG. 22 illustrates conceptual comparison of 3DoF VR/AR video without/with head motion parallax.

FIG. 22 is conceptual comparison of 3DoF VR/AR video without/with head motion parallax in accordance with embodiments.

FIG. 23 is a content flow process for omnidirectional media with projected video of 3DoF in accordance with embodiments.

FIG. 24 is sparse view regeneration information SEI message syntax in accordance with embodiments.

FIG. 25 is Viewing position group information SEI message syntax in accordance with embodiments.

FIG. 26 is an example end-to-end flow chart of multi-view 3DoF+ video in accordance with embodiments.

FIG. 27 is an example implementation of pre-encoding process for multi-views 3DoF+ video in accordance with embodiments.

FIG. 28 is an example implementation of post-decoder process for multi-views 3DoF+ video in accordance with embodiments.

FIG. 29 is an example block diagram of encoder pre-processing in accordance with embodiments.

FIG. 30 is an example block diagram of decoder post-processing in accordance with embodiments.

FIG. 31 is an example block diagram of encoder pre-processing: detailed description of inter-view redundancy removal in accordance with embodiments.

FIG. 32 is detailed description of view regeneration in the post-processing in accordance with embodiments.

FIG. 33 is block diagram of 3DoF+ SW platform in accordance with embodiments.

FIG. 34 is an example of encoder pre-processing scheme with pruning module in accordance with embodiments.

FIG. 35 is an example of decoder post-processing scheme with view generation in accordance with embodiments.

FIG. 36 is an example of encoder pre-processing scheme with pruning module and sparse view selection module in accordance with embodiments.

FIG. 37 is an example of efficient decoder post-processing scheme with view generation by replacing reference view with the regenerated view in accordance with embodiments.

FIG. 38 is an example of encoder pre-processing scheme with pruning module and sparse view pruning in accordance with embodiments.

FIG. 39 is an example of decoder post-processing scheme with view regeneration and sparse view regeneration in accordance with embodiments (sparse_view_regeneration_type=1).

FIG. 40 is an example of decoder post-processing scheme with view regeneration and sparse view regeneration in accordance with embodiments (sparse_view_regeneration_type=2).

FIG. 41 is an example of decoder post-processing scheme with view regeneration and sparse view regeneration in accordance with embodiments (sparse_view_regeneration_type=3).

FIG. 42 is an example of decoder post-processing scheme with view regeneration and sparse view regeneration in accordance with embodiments (sparse_view_regeneration_type=4).

FIG. 43 is a flowchart in accordance with embodiments.

FIG. 44 is a flowchart in accordance with embodiments.

### BEST MODE

Reference will now be made in detail to embodiments, examples of which are illustrated in the accompanying drawings. The detailed description, which will be given below with reference to the accompanying drawings, is intended to explain exemplary embodiments of embodiments, rather than to show the only embodiments that can be implemented according to embodiments. The following detailed description includes specific details in order to provide a thorough understanding of embodiments. However, it will be apparent to those skilled in the art that embodiments may be practiced without such specific details.

Although most terms used in embodiments have been selected from general ones widely used in the art, some terms have been arbitrarily selected by the applicant and their meanings are explained in detail in the following description as needed. Thus, embodiments should be understood based upon the intended meanings of the terms rather than their simple names or meanings.

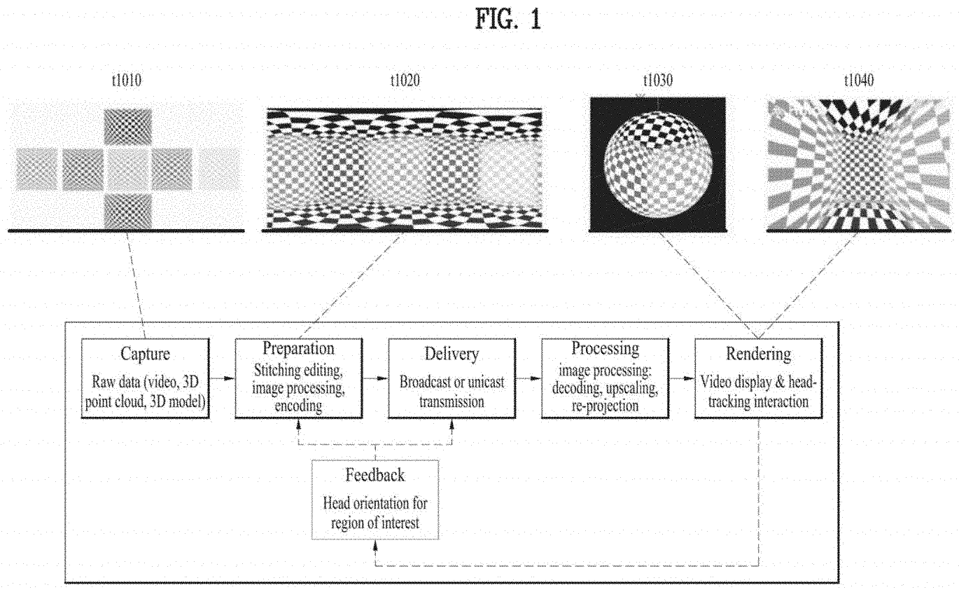

FIG. 1 illustrates an architecture for providing 360 video according to embodiments. Embodiments provides a method for providing 360 content to provide VR (Virtual Reality) to users. VR refers to a technique or an environment for replicating an actual or virtual environment. VR artificially provides sensuous experiences to users, and users can experience electronically projected environments.

360 content refers to convent for realizing and providing VR and may include 360 video and/or 360 audio. 360 video may refer to video or image content which is necessary to provide VR and is captured or reproduced in all directions (360 degrees). 360 video can refer to video or image represented on 3D spaces in various forms according to 3D models. For example, 360 video can be represented on a spherical plane. 360 audio is audio content for providing VR and can refer to spatial audio content which can be recognized as content having an audio generation source located on a specific space. 360 content can be generated, processed and transmitted to users, and users can consume VR experiences using the 360 content.

Embodiments proposes a method for effectively providing 360 video. To provide 360 video, first, 360 video can be captured using one or more cameras. The captured 360 video is transmitted through a series of processes, and a receiving side can process received data into the original 360 video and render the 360 video. Accordingly, the 360 video can be provided to a user.

Specifically, a procedure for providing 360 video may include a capture process, a preparation process, a transmission process, a processing process, a rendering process and/or a feedback process.

The capture process may refer to a process of capturing images or videos for a plurality of views through one or more cameras. The shown image/video data t1010 can be generated through the capture process. Each plane of the shown image/video data t1010 can refer to an image/video for each view. The captured images/videos may be called raw data. In the capture process, metadata related to capture can be generated.

For capture, a special camera for VR may be used. When 360 video with respect to a virtual space generated using a computer is provided in an embodiment, capture using a camera may not be performed. In this case, the capture process may be replaced by a process of simply generating related data.

The preparation process may be a process of processing the captured images/videos and metadata generated in the capture process. The captured images/videos may be subjected to stitching, projection, region-wise packing and/or encoding in the preparation process.

First, each image/video may pass through a stitching process. The stitching process may be a process of connecting captured images/videos to create a single panorama image/video or a spherical image/video.

Then, the stitched images/videos may pass through a projection process. In the projection process, the stitched images/videos can be projected on a 2D image. This 2D image may be called a 2D image frame. Projection on a 2D image may be represented as mapping to the 2D image. The projected image/video data can have a form of a 2D image t1020 as shown in the figure.

The video data projected on the 2D image can pass through a region-wise packing process in order to increase video coding efficiency. Region-wise packing may refer to a process of dividing video data projected on a 2D image into regions and processing the regions. Here, regions may refer to regions obtained by dividing a 2D image on which 360 video data is projected. Such regions can be obtained by dividing the 2D image equally or arbitrarily according to an embodiment. Regions may be divided according to a projection scheme according to an embodiment. The region-wise packing process is an optional process and thus may be omitted in the preparation process.

According to an embodiment, this process may include a process of rotating the regions or rearranging the regions on the 2D image in order to increase video coding efficiency. For example, the regions can be rotated such that specific sides of regions are positioned in proximity to each other to increase coding efficiency.

According to an embodiment, the this process may include a process of increasing or decreasing the resolution of a specific region in order to differentiate the resolution for regions of the 360 video. For example, the resolution of regions corresponding to a relatively important part of the 360 video can be increased to higher than other regions. The video data projected on the 2D image or the region-wise packed video data can pass through an encoding process using a video codec.

According to an embodiment, the preparation process may additionally include an editing process. In this editing process, the image/video data before or after projection may be edited. In the preparation process, metadata with respect to stitching/projection/encoding/editing may be generated. In addition, metadata with respect to the initial view or ROI (region of interest) of the video data projected on the 2D image may be generated.

The transmission process may be a process of processing and transmitting the image/video data and metadata which have pass through the preparation process. For transmission, processing according to an arbitrary transmission protocol may be performed. The data that has been processed for transmission can be delivered over a broadcast network and/or broadband. The data may be delivered to a receiving side in an on-demand manner. The receiving side can receive the data through various paths.

The processing process refers to a process of decoding the received data and re-projecting the projected image/video data on a 3D model. In this process, the image/video data projected on the 2D image can be re-projected on a 3D space. This process may be called mapping projection. Here, the 3D space on which the data is mapped may have a form depending on a 3D model. For example, 3D models may include a sphere, a cube, a cylinder and a pyramid.

According to an embodiment, the processing process may further include an editing process, an up-scaling process, etc. In the editing process, the image/video data before or after re-projection can be edited. When the image/video data has been reduced, the size of the image/video data can be increased through up-scaling of samples in the up-scaling process. As necessary, the size may be decreased through down-scaling.

The rendering process may refer to a process of rendering and displaying the image/video data re-projected on the 3D space. Re-projection and rendering may be collectively represented as rendering on a 3D mode. The image/video re-projected (or rendered) on the 3D model may have a form t1030 as shown in the figure. The form t1030 corresponds to a case in which the image/video data is re-projected on a spherical 3D model. A user can view a region of the rendered image/video through a VR display or the like. Here, the region viewed by the user may have a form t1040 shown in the figure.

The feedback process may refer to a process of delivering various types of feedback information which can be acquired in the display process to a transmission side. Through the feedback process, interactivity in 360 video consumption can be provided. According to an embodiment, head orientation information, viewport information indicating a region currently viewed by a user, etc. can be delivered to the transmission side in the feedback process. According to an embodiment, a user can interact with content realized in a VR environment. In this case, information related to the interaction may be delivered to the transmission side or a service provider during the feedback process. According to an embodiment, the feedback process may not be performed.

The head orientation information may refer to information about the position, angle and motion of a user's head. On the basis of this information, information about a region of 360 video currently viewed by the user, that is, viewport information can be calculated.

The viewport information may be information about a region of 360 video currently viewed by a user. Gaze analysis may be performed using the viewport information to check a manner in which the user consumes 360 video, a region of the 360 video at which the user gazes, and how long the user gazes at the region. Gaze analysis may be performed by the receiving side and the analysis result may be delivered to the transmission side through a feedback channel. An apparatus such as a VR display can extract a viewport region on the basis of the position/direction of a user's head, vertical or horizontal FOV supported by the apparatus, etc.

According to an embodiment, the aforementioned feedback information may be consumed at the receiving side as well as being delivered to the transmission side. That is, decoding, re-projection and rendering processes of the receiving side can be performed using the aforementioned feedback information. For example, only 360 video with respect to the region currently viewed by the user can be preferentially decoded and rendered using the head orientation information and/or the viewport information.

Here, a viewport or a viewport region can refer to a region of 360 video currently viewed by a user. A viewpoint is a point in 360 video which is viewed by the user and can refer to a center point of a viewport region. That is, a viewport is a region based on a view, and the size and form of the region can be determined by FOV (field of view) which will be described below.

In the above-described architecture for providing 360 video, image/video data which is subjected to a series of capture/projection/encoding/transmission/decoding/re-projection/rendering processes can be called 360 video data. The term “360 video data” may be used as the concept including metadata or signaling information related to such image/video data.

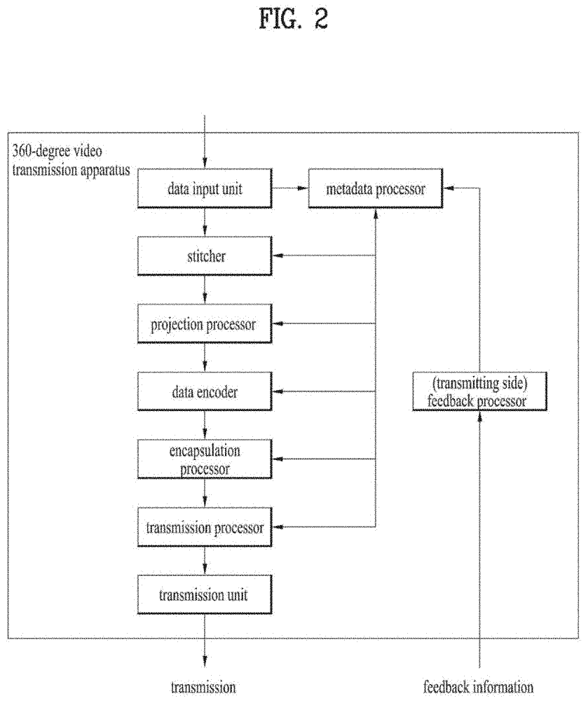

FIG. 2 illustrates a 360 video transmission apparatus according to embodiments.

According to one aspect, embodiments can relate to a 360 video transmission apparatus. The 360 video transmission apparatus according to embodiments can perform operations related to the above-described preparation process to the transmission process. The 360 video transmission apparatus according to embodiments may include a data input unit, a stitcher, a projection processor, a region-wise packing processor (not shown), a metadata processor, a transmitter feedback processor, a data encoder, an encapsulation processor, a transmission processor and/or a transmitter as internal/external elements.

The data input unit may receive captured images/videos for respective views. The images/videos for the views may be images/videos captured by one or more cameras. In addition, the data input unit may receive metadata generated in a capture process. The data input unit may deliver the received images/videos for the views to the stitcher and deliver the metadata generated in the capture process to a signaling processor.

The stitcher may stitch the captured images/videos for the views. The stitcher can deliver the stitched 360 video data to the projection processor. The stitcher may receive necessary metadata from the metadata processor and use the metadata for stitching operation. The stitcher may deliver the metadata generated in the stitching process to the metadata processor. The metadata in the stitching process may include information indicating whether stitching has been performed, a stitching type, etc.

The projection processor can project the stitched 360 video data on a 2D image. The projection processor can perform projection according to various schemes which will be described below. The projection processor can perform mapping in consideration of the depth of 360 video data for each view. The projection processor may receive metadata necessary for projection from the metadata processor and use the metadata for the projection operation as necessary. The projection processor may deliver metadata generated in a projection process to the metadata processor. The metadata of the projection process may include a projection scheme type.

The region-wise packing processor (not shown) can perform the aforementioned region-wise packing process. That is, the region-wise packing processor can perform a process of dividing the projected 360 video data into regions, rotating or rearranging the regions or changing the resolution of each region. As described above, the region-wise packing process is an optional process, and when region-wise packing is not performed, the region-wise packing processor can be omitted. The region-wise packing processor may receive metadata necessary for region-wise packing from the metadata processor and use the metadata for the region-wise packing operation as necessary. The metadata of the region-wise packing processor may include a degree to which each region is rotated, the size of each region, etc.

The aforementioned stitcher, the projection processor and/or the region-wise packing processor may be realized by one hardware component according to an embodiment.

The metadata processor can process metadata which can be generated in the capture process, the stitching process, the projection process, the region-wise packing process, the encoding process, the encapsulation process and/or the processing process for transmission. The metadata processor can generate 360 video related metadata using such metadata. According to an embodiment, the metadata processor may generate the 360 video related metadata in the form of a signaling table. The 360 video related metadata may be called metadata or 360 video related signaling information according to signaling context. Furthermore, the metadata processor can deliver acquired or generated metadata to internal elements of the 360 video transmission apparatus as necessary. The metadata processor may deliver the 360 video related metadata to the data encoder, the encapsulation processor and/or the transmission processor such that the metadata can be transmitted to the receiving side.

The data encoder can encode the 360 video data projected on the 2D image and/or the region-wise packed 360 video data. The 360 video data can be encoded in various formats.

The encapsulation processor can encapsulate the encoded 360 video data and/or 360 video related metadata into a file. Here, the 360 video related metadata may be delivered from the metadata processor. The encapsulation processor can encapsulate the data in a file format such as ISOBMFF, CFF or the like or process the data into a DASH segment. The encapsulation processor may include the 360 video related metadata in a file format according to an embodiment. For example, the 360 video related metadata can be included in boxes of various levels in an ISOBMFF file format or included as data in an additional track in a file. The encapsulation processor can encapsulate the 360 video related metadata into a file according to an embodiment. The transmission processor can perform processing for transmission on the 360 video data encapsulated in a file format. The transmission processor can process the 360 video data according to an arbitrary transmission protocol. The processing for transmission may include processing for delivery through a broadcast network and processing for delivery over a broadband. According to an embodiment, the transmission processor may receive 360 video related metadata from the metadata processor in addition to the 360 video data and perform processing for transmission on the 360 video related metadata.

The transmission unit can transmit the processed 360 video data and/or the 360 video related metadata over a broadcast network and/or broadband. The transmission unit can include an element for transmission over a broadcast network and an element for transmission over a broadband.

According to an embodiment of the 360 video transmission apparatus according to embodiments, the 360 video transmission apparatus may further include a data storage unit (not shown) as an internal/external element. The data storage unit may store the encoded 360 video data and/or 360 video related metadata before delivery thereof. Such data may be stored in a file format such as ISOBMFF. When 360 video is transmitted in real time, the data storage unit may not be used. However, 360 video is delivered on demand, in non-real time or over a broadband, encapsulated 360 data may be stored in the data storage unit for a predetermined period and transmitted.

According to another embodiment of the 360 video transmission apparatus according to embodiments, the 360 video transmission apparatus may further include a transmitter feedback processor and/or a network interface (not shown) as internal/external elements. The network interface can receive feedback information from a 360 video reception apparatus according to embodiments and deliver the feedback information to the transmitter feedback processor. The transmitter feedback processor can deliver the feedback information to the stitcher, the projection processor, the region-wise packing processor, the data encoder, the encapsulation processor, the metadata processor and/or the transmission processor. The feedback information may be delivered to the metadata processor and then delivered to each internal element according to an embodiment. Upon reception of the feedback information, internal elements can reflect the feedback information in 360 video data processing.

According to another embodiment of the 360 video transmission apparatus according to embodiments, the region-wise packing processor can rotate regions and map the regions on a 2D image. Here, the regions can be rotated in different directions at different angles and mapped on the 2D image. The regions can be rotated in consideration of neighboring parts and stitched parts of the 360 video data on the spherical plane before projection. Information about rotation of the regions, that is, rotation directions and angles can be signaled using 360 video related metadata. According to another embodiment of the 360 video transmission apparatus according to embodiments, the data encoder can perform encoding differently on respective regions. The data encoder can encode a specific region with high quality and encode other regions with low quality. The feedback processor at the transmission side can deliver the feedback information received from a 360 video reception apparatus to the data encoder such that the data encoder can use encoding methods differentiated for regions. For example, the transmitter feedback processor can deliver viewport information received from a receiving side to the data encoder. The data encoder can encode regions including a region indicated by the viewport information with higher quality (UHD) than other regions.

According to another embodiment of the 360 video transmission apparatus according to embodiments, the transmission processor can perform processing for transmission differently on respective regions. The transmission processor can apply different transmission parameters (modulation orders, code rates, etc.) to regions such that data delivered to the regions have different robustnesses.

Here, the transmitter feedback processor can deliver the feedback information received from the 360 video reception apparatus to the transmission processor such that the transmission processor can perform transmission processing differentiated for respective regions. For example, the transmitter feedback processor can deliver viewport information received from the receiving side to the transmission processor. The transmission processor can perform transmission processing on regions including a region indicated by the viewport information such that the regions have higher robustness than other regions.

The internal/external elements of the 360 video transmission apparatus according to embodiments may be hardware elements realized by hardware. According to an embodiment, the internal/external elements may be modified, omitted, replaced by other elements or integrated with other elements. According to an embodiment, additional elements may be added to the 360 video transmission apparatus.

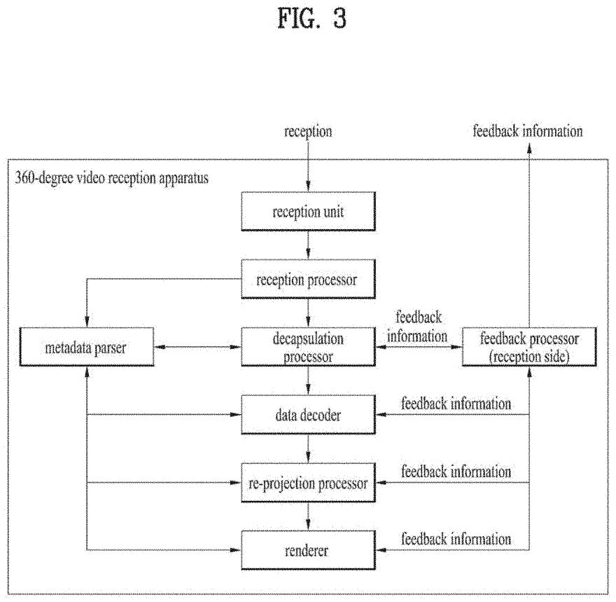

FIG. 3 illustrates a 360 video reception apparatus according to embodiments.

According to another aspect, embodiments may relate to a 360 video reception apparatus. The 360 video reception apparatus according to embodiments can perform operations related to the above-described processing process and/or the rendering process. The 360 video reception apparatus according to embodiments may include a reception unit, a reception processor, a decapsulation processor, a data decoder, a metadata parser, a receiver feedback processor, a re-projection processor and/or a renderer as internal/external elements.

The reception unit can receive 360 video data transmitted from the 360 video transmission apparatus according to embodiments. The reception unit may receive the 360 video data through a broadcast network or a broadband according to a transmission channel.

The reception processor can perform processing according to a transmission protocol on the received 360 video data. The reception processor can perform a reverse of the process of the transmission processor. The reception processor can deliver the acquired 360 video data to the decapsulation processor and deliver acquired 360 video related metadata to the metadata parser. The 360 video related metadata acquired by the reception processor may have a form of a signaling table.

The decapsulation processor can decapsulate the 360 video data in a file format received from the reception processor. The decapsulation processor can decapsulate files in ISOBMFF to acquire 360 video data and 360 video related metadata. The acquired 360 video data can be delivered to the data decoder and the acquired 360 video related metadata can be delivered to the metadata parser. The 360 video related metadata acquired by the decapsulation processor may have a form of box or track in a file format. The decapsulation processor may receive metadata necessary for decapsulation from the metadata parser as necessary.

The data decoder can decode the 360 video data. The data decoder may receive metadata necessary for decoding from the metadata parser. The 360 video related metadata acquired in the data decoding process may be delivered to the metadata parser.

The metadata parser can parse/decode the 360 video related metadata. The metadata parser can deliver the acquired metadata to the data decapsulation processor, the data decoder, the re-projection processor and/or the renderer.

The re-projection processor can re-project the decoded 360 video data. The re-projection processor can re-project the 360 video data on a 3D space. The 3D space may have different forms according to used 3D modes. The re-projection processor may receive metadata necessary for re-projection from the metadata parser. For example, the re-projection processor can receive information about the type of a used 3D model and detailed information thereof from the metadata parser. According to an embodiment, the re-projection processor may re-project only 360 video data corresponding to a specific region on the 3D space on the 3D space using the metadata necessary for re-projection.

The renderer can render the re-projected 360 video data. This may be represented as rendering of the 360 video data on a 3D space as described above. When two processes are simultaneously performed in this manner, the re-projection processor and the renderer can be integrated to perform both the processes in the renderer. According to an embodiment, the renderer may render only a region viewed by a user according to view information of the user.

A user can view part of the rendered 360 video through a VR display. The VR display is an apparatus for reproducing 360 video and may be included in the 360 video reception apparatus (tethered) or connected to the 360 video reception apparatus as a separate apparatus (un-tethered).

According to an embodiment of the 360 video reception apparatus according to embodiments, the 360 video reception apparatus may further include a (receiver) feedback processor and/or a network interface (not shown) as internal/external elements. The receiver feedback processor can acquire feedback information from the renderer, the re-projection processor, the data decoder, the decapsulation processor and/or the VR display and process the feedback information. The feedback information may include viewport information, head orientation information, gaze information, etc. The network interface can receive the feedback information from the receiver feedback processor and transmit the same to the 360 video transmission apparatus.

As described above, the feedback information may be used by the receiving side in addition to being delivered to the transmission side. The receiver feedback processor can deliver the acquired feedback information to internal elements of the 360 video reception apparatus such that the feedback information is reflected in a rendering process. The receiver feedback processor can deliver the feedback information to the renderer, the re-projection processor, the data decoder and/or the decapsulation processor. For example, the renderer can preferentially render a region viewed by a user using the feedback information. In addition, the decapsulation processor and the data decoder can preferentially decapsulate and decode a region viewed by the user or a region to be viewed by the user.

The internal/external elements of the 360 video reception apparatus according to embodiments may be hardware elements realized by hardware. According to an embodiment, the internal/external elements may be modified, omitted, replaced by other elements or integrated with other elements. According to an embodiment, additional elements may be added to the 360 video reception apparatus.

Embodiments may relate to a method of transmitting 360 video and a method of receiving 360 video. The methods of transmitting/receiving 360 video according to embodiments can be performed by the above-described 360 video transmission/reception apparatuses or embodiments thereof.

The aforementioned embodiments of the 360 video transmission/reception apparatuses and embodiments of the internal/external elements thereof may be combined. For example, embodiments of the projection processor and embodiments of the data encoder can be combined to create as many embodiments of the 360 video transmission apparatus as the number of the embodiments. The combined embodiments are also included in the scope of embodiments.

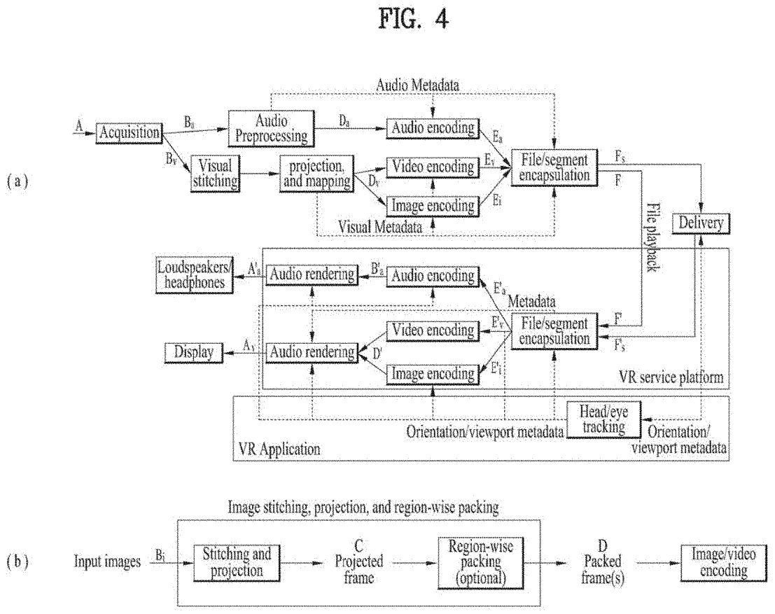

FIG. 4 illustrates a 360 video transmission apparatus/360 video reception apparatus according to embodiments.

As described above, 360 content can be provided according to the architecture shown in (a). The 360 content can be provided in the form of a file or in the form of a segment based download or streaming service such as DASH. Here, the 360 content can be called VR content.

As described above, 360 video data and/or 360 audio data may be acquired.

The 360 audio data can be subjected to audio preprocessing and audio encoding. In these processes, audio related metadata can be generated, and the encoded audio and audio related metadata can be subjected to processing for transmission (file/segment encapsulation).

The 360 video data can pass through the aforementioned processes. The stitcher of the 360 video transmission apparatus can stitch the 360 video data (visual stitching). This process may be omitted and performed at the receiving side according to an embodiment. The projection processor of the 360 video transmission apparatus can project the 360 video data on a 2D image (projection and mapping (packing)).

The stitching and projection processes are shown in (b) in detail. In (b), when the 360 video data (input images) is delivered, stitching and projection can be performed thereon. The projection process can be regarded as projecting the stitched 360 video data on a 3D space and arranging the projected 360 video data on a 2D image. In the specification, this process may be represented as projecting the 360 video data on a 2D image. Here, the 3D space may be a sphere or a cube. The 3D space may be identical to the 3D space used for re-projection at the receiving side.

The 2D image may also be called a projected frame (C). Region-wise packing may be optionally performed on the 2D image. When region-wise packing is performed, the positions, forms and sizes of regions can be indicated such that the regions on the 2D image can be mapped on a packed frame (D). When region-wise packing is not performed, the projected frame can be identical to the packed frame. Regions will be described below. The projection process and the region-wise packing process may be represented as projecting regions of the 360 video data on a 2D image. The 360 video data may be directly converted into the packed frame without an intermediate process according to design.

In (a), the projected 360 video data can be image-encoded or video-encoded. Since the same content can be present for different viewpoints, the same content can be encoded into different bit streams. The encoded 360 video data can be processed into a file format such as ISOBMFF according to the aforementioned encapsulation processor. Alternatively, the encapsulation processor can process the encoded 360 video data into segments. The segments may be included in an individual track for DASH based transmission.

Along with processing of the 360 video data, 360 video related metadata can be generated as described above. This metadata can be included in a video stream or a file format and delivered. The metadata may be used for encoding, file format encapsulation, processing for transmission, etc.

The 360 audio/video data can pass through processing for transmission according to the transmission protocol and then can be transmitted. The aforementioned 360 video reception apparatus can receive the 360 audio/video data over a broadcast network or broadband.

In (a), a VR service platform may correspond to an embodiment of the aforementioned 360 video reception apparatus. In (a), loudspeakers/headphones, display and head/eye tracking components are performed by an external apparatus or a VR application of the 360 video reception apparatus. According to an embodiment, the 360 video reception apparatus may include all of these components. According to an embodiment, the head/eye tracking component may correspond to the aforementioned receiver feedback processor.

The 360 video reception apparatus can perform processing for reception (file/segment decapsulation) on the 360 audio/video data. The 360 audio data can be subjected to audio decoding and audio rendering and provided to a user through a speaker/headphone.

The 360 video data can be subjected to image decoding or video decoding and visual rendering and provided to the user through a display. Here, the display may be a display supporting VR or a normal display.

As described above, the rendering process can be regarded as a process of re-projecting 360 video data on a 3D space and rendering the re-projected 360 video data. This may be represented as rendering of the 360 video data on the 3D space.

The head/eye tracking component can acquire and process head orientation information, gaze information and viewport information of a user. This has been described above.

A VR application which communicates with the aforementioned processes of the receiving side may be present at the receiving side.

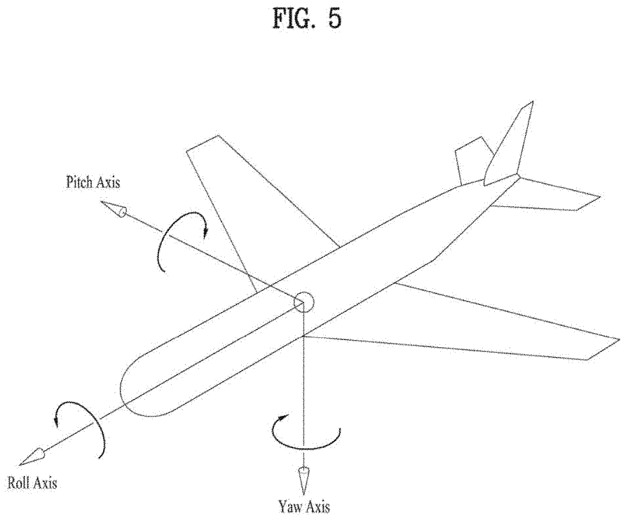

FIG. 5 illustrates the concept of aircraft principal axes for describing a 3D space of embodiments.

In embodiments, the concept of aircraft principal axes can be used to represent a specific point, position, direction, spacing and region in a 3D space.

That is, the concept of aircraft principal axes can be used to describe a 3D space before projection or after re-projection and to signal the same. According to an embodiment, a method using X, Y and Z axes or a spherical coordinate system may be used.

An aircraft can feely rotate in the three dimension. Axes which form the three dimension are called pitch, yaw and roll axes. In the specification, these may be represented as pitch, yaw and roll or a pitch direction, a yaw direction and a roll direction.

The pitch axis may refer to a reference axis of a direction in which the front end of the aircraft rotates up and down. In the shown concept of aircraft principal axes, the pitch axis can refer to an axis connected between wings of the aircraft.

The yaw axis may refer to a reference axis of a direction in which the front end of the aircraft rotates to the left/right. In the shown concept of aircraft principal axes, the yaw axis can refer to an axis connected from the top to the bottom of the aircraft.

The roll axis may refer to an axis connected from the front end to the tail of the aircraft in the shown concept of aircraft principal axes, and rotation in the roll direction can refer to rotation based on the roll axis.

As described above, a 3D space in embodiments can be described using the concept of the pitch, yaw and roll.

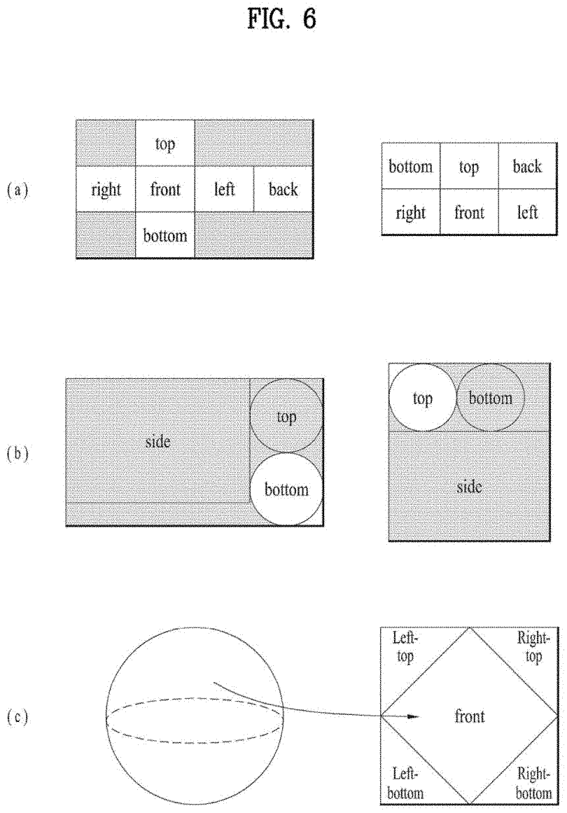

FIG. 6 illustrates projection schemes according to embodiments.

As described above, the projection processor of the 360 video transmission apparatus according to embodiments can project stitched 360 video data on a 2D image. In this process, various projection schemes can be used.

According to another embodiment of the 360 video transmission apparatus according to embodiments, the projection processor can perform projection using a cubic projection scheme. For example, stitched video data can be represented on a spherical plane. The projection processor can segment the 360 video data into a cube and project the same on the 2D image. The 360 video data on the spherical plane can correspond to planes of the cube and be projected on the 2D image as shown in (a).

According to another embodiment of the 360 video transmission apparatus according to embodiments, the projection processor can perform projection using a cylindrical projection scheme. Similarly, if stitched video data can be represented on a spherical plane, the projection processor can segment the 360 video data into a cylinder and project the same on the 2D image. The 360 video data on the spherical plane can correspond to the side, top and bottom of the cylinder and be projected on the 2D image as shown in (b).

According to another embodiment of the 360 video transmission apparatus according to embodiments, the projection processor can perform projection using a pyramid projection scheme. Similarly, if stitched video data can be represented on a spherical plane, the projection processor can regard the 360 video data as a pyramid form and project the same on the 2D image. The 360 video data on the spherical plane can correspond to the front, left top, left bottom, right top and right bottom of the pyramid and be projected on the 2D image as shown in (c).

According to an embodiment, the projection processor may perform projection using an equirectangular projection scheme and a panoramic projection scheme in addition to the aforementioned schemes.

As described above, regions can refer to regions obtained by dividing a 2D image on which 360 video data is projected. Such regions need not correspond to respective sides of the 2D image projected according to a projection scheme. However, regions may be divided such that the sides of the projected 2D image correspond to the regions and region-wise packing may be performed according to an embodiment. Regions may be divided such that a plurality of sides may correspond to one region or one side may correspond to a plurality of regions according to an embodiment. In this case, the regions may depend on projection schemes. For example, the top, bottom, front, left, right and back sides of the cube can be respective regions in (a). The side, top and bottom of the cylinder can be respective regions in (b). The front, left top, left bottom, right top and right bottom sides of the pyramid can be respective regions in (c).

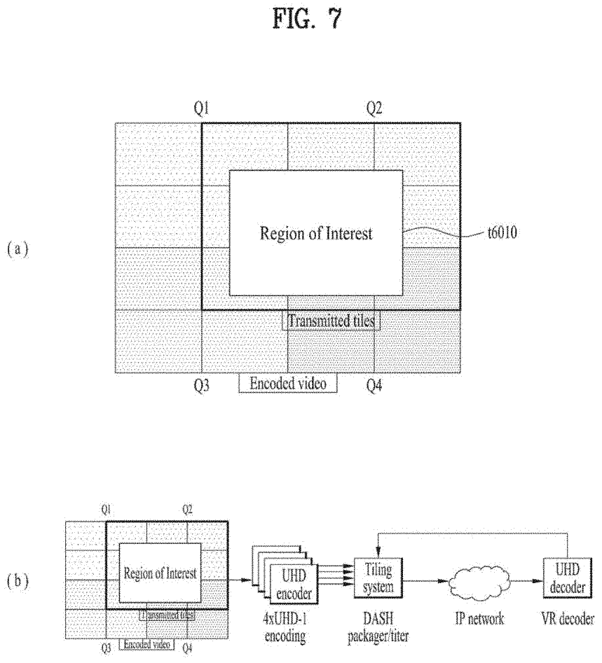

FIG. 7 illustrates tiles according to embodiments.

360 video data projected on a 2D image or region-wise packed 360 video data can be divided into one or more tiles. (a) shows that one 2D image is divided into 16 tiles. Here, the 2D image may be the aforementioned projected frame or packed frame. According to another embodiment of the 360 video transmission apparatus according to embodiments, the data encoder can independently encode the tiles.

The aforementioned region-wise packing can be discriminated from tiling. The aforementioned region-wise packing may refer to a process of dividing 360 video data projected on a 2D image into regions and processing the regions in order to increase coding efficiency or adjusting resolution. Tiling may refer to a process through which the data encoder divides a projected frame or a packed frame into tiles and independently encode the tiles. When 360 video is provided, a user does not simultaneously use all parts of the 360 video. Tiling enables only tiles corresponding to important part or specific part, such as a viewport currently viewed by the user, to be transmitted or consumed to or by a receiving side on a limited bandwidth. Through tiling, a limited bandwidth can be used more efficiently and the receiving side can reduce computational load compared to a case in which the entire 360 video data is processed simultaneously.

A region and a tile are discriminated from each other and thus they need not be identical. However, a region and a tile may refer to the same area according to an embodiment. Region-wise packing can be performed to tiles and thus regions can correspond to tiles according to an embodiment. Furthermore, when sides according to a projection scheme correspond to regions, each side, region and tile according to the projection scheme may refer to the same area according to an embodiment. A region may be called a VR region and a tile may be called a tile region according to context.

ROI (Region of Interest) may refer to a region of interest of users, which is provided by a 360 content provider. When 360 video is produced, the 360 content provider can produce the 360 video in consideration of a specific region which is expected to be a region of interest of users. According to an embodiment, ROI may correspond to a region in which important content of the 360 video is reproduced.

According to another embodiment of the 360 video transmission/reception apparatuses according to embodiments, the receiver feedback processor can extract and collect viewport information and deliver the same to the transmitter feedback processor. In this process, the viewport information can be delivered using network interfaces of both sides. In the 2D image shown in (a), a viewport t6010 is displayed. Here, the viewport may be displayed over nine tiles of the 2D images.

In this case, the 360 video transmission apparatus may further include a tiling system. According to an embodiment, the tiling system may be located following the data encoder (b), may be included in the aforementioned data encoder or transmission processor, or may be included in the 360 video transmission apparatus as a separate internal/external element.

The tiling system may receive viewport information from the transmitter feedback processor. The tiling system can select only tiles included in a viewport region and transmit the same. In the 2D image shown in (a), only nine tiles including the viewport region t6010 among 16 tiles can be transmitted. Here, the tiling system can transmit tiles in a unicast manner over a broadband because the viewport region is different for users.

In this case, the transmitter feedback processor can deliver the viewport information to the data encoder. The data encoder can encode the tiles including the viewport region with higher quality than other tiles.

Furthermore, the transmitter feedback processor can deliver the viewport information to the metadata processor. The metadata processor can deliver metadata related to the viewport region to each internal element of the 360 video transmission apparatus or include the metadata in 360 video related metadata.

By using this tiling method, transmission bandwidths can be saved and processes differentiated for tiles can be performed to achieve efficient data processing/transmission.

The above-described embodiments related to the viewport region can be applied to specific regions other than the viewport region in a similar manner. For example, the aforementioned processes performed on the viewport region can be performed on a region determined to be a region in which users are interested through the aforementioned gaze analysis, ROI, and a region (initial view, initial viewpoint) initially reproduced when a user views 360 video through a VR display.

According to another embodiment of the 360 video transmission apparatus according to embodiments, the transmission processor may perform processing for transmission differently on tiles. The transmission processor can apply different transmission parameters (modulation orders, code rates, etc.) to tiles such that data delivered for the tiles has different robustnesses.

Here, the transmitter feedback processor can deliver feedback information received from the 360 video reception apparatus to the transmission processor such that the transmission processor can perform transmission processing differentiated for tiles. For example, the transmitter feedback processor can deliver the viewport information received from the receiving side to the transmission processor. The transmission processor can perform transmission processing such that tiles including the corresponding viewport region have higher robustness than other tiles.

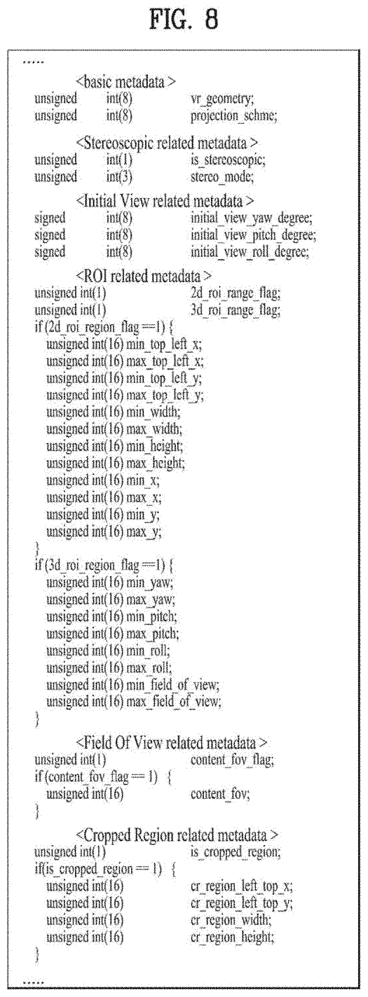

FIG. 8 illustrates 360 video related metadata according to embodiments.

The aforementioned 360 video related metadata may include various types of metadata related to 360 video. The 360 video related metadata may be called 360 video related signaling information according to context. The 360 video related metadata may be included in an additional signaling table and transmitted, included in a DASH MPD and transmitted, or included in a file format such as ISOBMFF in the form of box and delivered. When the 360 video related metadata is included in the form of box, the 360 video related metadata can be included in various levels such as a file, fragment, track, sample entry, sample, etc. and can include metadata about data of the corresponding level.

According to an embodiment, part of the metadata, which will be described below, may be configured in the form of a signaling table and delivered, and the remaining part may be included in a file format in the form of a box or a track.

According to an embodiment of the 360 video related metadata, the 360 video related metadata may include basic metadata related to a projection scheme, stereoscopic related metadata, initial view/initial viewpoint related metadata, ROI related metadata, FOV (Field of View) related metadata and/or cropped region related metadata. According to an embodiment, the 360 video related metadata may include additional metadata in addition to the aforementioned metadata.

Embodiments of the 360 video related metadata according to embodiments may include at least one of the aforementioned basic metadata, stereoscopic related metadata, initial view/initial viewpoint related metadata, ROI related metadata, FOV related metadata, cropped region related metadata and/or additional metadata. Embodiments of the 360 video related metadata according to embodiments may be configured in various manners depending on the number of cases of metadata included therein. According to an embodiment, the 360 video related metadata may further include additional metadata in addition to the aforementioned metadata.

The basic metadata may include 3D model related information, projection scheme related information and the like. The basic metadata can include a vr_geometry field, a projection_scheme field, etc. According to an embodiment, the basic metadata may further include additional information.

The vr_geometry field can indicate the type of a 3D model supported by the corresponding 360 video data. When the 360 video data is re-projected on a 3D space as described above, the 3D space can have a form according to a 3D model indicated by the vr_geometry field. According to an embodiment, a 3D model used for rendering may differ from the 3D model used for re-projection, indicated by the vr_geometry field. In this case, the basic metadata may further include a field which indicates the 3D model used for rendering. When the field has values of 0, 1, 2 and 3, the 3D space can conform to 3D models of a sphere, a cube, a cylinder and a pyramid. When the field has the remaining values, the field can be reserved for future use. According to an embodiment, the 360 video related metadata may further include detailed information about the 3D model indicated by the field. Here, the detailed information about the 3D model can refer to the radius of a sphere, the height of a cylinder, etc. for example. This field may be omitted.

The projection_scheme field can indicate a projection scheme used when the 360 video data is projected on a 2D image. When the field has values of 0, 1, 2, 3, 4, and 5, the field indicates that the equirectangular projection scheme, cubic projection scheme, cylindrical projection scheme, tile-based projection scheme, pyramid projection scheme and panoramic projection scheme are used. When the field has a value of 6, the field indicates that the 360 video data is directly projected on the 2D image without stitching. When the field has the remaining values, the field can be reserved for future use. According to an embodiment, the 360 video related metadata may further include detailed information about regions generated according to a projection scheme specified by the field. Here, the detailed information about regions may refer to information indicating whether regions have been rotated, the radius of the top region of a cylinder, etc. for example.

The stereoscopic related metadata may include information about 3D related properties of the 360 video data. The stereoscopic related metadata may include an is_stereoscopic field and/or a stereo_mode field. According to an embodiment, the stereoscopic related metadata may further include additional information.

The is_stereoscopic field can indicate whether the 360 video data supports 3D. When the field is 1, the 360 video data supports 3D. When the field is 0, the 360 video data does not support 3D. This field may be omitted.

The stereo_mode field can indicate 3D layout supported by the corresponding 360 video. Whether the 360 video supports 3D can be indicated only using this field. In this case, the is_stereoscopic field can be omitted. When the field is 0, the 360 video may be a mono mode. That is, the projected 2D image can include only one mono view. In this case, the 360 video may not support 3D.

When this field is 1 and 2, the 360 video can conform to left-right layout and top-bottom layout. The left-right layout and top-bottom layout may be called a side-by-side format and a top-bottom format. In the case of the left-right layout, 2D images on which left image/right image are projected can be positioned at the left/right on an image frame. In the case of the top-bottom layout, 2D images on which left image/right image are projected can be positioned at the top/bottom on an image frame. When the field has the remaining values, the field can be reserved for future use.

The initial view/initial viewpoint related metadata may include information about a view (initial view) which is viewed by a user when initially reproducing 360 video. The initial view/initial viewpoint related metadata may include an initial_view_yaw_degree field, an initial_view_pitch_degree field and/or an initial_view_roll_degree field. According to an embodiment, the initial view/initial viewpoint related metadata may further include additional information.

The initial_view_yaw_degree field, initial_view_pitch_degree field and initial_view_roll_degree field can indicate an initial view when the 360 video is reproduced. That is, the center point of a viewport which is initially viewed when the 360 video is reproduced can be indicated by these three fields. The fields can indicate the center point using a direction (sign) and a degree (angle) of rotation on the basis of yaw, pitch and roll axes. Here, the viewport which is initially viewed when the 360 video is reproduced according to FOV. The width and height of the initial viewport based on the indicated initial view can be determined through FOV. That is, the 360 video reception apparatus can provide a specific region of the 360 video as an initial viewport to a user using the three fields and FOV information.

According to an embodiment, the initial view indicated by the initial view/initial viewpoint related metadata may be changed per scene. That is, scenes of the 360 video change as 360 content proceeds with time. The initial view or initial viewport which is initially viewed by a user can change for each scene of the 360 video. In this case, the initial view/initial viewpoint related metadata can indicate the initial view per scene. To this end, the initial view/initial viewpoint related metadata may further include a scene identifier for identifying a scene to which the initial view is applied. In addition, since FOV may change per scene of the 360 video, the initial view/initial viewpoint related metadata may further include FOV information per scene which indicates FOV corresponding to the relative scene.

The ROI related metadata may include information related to the aforementioned ROI. The ROI related metadata may include a 2d_roi_range_flag field and/or a 3d_roi_range_flag field. These two fields can indicate whether the ROI related metadata includes fields which represent ROI on the basis of a 2D image or fields which represent ROI on the basis of a 3D space. According to an embodiment, the ROI related metadata may further include additional information such as differentiate encoding information depending on ROI and differentiate transmission processing information depending on ROI.

When the ROI related metadata includes fields which represent ROI on the basis of a 2D image, the ROI related metadata can include a min_top_left_x field, a max_top_left_x field, a min_top_left_y field, a max_top_left_y field, a min_width field, a max_width field, a min_height field, a max_height field, a min_x field, a max_x field, a min_y field and/or a max_y field.

The min_top_left_x field, max_top_left_x field, min_top_left_y field, max_top_left_y field can represent minimum/maximum values of the coordinates of the left top end of the ROI. These fields can sequentially indicate a minimum x coordinate, a maximum x coordinate, a minimum y coordinate and a maximum y coordinate of the left top end.

The min_width field, max_width field, min_height field and max_height field can indicate minimum/maximum values of the width and height of the ROI. These fields can sequentially indicate a minimum value and a maximum value of the width and a minimum value and a maximum value of the height.

The min_x field, max_x field, min_y field and max_y field can indicate minimum and maximum values of coordinates in the ROI. These fields can sequentially indicate a minimum x coordinate, a maximum x coordinate, a minimum y coordinate and a maximum y coordinate of coordinates in the ROI. These fields can be omitted.

When ROI related metadata includes fields which indicate ROI on the basis of coordinates on a 3D rendering space, the ROI related metadata can include a min_yaw field, a max_yaw field, a min_pitch field, a max_pitch field, a min_roll field, a max_roll field, a min_field_of_view field and/or a max_field_of_view field.

The min_yaw field, max_yaw field, min_pitch field, max_pitch field, min_roll field and max_roll field can indicate a region occupied by ROI on a 3D space using minimum/maximum values of yaw, pitch and roll. These fields can sequentially indicate a minimum value of yaw-axis based reference rotation amount, a maximum value of yaw-axis based reference rotation amount, a minimum value of pitch-axis based reference rotation amount, a maximum value of pitch-axis based reference rotation amount, a minimum value of roll-axis based reference rotation amount, and a maximum value of roll-axis based reference rotation amount.

The min_field_of_view field and max_field_of_view field can indicate minimum/maximum values of FOV of the corresponding 360 video data. FOV can refer to the range of view displayed at once when 360 video is reproduced. The min_field_of_view field and max_field_of_view field can indicate minimum and maximum values of FOV. These fields can be omitted. These fields may be included in FOV related metadata which will be described below.

The FOV related metadata can include the aforementioned FOV related information. The FOV related metadata can include a content_fov_flag field and/or a content_fov field. According to an embodiment, the FOV related metadata may further include additional information such as the aforementioned minimum/maximum value related information of FOV.

The content_fov_flag field can indicate whether corresponding 360 video includes information about FOV intended when the 360 video is produced. When this field value is 1, a content_fov field can be present.

The content_fov field can indicate information about FOV intended when the 360 video is produced. According to an embodiment, a region displayed to a user at once in the 360 video can be determined according to vertical or horizontal FOV of the 360 video reception apparatus. Alternatively, a region displayed to a user at once in the 360 video may be determined by reflecting FOV information of this field according to an embodiment.

Cropped region related metadata can include information about a region including 360 video data in an image frame. The image frame can include a 360 video data projected active video area and other areas. Here, the active video area can be called a cropped region or a default display region. The active video area is viewed as 360 video on an actual VR display and the 360 video reception apparatus or the VR display can process/display only the active video area. For example, when the aspect ratio of the image frame is 4:3, only an area of the image frame other than an upper part and a lower part of the image frame can include 360 video data. This area can be called the active video area.

The cropped region related metadata can include an is_cropped_region field, a cr_region_left_top_x field, a cr_region_left_top_y field, a cr_region_width field and/or a cr_region_height field. According to an embodiment, the cropped region related metadata may further include additional information.

The is_cropped_region field may be a flag which indicates whether the entire area of an image frame is used by the 360 video reception apparatus or the VR display. That is, this field can indicate whether the entire image frame indicates an active video area. When only part of the image frame is an active video area, the following four fields may be added.

A cr_region_left_top_x field, a cr_region_left_top_y field, a cr_region_width field and a cr_region_height field can indicate an active video area in an image frame. These fields can indicate the x coordinate of the left top, the y coordinate of the left top, the width and the height of the active video area. The width and the height can be represented in units of pixel.

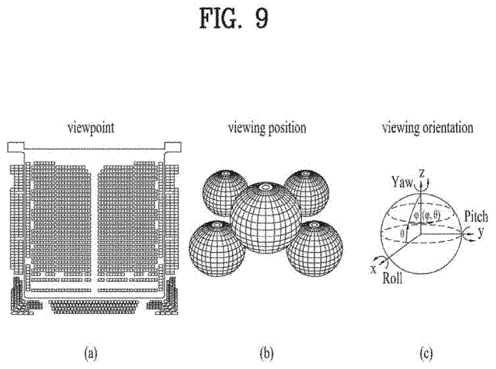

FIG. 9 is a view showing a viewpoint and viewing position additionally defined in a 3DoF+ VR system.

The 360-degree video based VR system of embodiments may provide visual/auditory experiences for different viewing orientations based on a position of a user for 360-degree video. This method may be referred to as 3DoF (three degree of freedom) plus. In detail, the VR system that provides visual/auditory experiences for different orientations in a fixed position of a user may be referred to as a 3DoF based VR system.

Meanwhile, the VR system that may provide extended visual/auditory experiences for different orientations in different viewpoints and different viewing positions at the same time zone may be referred to as a 3DoF+ or 3DoF plus based VR system.

1) Supposing a space such as (a) (example of art center), different positions (example of art center marked with a red circle) may be considered as the respective viewpoints. At this time, video/audio provided by the respective viewpoints existing in the same space as example may have the same time flow.

2) In this case, different visual/auditory experiences may be provided in accordance with a viewpoint change (head motion) of a user in a specific position. That is, spheres of various viewing positions may be assumed as shown in (b) for a specific viewpoint, and video/audio/text information in which a relative position of each viewpoint is reflected may be provided.

3) Meanwhile, visual/auditory information of various orientations such as the existing 3DoF may be delivered at a specific viewpoint of a specific position as shown in (c). In this case, additional various sources as well as main sources (video/audio/text) may be provided in combination, and this may be associated with a viewing orientation of a user or information may be delivered independently.

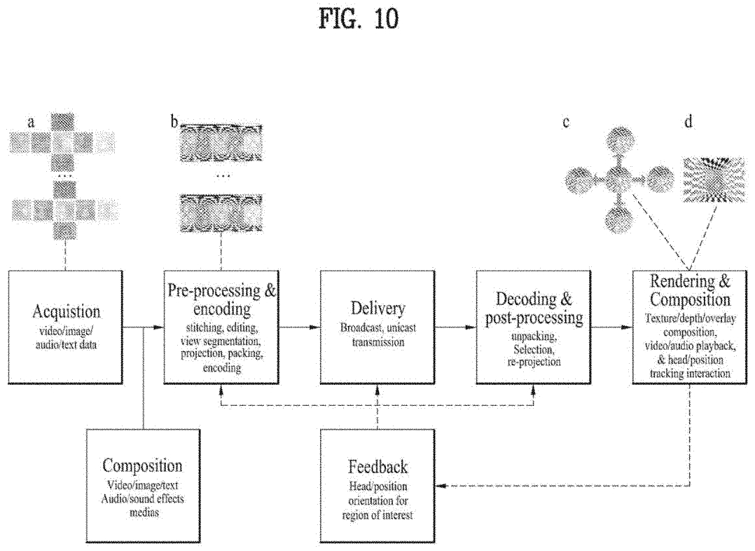

FIG. 10 is a view showing a method for implementing 360-degree video signal processing and related transmission apparatus/reception apparatus based on 3DoF+ system.

FIG. 10 is an example of 3DoF+ end-to-end system flow chart including video acquisition, pre-processing, transmission, (post)processing, rendering and feedback processes of 3DoF+.

1) Acquisition: may mean a process of acquiring 360-degree video through capture, composition or generation of 360-degree video. Various kinds of video/audio information according to head motion may be acquired for a plurality of positions through this process. In this case, video information may include depth information as well as visual information (texture). At this time, a plurality of kinds of information of different viewing positions according to different viewpoints may be acquired like example of video information of a.

2) Composition: may define a method for composition to include video (video/image, etc.) through external media, voice (audio/effect sound, etc.) and text (caption, etc.) as well as information acquired through the video/audio input module in user experiences.

3) Pre-processing: is a preparation (pre-processing) process for transmission/delivery of the acquired 360-degree video, and may include stitching, projection, region wise packing and/or encoding process. That is, this process may include pre-processing and encoding processes for modifying/complementing data such as video/audio/text information in accordance with a producer's intention. For example, the pre-processing process of the video may include mapping (stitching) of the acquired visual information onto 360 sphere, editing such as removing a region boundary, reducing difference in color/brightness or providing visual effect of video, view segmentation according to viewpoint, a projection for mapping video on 360 sphere into 2D image, region-wise packing for rearranging video in accordance with a region, and encoding for compressing video information. A plurality of projection videos of different viewing positions according to different viewpoints may be generated like example in view of video of B.

4) Delivery: may mean a process of processing and transmitting video/audio data and metadata subjected to the preparation process (pre-processing). As a method for delivering a plurality of video/audio data and related metadata of different viewing positions according to different viewpoints, a broadcast network or a communication network may be used, or unidirectional delivery method may be used.

5) Post-processing & composition: may mean a post-processing process for decoding and finally reproducing received/stored video/audio/text data. For example, the post-processing process may include unpacking for unpacking a packed video and re-projection for restoring 2D projected image to 3D sphere image as described above.

6) Rendering: may mean a process of rendering and displaying re-projected image/video data on a 3D space. In this process, the process may be reconfigured to finally output video/audio signals. A viewing orientation, viewing position/head position and viewpoint, in which a user's region of interest exists, may be subjected to tracking, and necessary video/audio/text information may selectively be used in accordance with this information. At this time, in case of video signal, different viewing positions may be selected in accordance with the user's region of interest as shown in c, and video in a specific orientation of a specific viewpoint at a specific position may finally be output as shown in d.

7) Feedback: may mean a process of delivering various kinds of feedback information, which can be acquired during a display process, to a transmission side. In this embodiment, a viewing orientation, a viewing position, and a viewpoint, which corresponds to a user's region of interest, may be estimated, and feedback may be delivered to reproduce video/audio based on the estimated result.

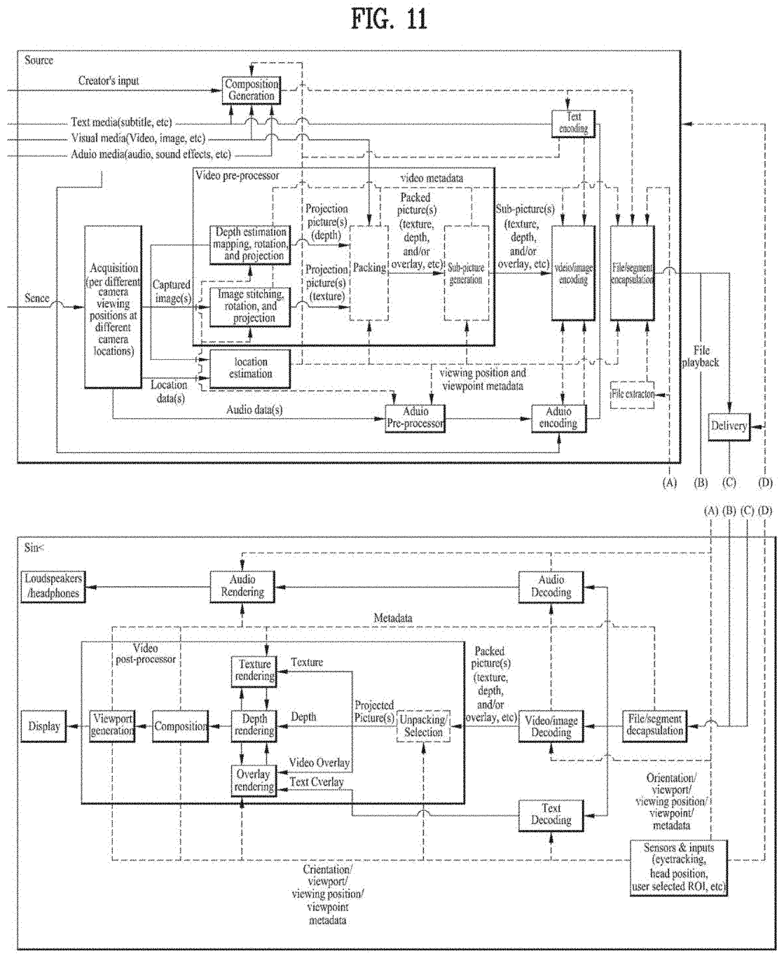

FIG. 11 is a view showing an architecture of a 3DoF+ end-to-end system.

FIG. 11 is an example of a 3DoF+ end-to-end system architecture. As described in the architecture of FIG. 11, 3DoF+360 contents may be provided.

The 360-degree video transmission apparatus may include an acquisition unit for acquiring 360-degree video(image)/audio data, a video/audio pre-processor for processing the acquired data, a composition generation unit for composing additional information an encoding unit for encoding text, audio and projected 360-degree video, and an encapsulation unit for encapsulating the encoded data. As described above, the encapsulated data may be output in the form of bitstreams. The encoded data may be encapsulated in a file format such as ISOBMFF and CFF, or may be processed in the form of other DASH segment. The encoded data may be delivered to the 360-degree video reception apparatus through a digital storage medium. Although not shown explicitly, the encoded data may be subjected to processing for transmission through the transmission-processor and then transmitted through a broadcast network or a broadband, as described above.

The data acquisition unit may simultaneously or continuously acquire different kinds of information in accordance with sensor orientation (viewing orientation in view of video), information acquisition timing of a sensor (sensor position, or viewing position in view of video), and information acquisition position of a sensor (viewpoint in case of video). At this time, video, image, audio and position information may be acquired.

In case of video data, texture and depth information may respectively be acquired, and video pre-processing may be performed in accordance with characteristic of each component. For example, in case of the text information, 360-degree omnidirectional video may be configured using videos of different orientations of the same viewing position, which are acquired at the same viewpoint using image sensor position information. To this end, video stitching may be performed. Also, projection and/or region wise packing for modifying the video to a format for encoding may be performed. In case of depth image, the image may generally be acquired through a depth camera. In this case, the depth image may be made in the same format such as texture. Alternatively, depth data may be generated based on data measured separately. After image per component is generated, additional conversion (packing) to a video format for efficient compression may be performed, or a sub-picture generation for reconfiguring the images by segmentation into sub-pictures which are actually necessary may be performed. Information on image configuration used in a video pre-processing end is delivered as video metadata.

If video/audio/text information additionally given in addition to the acquired data (or data for main service) are together served, it is required to provide information for composing these kinds of information during final reproduction. The composition generation unit generates information for composing externally generated media data (video/image in case of video, audio/effect sound in case of audio, and caption in case of text) at a final reproduction end based on a producer's intention, and this information is delivered as composition data.

The video/audio/text information subjected to each processing is compressed using each encoder, and encapsulated on a file or segment basis in accordance with application. At this time, only necessary information may be extracted (file extractor) in accordance with a method for configuring video, file or segment.

Also, information for reconfiguring each data in the receiver is delivered at a codec or file format/system level, and in this case, the information includes information (video/audio metadata) for video/audio reconfiguration, composition information (composition metadata) for overlay, viewpoint capable of reproducing video/audio and viewing position information according to each viewpoint (viewing position and viewpoint metadata), etc. This information may be processed through a separate metadata processor.

The 360-degree video reception apparatus may include a file/segment decapsulation unit for decapsulating a received file and segment, a decoding unit for generating video/audio/text information from bitstreams, a post-processor for reconfiguring the video/audio/text in the form of reproduction, a tracking unit for tracking a user's region of interest, and a display which is a reproduction unit.

The bitstreams generated through decapsulation may be segmented into video/audio/text in accordance with types of data and separately decoded to be reproduced.

The tracking unit generates viewpoint of a user's region of interest, viewing position at the corresponding viewpoint, and viewing orientation information at the corresponding viewing position based on a sensor and the user's input information. This information may be used for selection or extraction of a region of interest in each module of the 360-degree video reception apparatus, or may be used for a post-processing process for emphasizing information of the region of interest. Also, if this information is delivered to the 360-degree video transmission apparatus, this information may be used for file selection (file extractor) or subpicture selection for efficient bandwidth use, and may be used for various video reconfiguration methods based on a region of interest (viewport/viewing position/viewpoint dependent processing).

The decoded video signal may be processed in accordance with various processing methods of the video configuration method. If image packing is performed in the 360-degree video transmission apparatus, a process of reconfiguring video is required based on the information delivered through metadata. In this case, video metadata generated by the 360-degree video transmission apparatus may be used. Also, if videos of a plurality of viewpoints or a plurality of viewing positions or various orientations are included in the decoded video, information matched with viewpoint, viewing position, and orientation information of the user's region of interest, which are generated through tracking, may be selected and processed. At this time, viewing position and viewpoint metadata generated at the transmission side may be used. Also, if a plurality of components are delivered for a specific position, viewpoint and orientation or video information for overlay is separately delivered, a rendering process for each of the data and information may be included. The video data (texture, depth and overlay) subjected to a separate rendering process may be subjected to a composition process. At this time, composition metadata generated by the transmission side may be used. Finally, information for reproduction in viewport may be generated in accordance with the user's region of interest.

The decoded audio signal may be generated as an audio signal capable of being reproduced, through an audio renderer and/or the post-processing process. At this time, information suitable for the user's request may be generated based on the information on the user's region of interest and the metadata delivered to the 360-degree video reception apparatus.

The decoded text signal may be delivered to an overlay renderer and processed as overlay information based on text such as subtitle. A separate text post-processing process may be included if necessary.

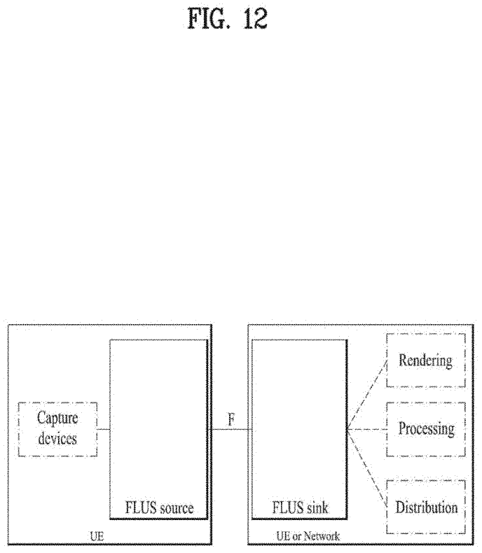

FIG. 12 is a view showing an architecture of a Frame for Live Uplink Streaming (FLUS).

The detailed blocks of the transmission side and the reception side may be categorized into functions of a source and a sink in FLUS (Framework for Live Uplink Streaming). In this case, the information acquisition unit may implement the function of the source, implement the function of the sink on a network, or implement source/sink within a network node, as follows.

The network node may include a user equipment (UE). The UE may include the aforementioned 360-degree video transmission apparatus or the aforementioned 360-degree reception apparatus.

A transmission and reception processing process based on the aforementioned architecture may be described as follows. The following transmission and reception processing process is described based on the video signal processing process. If the other signals such as audio or text are processed, a portion marked with italic may be omitted or may be processed by being modified to be suitable for audio or text processing process.

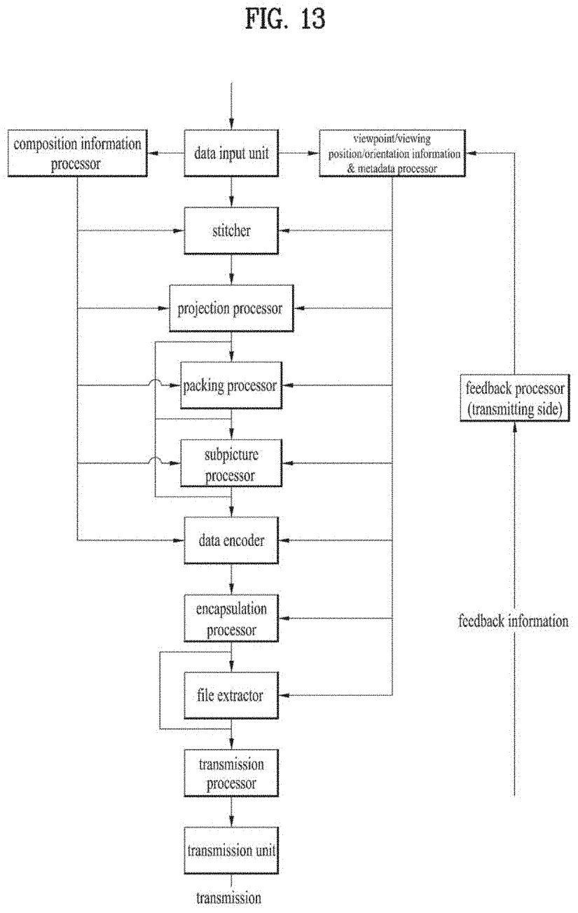

FIG. 13 is a view showing a configuration of 3DoF+ transmission side.

The transmission side (360-degree video transmission apparatus) may perform stitching for sphere image configuration per viewpoint/viewing position/component if input data are images output through a camera. If sphere images per viewpoint/viewing position/component are configured, the transmission side may perform projection for coding in 2D image. The transmission side may generate a plurality of images as subpictures of a packing or segmented region for making an integrated image in accordance with application. As described above, the region wise packing process is an optional process, and may not be performed. In this case, the packing process may be omitted. If the input data are video/audio/text additional information, a method for displaying additional information by adding the additional information to a center image may be notified, and the additional data may be transmitted together. The encoding process for compressing the generated images and the added data to generate bitstreams may be performed and then the encapsulation process for converting the bitstreams to a file format for transmission or storage may be performed. At this time, a process of extracting a file requested by the reception side may be processed in accordance with application or request of the system. The generated bitstreams may be converted to the transport format through the transmission-processor and then transmitted. At this time, the feedback processor of the transmission side may process viewpoint/viewing position/orientation information and necessary metadata based on the information delivered from the reception side and deliver the information to the related transmission side so that the transmission side may process the corresponding data.

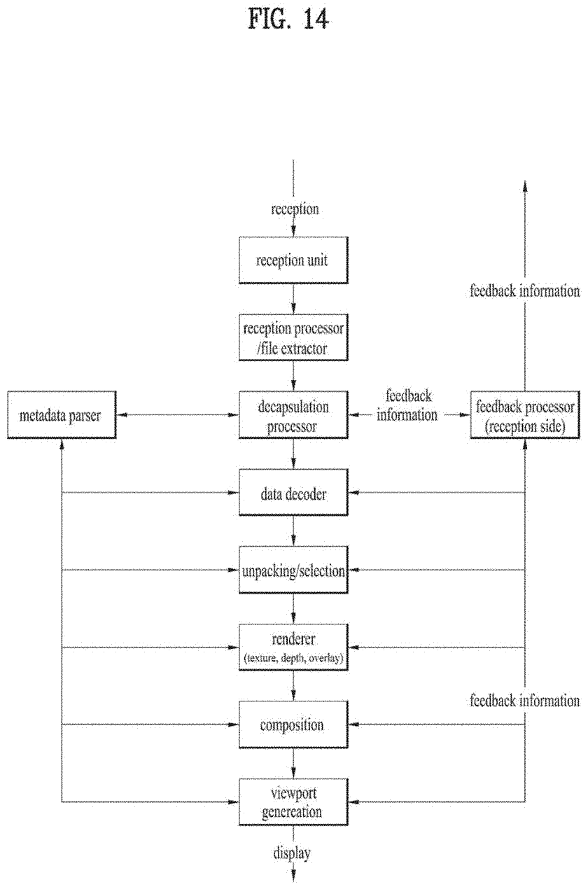

FIG. 14 is a view showing a configuration of 3DoF+ reception side.

The reception side (360-degree video reception apparatus) may extract a necessary file after receiving the bitstreams delivered from the transmission side. The reception side may select bitstreams in the generated file format by using the viewpoint/viewing position/orientation information delivered from the feedback processor and reconfigure the selected bitstreams as image information through the decoder. The reception side may perform unpacking for the packed image based on packing information delivered through the metadata. If the packing process is omitted in the transmission side, unpacking of the reception side may also be omitted. Also, the reception side may perform a process of selecting images suitable for the viewpoint/viewing position/orientation information delivered from the feedback processor and necessary components if necessary. The reception side may perform a rendering process of reconfiguring texture, depth and overlay information of images as a format suitable for reproduction. The reception side may perform a composition process for composing information of different layers before generating a final image, and may generate and reproduce an image suitable for a display viewport.

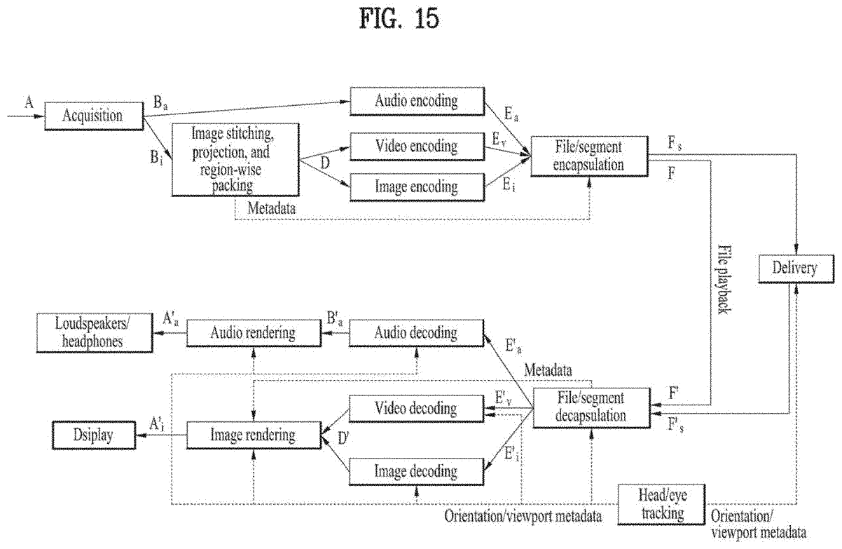

FIG. 15 is a view showing an OMAF structure.

The 360-degree video based VR system may provide visual/auditory experiences for different viewing orientations based on a position of a user for 360-degree video based on the 360-degree video processing process. A service for providing visual/auditory experiences for different orientations in a fixed position of a user with respect to 360-degree video may be referred to as a 3DoF based service. Meanwhile, a service for providing extended visual/auditory experiences for different orientations in a random viewpoint and viewing position at the same time zone may be referred to as a 6DoF (six degree of freedom) based service.

A file format for 3DoF service has a structure in which a position of rendering, information of a file to be transmitted, and decoding information may be varied depending on a head/eye tracking module as shown in FIG. 15. However, this structure is not suitable for transmission of a media file of 6DoF in which rendering information/transmission details and decoding information are varied depending on a viewpoint or position of a user, correction is required.

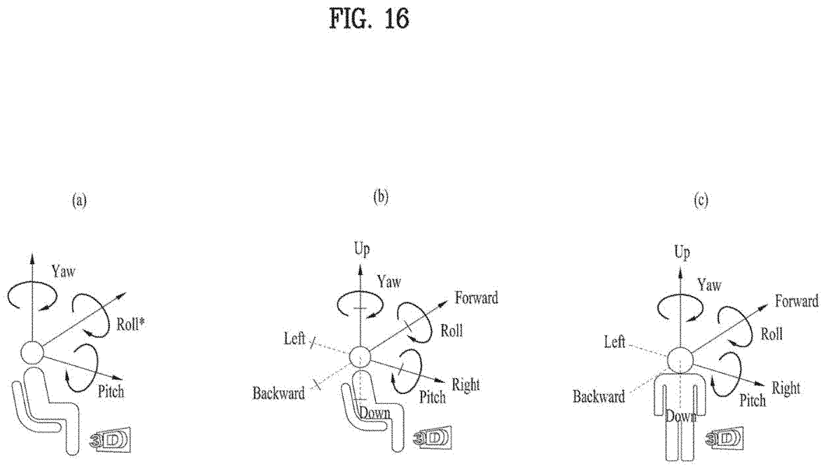

FIG. 16 is a view showing a type of media according to movement of a user.

Embodiments proposes a method for providing 6DoF content to provide a user with experiences of immersive media/realistic media. The immersive media/realistic media is a concept extended from a virtual environment provided by the existing 360 contents, and the position of the user is fixed in the form of (a) of the existing 360-degree video contents. If the immersive media/realistic media has only a concept of rotation, the immersive media/realistic media may mean an environment or contents, which can provide a user with more sensory experiences such as movement/rotation of the user in a virtual space by giving a concept of movement when the user experiences contents as described in (b) or (c).

(a) indicates media experiences if a view of a user is rotated in a state that a position of the user is fixed.

(b) indicates media experiences if a user's head may additionally move in addition to a state that a position of the user is fixed.

(c) indicates media experiences when a position of a user may move.

The realistic media contents may include 6DoF video and 6DoF audio for providing corresponding contents, wherein 6DoF video may mean video or image required to provide realistic media contents and captured or reproduced as 3DoF or 360-degree video newly formed during every movement. 6DoF content may mean videos or images displayed on a 3D space. If movement within contents is fixed, the corresponding contents may be displayed on various types of 3D spaces like the existing 360-degree video. For example, the corresponding contents may be displayed on a spherical surface. If movement within the contents is a free state, a 3D space may newly be formed on a moving path based on the user every time and the user may experience contents of the corresponding position. For example, if the user experiences an image displayed on a spherical surface at a position where the user first views, and actually moves on the 3D space, a new image on the spherical surface may be formed based on the moved position and the corresponding contents may be consumed. Likewise, 6DoF audio is an audio content for providing a content to allow a user to experience realistic media, and may mean contents for newly forming and consuming a spatial audio according to movement of a position where sound is consumed.

Embodiments proposes a method for effectively providing 6DoF video. The 6DoF video may be captured at different positions by two or more cameras. The captured video may be transmitted through a series of processes, and the reception side may process and render some of the received data as 360-degree video having an initial position of the user as a starting point. If the position of the user moves, the reception side may process and render new 360-degree video based on the position where the user has moved, whereby the 6DoF video may be provided to the user.

Hereinafter, a transmission method and a reception method for providing 6DoF video services will be described.

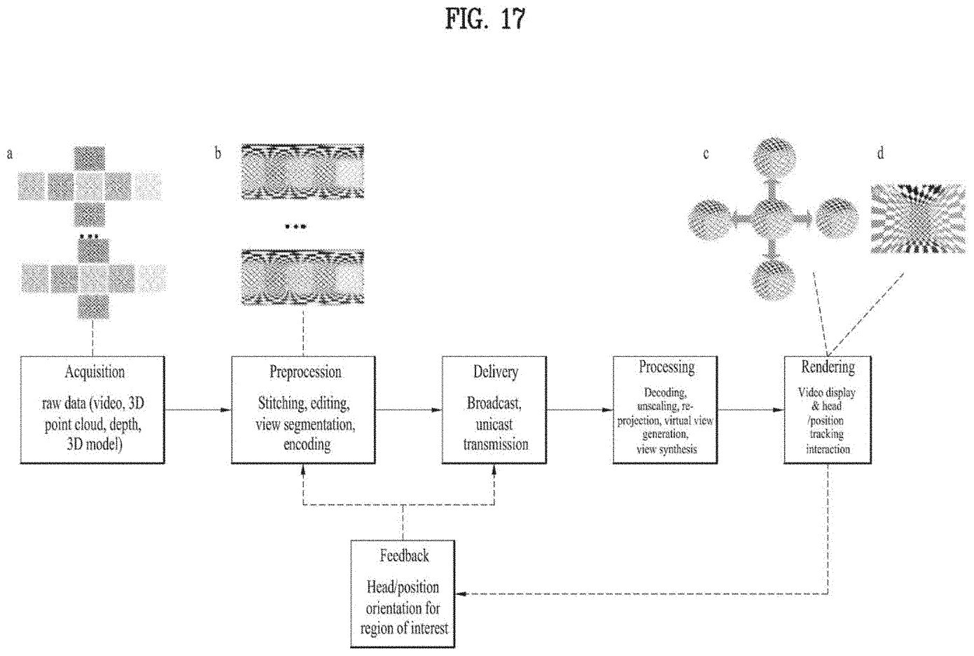

FIG. 17 is a view showing the entire architecture for providing 6DoF video.

A series of the processes described above will be described in detail based on FIG. 17. First of all, as an acquisition step, HDCA (High Density Camera Array), Lenslet (microlens) camera, etc. may be used to capture 6DoF contents, and 6DoF video may be acquired by a new device designed for capture of the 6DoF video. The acquired video may be generated as several image/video data sets generated in accordance with a position of a camera, which is captured as shown in FIG. 3a. At this time, metadata such as internal/external setup values of the camera may be generated during the capturing process. In case of image generated by a computer not the camera, the capturing process may be replaced. The pre-processing process of the acquired video may be a process of processing the captured image/video and the metadata delivered through the capturing process. This process may correspond to all of types of pre-processing steps such as a stitching process, a color correction process, a projection process, a view segmentation process for segmenting views into a primary view and a secondary view to enhance coding efficiency, and an encoding process.

The stitching process may be a process of making image/video by connecting image captured in the direction of 360-degree in a position of each camera with image in the form of panorama or sphere based on the position of each camera. Projection means a process of projecting the image resultant from the stitching process to a 2D image as shown in FIG. 3b, and may be expressed as mapping into 2D image. The image mapped in the position of each camera may be segmented into a primary view and a secondary view such that resolution different per view may be applied to enhance video coding efficiency, and arrangement or resolution of mapping image may be varied even within the primary view, whereby efficiency may be enhanced during coding. The secondary view may not exist depending on the capture environment. The secondary view means image/video to be reproduced during a movement process when a user moves from the primary view to another primary view, and may have resolution lower than that of the primary view but may have the same resolution as that of the primary view if necessary. The secondary view may newly be generated by the receiver as virtual information as the case may be.

In some embodiments, the pre-processing process may further include an editing process. In this process, editing for image/video data may further be performed before and after projection, and metadata may be generated even during the pre-processing process. Also, when the image/video are provided, metadata for an initial view to be first reproduced and an initial position and a region of interest (ROI) of a user may be generated.

The media transmission step may be a process of processing and transmitting the image/video data and metadata acquired during the pre-processing process. Processing according to a random transmission protocol may be performed for transmission, and the pre-processed data may be delivered through a broadcast network and/or a broadband. The pre-processed data may be delivered to the reception side in an on demand manner.

The processing process may include all steps before image is generated, wherein all steps may include decoding the received image/video data and metadata, re-projection which may be called mapping or projection into a 3D model, and a virtual view generation and composition process. The 3D model which is mapped or a projection map may include a sphere, a cube, a cylinder or a pyramid like the existing 360-degree video, and may be a modified type of a projection map of the existing 360-degree video, or may be a projection map of a free type as the case may be.

The virtual view generation and composition process may mean a process of generating and composing the image/video data to be reproduced when the user moves between the primary view and the secondary view or between the primary view and the primary view. The process of processing the metadata delivered during the capture and pre-processing processes may be required to generate the virtual view. As the case may be, some of the 360-degree images/videos not all of the 360-degree images/videos may be generated/composed.

In some embodiments, the processing process may further include an editing process, an up scaling process, and a down scaling process. Additional editing required before reproduction may be applied to the editing process after the processing process. The process of up scaling or down scaling the received images/videos may be performed if necessary.

The rendering process may mean a process of rendering image/video, which is re-projected by being transmitted or generated, to be displayed. As the case may be, rendering and re-projection process may be referred to as rendering. Therefore, the rendering process may include the re-projection process. A plurality of re-projection results may exist in the form of 360-degree video/image based on the user and 360-degree video/image formed based on the position where the user moves in accordance with a moving direction as shown in FIG. 3c. The user may view some region of the 360-degree video/image in accordance with a device to be displayed. At this time, the region viewed by the user may be a form as shown in FIG. 3d. When the user moves, the entire 360-degree videos/images may not be rendered but the image corresponding to the position where the user views may only be rendered. Also, metadata for the position and the moving direction of the user may be delivered to previously predict movement, and video/image of a position to which the user will move may additionally be rendered.

The feedback process may mean a process of delivering various kinds of feedback information, which can be acquired during the display process, to the transmission side. Interactivity between 6DoF content and the user may occur through the feedback process. In some embodiments, the user's head/position orientation and information on a viewport where the user currently views may be delivered during the feedback process. The corresponding information may be delivered to the transmission side or a service provider during the feedback process. In some embodiments, the feedback process may not be performed.

The user's position information may mean information on the user's head position, angle, movement and moving distance. Information on a viewport where the user views may be calculated based on the corresponding information.

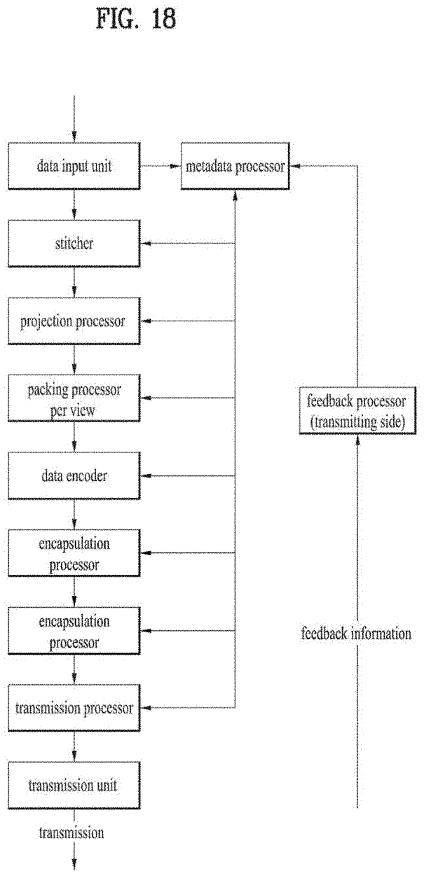

FIG. 18 is a view showing a configuration of a transmission apparatus for providing 6DoF video services.

Embodiments at the transmission side may be related to the 6DoF video transmission apparatus. The 6DoF video transmission apparatus may perform the aforementioned preparation processes and operations. The 6DoF video/image transmission apparatus according to embodiments may include a data input unit, a depth information processor (not shown), a stitcher, a projection processor, a view segmentation processor, a packing processor per view, a metadata processor, a feedback processor, a data encoder, an encapsulation processor, a transmission-processor, and/or a transmission unit as internal/external components.

The data input unit may receive image/video/depth information/audio data per view captured by one or more cameras at one or more positions. The data input unit may receive metadata generated during the capturing process together with the video/image/depth information/audio data. The data input unit may deliver the input video/image data per view to the stitcher and deliver the metadata generated during the capturing process to the metadata processor.

The stitcher may perform stitching for image/video per captured view/position. The stitcher may deliver the stitched 360-degree video data to the processor. The stitcher may perform stitching for the metadata delivered from the metadata processor if necessary. The stitcher may deliver the metadata generated during the stitching process to the metadata processor. The stitcher may vary a video/image stitching position by using a position value delivered from the depth information processor (not shown). The stitcher may deliver the metadata generated during the stitching process to the metadata processor. The delivered metadata may include information as to whether stitching has been performed, a stitching type, IDs of a primary view and a secondary view, and position information on a corresponding view.

The projection processor may perform projection for the stitched 6DoF video data to 2D image frame. The projection processor may obtain different types of results in accordance with a scheme, and the corresponding scheme may similar to the projection scheme of the existing 360-degree video, or a scheme newly proposed for 6DoF may be applied to the corresponding scheme. Also, different schemes may be applied to the respective views. The depth information processor may deliver depth information to the projection processor to vary a mapping resultant value. The projection processor may receive metadata required for projection from the metadata processor and use the metadata for a projection task if necessary, and may deliver the metadata generated during the projection process to the metadata processor. The corresponding metadata may include a type of a scheme, information as to whether projection has been performed, ID of 2D frame after projection for a primary view and a secondary view, and position information per view.

The packing processor per view may segment view into a primary view and a secondary view as described above and perform region wise packing within each view. That is, the packing processor per view may categorize 6DoF video data projected per view/position into a primary view and a secondary view and allow the primary view and the secondary view to have their respective resolutions different from each other so as to enhance coding efficiency, or may vary rotation and rearrangement of the video data of each view and vary resolution per region categorized within each view. The process of categorizing the primary view and the second view may be optional and thus omitted. The process of varying resolution per region and arrangement may selectively be performed. When the packing processor per view is performed, packing may be performed using the information delivered from the metadata processor, and the metadata generated during the packing process may be delivered to the metadata processor. The metadata defined in the packing process per view may be ID of each view for categorizing each view into a primary view and a secondary view, a size applied per region within a view, and a rotation position value per region.

The stitcher, the projection processor and/or the packing processor per view described as above may occur in an ingest server within one or more hardware components or streaming/download services in some embodiments.

The metadata processor may process metadata, which may occur in the capturing process, the stitching process, the projection process, the packing process per view, the encoding process, the encapsulation process and/or the transmission process. The metadata processor may generate new metadata for 6DoF video service by using the metadata delivered from each process. In some embodiments, the metadata processor may generate new metadata in the form of signaling table. The metadata processor may deliver the delivered metadata and the metadata newly generated/processed therein to another components. The metadata processor may deliver the metadata generated or delivered to the data encoder, the encapsulation processor and/or the transmission-processor to finally transmit the metadata to the reception side.

The data encoder may encode the 6DoF video data projected on the 2D image frame and/or the view/region-wise packed video data. The video data may be encoded in various formats, and encoded result values per view may be delivered separately if category per view is made.

The encapsulation processor may encapsulate the encoded 6DoF video data and/or the related metadata in the form of a file. The related metadata may be received from the aforementioned metadata processor. The encapsulation processor may encapsulate the corresponding data in a file format of ISOBMFF or OMAF, or may process the corresponding data in the form of a DASH segment, or may process the corresponding data in a new type file format. The metadata may be included in various levels of boxes in the file format, or may be included as data in a separate track, or may separately be encapsulated per view. The metadata required per view and the corresponding video information may be encapsulated together.

The transmission-processor may perform additional processing for transmission on the encapsulated video data in accordance with the format. The corresponding processing may be performed using the metadata received from the metadata processor. The transmission unit may transmit the data and/or the metadata received from the transmission-processor through a broadcast network and/or a broadband. The transmission-processor may include components required during transmission through the broadcast network and/or the broadband.

The feedback processor (transmission side) may further include a network interface (not shown). The network interface may receive feedback information from the reception apparatus, which will be described later, and may deliver the feedback information to the feedback processor (transmission side). The feedback processor may deliver the information received from the reception side to the stitcher, the projection processor, the packing processor per view, the encoder, the encapsulation processor and/or the transmission-processor. The feedback processor may deliver the information to the metadata processor so that the metadata processor may deliver the information to the other components or generate/process new metadata and then deliver the generated/processed metadata to the other components. According to another embodiment of embodiments, the feedback processor may deliver position/view information received from the network interface to the metadata processor, and the metadata processor may deliver the corresponding position/view information to the projection processor, the packing processor per view, the encapsulation processor and/or the data encoder to transmit only information suitable for current view/position of the user and peripheral information, thereby enhancing coding efficiency.

The components of the aforementioned 6DoF video transmission apparatus may be hardware components implemented by hardware. In some embodiments, the respective components may be modified or omitted or new components may be added thereto, or may be replaced with or incorporated into the other components.

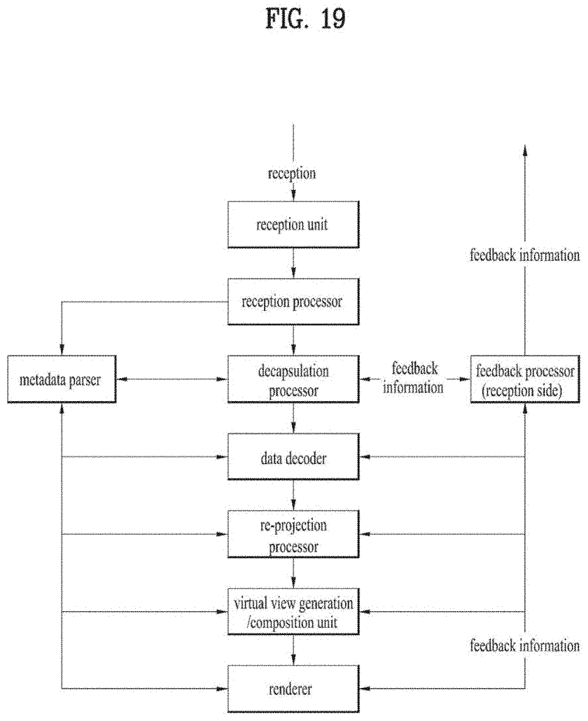

FIG. 19 is a view showing a configuration of 6DoF video reception apparatus.

Embodiments may be related to the reception apparatus. According to embodiments, the 6DoF video reception apparatus may include a reception unit, a reception processor, a decapsulation-processor, a metadata parser, a feedback processor, a data decoder, a re-projection processor, a virtual view generation/composition unit and/or a renderer as components.

The reception unit may receive video data from the aforementioned 6DoF transmission apparatus. The reception unit may receive the video data through a broadcast network or a broadband in accordance with a channel through which the video data are transmitted.

The reception processor may perform processing according to a transmission protocol for the received 6DoF video data. The reception processor may perform an inverse processing of the process performed in the transmission processor or perform processing according to a protocol processing method to acquire data obtained at a previous step of the transmission processor. The reception processor may deliver the acquired data to the decapsulation-processor, and may deliver metadata information received from the reception unit to the metadata parser.

The decapsulation-processor may decapsulate the 6DoF video data received in the form of file from the reception-processor. The decapsulation-processor may decapsulate the files to be matched with the corresponding file format to acquire 6DoF video and/or metadata. The acquired 6DoF video data may be delivered to the data decoder, and the acquired 6DoF metadata may be delivered to the metadata parser. As needed, the decapsulation-processor may receive metadata necessary for decapsulation from the metadata parser.

The data decoder may decode the 6DoF video data. The data decoder may receive metadata necessary for decoding from the metadata parser. The metadata acquired during the data decoding process may be delivered to the metadata parser and then processed.

The metadata parser may parse/decode the 6DoF video-related metadata. The metadata parser may deliver the acquired metadata to the decapsulation-processor, the data decoder, the re-projection processor, the virtual view generation/composition unit and/or the renderer.

The re-projection processor may re-project the decoded 6DoF video data. The re-projection processor may re-project the 6DoF video data per view/position in a 3D space. The 3D space may have different forms depending on the 3D models that are used, or may be re-projected on the same type of 3D model through a conversion process. The re-projection processor may receive metadata necessary for re-projection from the metadata parser. The re-projection processor may deliver the metadata defined during the re-projection process to the metadata parser. For example, the re-projection processor may receive 3D model of the 6DoF video data per view/position from the metadata parser. If 3D model of video data is different per view/position and video data of all views are re-projected in the same 3D model, the re-projection processor may deliver the type of the 3D model that is applied, to the metadata parser. In some embodiments, the re-projection processor may re-project only a specific area in the 3D space using the metadata for re-projection, or may re-project one or more specific areas.

The virtual view generation/composition unit may generate video data, which are not included in the 6DoF video data re-projected by being transmitted and received on the 3D space but need to be reproduced, in a virtual view area by using given data, and may compose video data in a new view/position based on the virtual view. The virtual view generation/composition unit may use data of the depth information processor (not shown) when generating video data of a new view. The virtual view generation/composition unit may generate/compose the specific area received from the metadata parser and a portion of a peripheral virtual view area, which is not received. The virtual view generation/composition unit may selectively be performed, and is performed when there is no video information corresponding to a necessary view and position.

The renderer may render the 6DoF video data delivered from the re-projection unit and the virtual view generation/composition unit. As described above, all the processes occurring in the re-projection unit or the virtual view generation/composition unit on the 3D space may be incorporated within the renderer such that the renderer can perform these processes. In some embodiments, the renderer may render only a portion that is being viewed by a user and a portion on a predicted path in accordance with the user's view/position information.

In embodiments, the feedback processor (reception side) and/or the network interface (not shown) may be included as additional components. The feedback processor of the reception side may acquire and process feedback information from the renderer, the virtual view generation/composition unit, the re-projection processor, the data decoder, the decapsulation unit and/or the VR display. The feedback information may include viewport information, head and position orientation information, gaze information, and gesture information. The network interface may receive the feedback information from the feedback processor, and may transmit the feedback information to the transmission unit. The feedback information may be consumed in each component of the reception side. For example, the decapsulation processor may receive position/viewpoint information of the user from the feedback processor, and may perform decapsulation, decoding, re-projection and rendering for corresponding position information if there is the corresponding position information in the received 6DoF video. If there is no corresponding position information, the 6DoF video located near the corresponding position may be subjected to decapsulation, decoding, re-projection, virtual view generation/composition, and rendering.

The components of the aforementioned 6DoF video reception apparatus may be hardware components implemented by hardware. In some embodiments, the respective components may be modified or omitted or new components may be added thereto, or may be replaced with or incorporated into the other components.

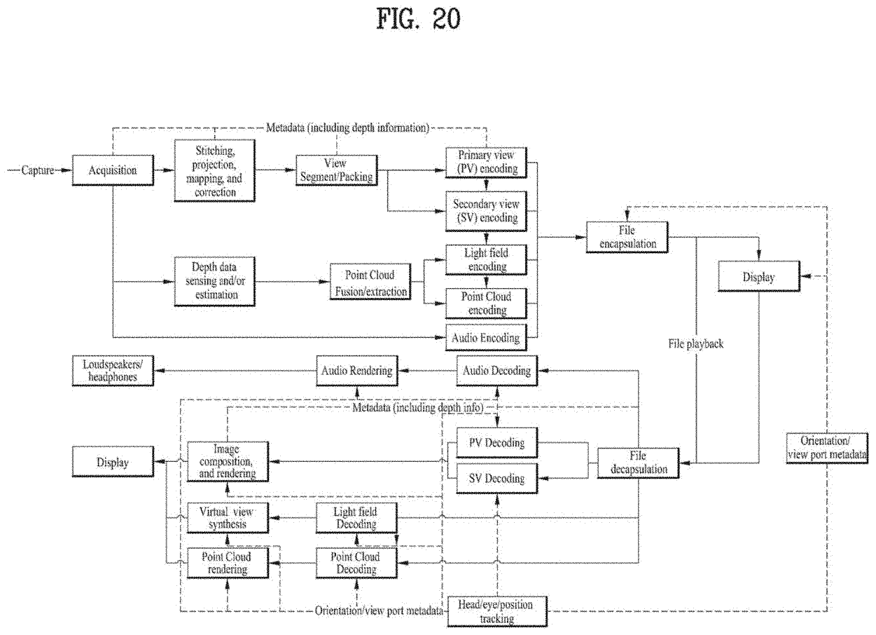

FIG. 20 is a view showing a configuration of 6DoF video transmission/reception apparatus.

6DoF contents may be provided in the form of file or segment based download or streaming service such as DASH, or a new file format or streaming/download service method may be used. In this case, 6DoF contents may be called immersive media contents, light field contents, or point cloud contents.

As described above, each process for providing a corresponding file and streaming/download services may be described in detail as follows.

Acquisition: is an output obtained after being captured from a camera for acquiring multi view/stereo/depth image, and two or more videos/images and audio data are obtained, and a depth map in each scene may be acquired if there is a depth camera.

Audio Encoding: 6DoF audio data may be subjected to audio pre-processing and encoding. In this process, metadata may be generated, and related metadata may be subjected to encapsulation/encoding for transmission.

Stitching, Projection, mapping, and correction: 6DoF video data may be subjected to editing, stitching and projection of the image acquired at various positions as described above. Some of these processes may be performed in accordance with the embodiment, or all of the processes may be omitted and then may be performed by the reception side.

View segmentation/packing: As described above, the view segmentation/packing processor may segment images of a primary view (PV), which are required by the reception side, based on the stitched image and pack the segmented images and then perform pre-processing for packing the other images as secondary views. Size, resolution, etc. of the primary view and the secondary views may be controlled during the packing process to enhance coding efficiency. Resolution may be varied even within the same view depending on a condition per region, or rotation and rearrangement may be performed depending on the region.

Depth sensing and/or estimation: is intended to perform a process of extracting a depth map from two or more acquired videos if there is no depth camera. If there is a depth camera, a process of storing position information as to a depth of each object included in each image in image acquisition position may be performed.

Point Cloud Fusion/extraction: a process of modifying a previously acquired depth map to data capable of being encoded may be performed. For example, a pre-processing of allocating a position value of each object of image on 3D by modifying the depth map to a point cloud data type may be performed, and a data type capable of expressing 3D space information not the pointer cloud data type may be applied.

PV encoding/SV encoding/light field/point cloud encoding: each view may previously be packed or depth information and/or position information may be subjected to image encoding or video encoding. The same contents of the same view may be encoded by bitstreams different per region. There may be a media format such as new codec which will be defined in MPEG-I, HEVC-3D and OMAF++.

File encapsulation: The encoded 6DoF video data may be processed in a file format such as ISOBMFF by file-encapsulation which is the encapsulation processor. Alternatively, the encoded 6DoF video data may be processed to segments.

Metadata (including depth information): Like the 6DoF vide data processing, the metadata generated during stitching, projection, view segmentation/packing, encoding, and encapsulation may be delivered to the metadata processor, or the metadata generated by the metadata processor may be delivered to each process. Also, the metadata generated by the transmission side may be generated as one track or file during the encapsulation process and then delivered to the reception side. The reception side may receive the metadata stored in a separate file or in a track within the file through a broadcast network or a broadband.

Delivery: file and/or segments may be included in a separate track for transmission based on a new model having DASH or similar function. At this time, MPEG DASH, MMT and/or new standard may be applied for transmission.

File decapsulation: The reception apparatus may perform processing for 6DoF video/audio data reception.

Audio decoding/Audio rendering/Loudspeakers/headphones: The 6DoF audio data may be provided to a user through a speaker or headphone after being subjected to audio decoding and rendering.

PV/SV/light field/point cloud decoding: The 6DoF video data may be image or video decoded. As a codec applied to decoding, a codec newly proposed for 6DoF in HEVC-3D, OMAF++ and MPEG may be applied. At this time, a primary view PV and a secondary view SV are segmented from each other and thus video or image may be decoded within each view packing, or may be decoded regardless of view segmentation. Also, after light field and point cloud decoding are performed, feedback of head, position and eye tracking is delivered and then image or video of a peripheral view in which a user is located may be segmented and decoded.

Head/eye/position tracking: a user's head, position, gaze, viewport information, etc. may be acquired and processed as described above.

Point Cloud rendering: when captured video/image data are re-projected on a 3D space, a 3D spatial position is configured, and a process of generating a 3D space of a virtual view to which a user can move is performed although the virtual view is failed to be obtained from the received video/image data.

Virtual view synthesis: a process of generating and synthesizing video data of a new view is performed using 6DoF video data already acquired near a user's position/view if there is no 6DoF video data in a space in which the user is located, as described above. In some embodiments, the virtual view generation and/or composition process may be omitted.

Image composition, and rendering: as a process of rendering image based on a user's position, video data decoded in accordance with the user's position and eyes may be used or video and image near the user, which are made by the virtual view generation/composition, may be rendered.

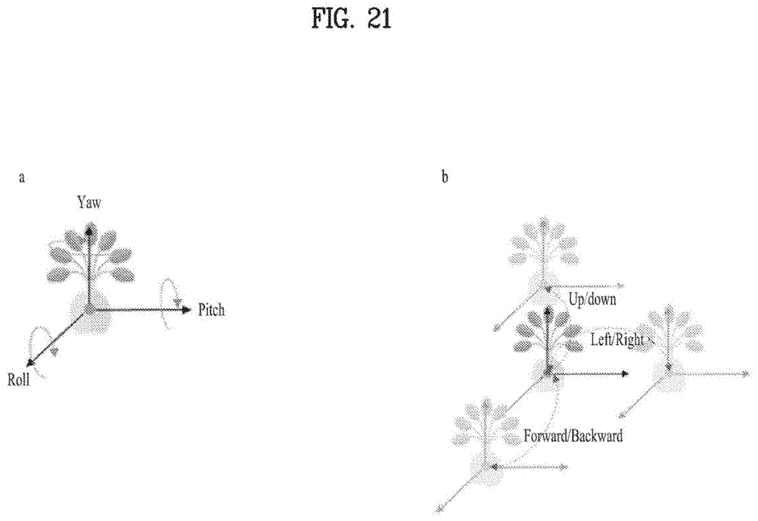

FIG. 21 is a view showing 6DoF space.

In embodiments, a 6DoF space before projection or after re-projection will be described and the concept of FIG. 21 may be used to perform corresponding signaling.

The 6DoF space may categorize an orientation of movement into two types, rational and translation, unlike the case that the 360-degree video or 3DoF space is described by yaw, pitch and roll. Rational movement may be described by yaw, pitch and roll as described in the orientation of the existing 3DoF like ‘a’, and may be called orientation movement. On the other hand, translation movement may be called position movement as described in ‘b’. Movement of a center axis may be described by definition of one axis or more to indicate a moving orientation of the axis among Left/Right orientation, Forward/Backward orientation, and Up/down orientation.

Embodiments propos an architecture for 6DoF video service and streaming, and also proposes basic metadata for file storage and signaling for future use in the invention for 6DoF related metadata and signaling extension.
Metadata generated in each process may be extended based on the proposed 6DoF transceiver architecture.
Metadata generated among the processes of the proposed architecture may be proposed.
6DoF video related parameter of contents for providing 6DoF video services by later addition/correction/extension based on the proposed metadata may be stored in a file such as ISOBMFF and signaled.

6DoF video metadata may be stored and signaled through SEI or VUI of 6DoF video stream by later addition/correction/extension based on the proposed metadata.

Region (meaning in region-wise packing): region may mean a region where 360-degree video data projected on 2D image are located in a packed frame through region-wise packing. In this case, the region may mean a region used in region-wise packing in accordance with the context. As described above, regions may be identified by equally dividing 2D image, or may be identified by being randomly divided in accordance with a projection scheme.

Region (general meaning): unlike the region in the aforementioned region-wise packing, the terminology, region may be used as a dictionary definition. In this case, the region may mean ‘area’, ‘zone’, ‘portion’, etc. For example, when the region means a region of a face which will be described later, the expression ‘one region of a corresponding face’ may be used. In this case, the region is different from the region in the aforementioned region-wise packing, and both regions may indicate their respective areas different from each other.

Picture: picture may mean the entire 2D image in which 360-degree video data are projected. In some embodiments, a projected frame or a packed frame may be the picture.

Sub-picture: sub-picture may mean a portion of the aforementioned picture. For example, the picture may be segmented into several sub-pictures to perform tiling. At this time, each sub-picture may be a tile. In detail, an operation of reconfiguring tile or MCTS as a picture type compatible with the existing HEVC may be referred to as MCTS extraction. A result of MCTS extraction may be a sub-picture of a picture to which the original tile or MCTS belongs.

Tile: tile is a lower concept of a sub-picture, and the sub-picture may be used as a tile for tiling. That is, the sub-picture and the tile in tiling may be the same concept. In detail, the tile may be a tool enabling parallel decoding or a tool for independent decoding in VR. In VR, tile may mean MCTS (Motion Constrained Tile Set) that restricts a range of temporal inter prediction to a current tile internal range. Therefore, the tile herein may be called MCTS.

Spherical region: spherical region or sphere region may mean one region on a spherical surface when 360-degree video data are rendered on a 3D space (for example, spherical surface) at the reception side. In this case, the spherical region is regardless of the region in the region-wise packing. That is, the spherical region does not need to mean the same region defined in the region-wise packing. The spherical region is a terminology used to mean a portion on a rendered spherical surface, and in this case, ‘region’ may mean ‘region’ as a dictionary definition. In accordance with the context, the spherical region may simply be called region.

Face: face may be a terminology for each face in accordance with a projection scheme. For example, if cube map projection is used, a front face, a rear face, side face, an upper face, or a lower face may be called face.

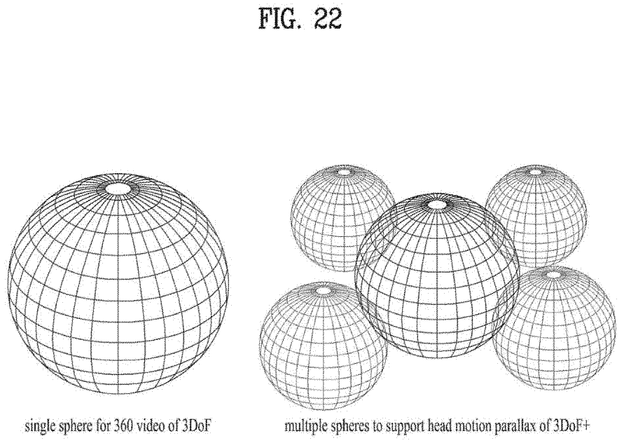

FIG. 22 is conceptual comparison of 3DoF VR/AR video without/with head motion parallax in accordance with embodiments.

360 video data of 3DoF is represented as a single sphere. 360 video data of 3DoF+ is represented as multiple spheres to support head motion parallax.

Apparatuses and/or methods in accordance with embodiments address packing, coding, and delivery of multiple videos sources which constitutes a video content/service such as 3DoF (degrees of freedom) and 6DoF omnidirectional video/service. As an example of the 3DoF and 6DoF omnidirectional videos, the multiple videos could represent different views at a location, which receivers could generate a video with head motion parallax and/or binocular disparity, or different viewpoints, which receivers could generate interactive video with changing locations.

Following is focused on a format of SEI message syntax elements and semantics for MPEG video codec. However, other formats of video level, e.g., parameters sets, and/or future or current video codecs, system level, e.g., file format, DASH, MMT, and 3GPP, or digital interfaces, e.g., HDMI, DisplayPort, and VESA, could be possible with the same features described below.

in accordance with embodiments, in a content flow process for an omnidirectional media application with projected video of 3DoF, the captured images compose a sphere, which provides viewport from a static viewpoint. Since the viewing position is assumed to be unchanged so it is not easy to provide interactivity between viewer and the VR environment. To provide different viewing experience with viewer's action in the VR environment, changing viewing position with a limitation of viewing boundary should be considered. The different view due to the different viewing position is called head motion parallax.

As described above, in accordance with embodiments, the head motion parallax could provide viewers certain degree of freedom of head motion with realistic viewing experience. To support the feature, the ideal content is consist of multiple spheres adjacent to the anchor (or center) sphere while the current content for 3DoF only considers a single sphere. As additional spherical information should be considered for subsidiary viewing positions, the current content work flow of 3DoF service which is based on the single sphere content should be changed, such as image capture, projection, packing format, file encapsulation, delivery, file decapsulation, rendering process might be changed.

In accordance with an apparatus for transmitting a video and an apparatus for receiving a video can provide effects of transmitting/receiving 360 video data (or video data, a video) more efficiently for head motion parallax.

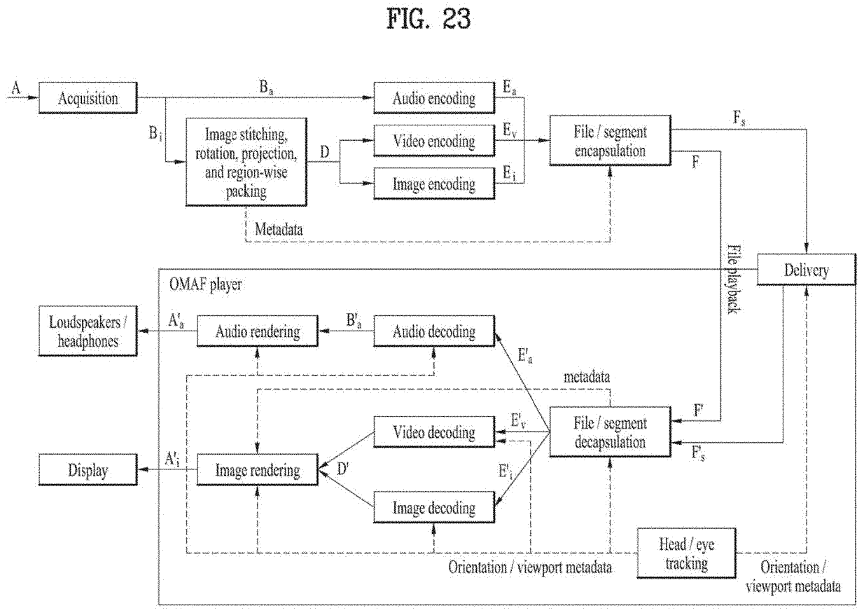

FIG. 23 is a content flow process for omnidirectional media with projected video of 3DoF in accordance with embodiments.

An apparatus for transmitting a video in accordance with embodiments includes a pre-processor, an encoder and/or an encapsulator.

The pre-processor performs acquisition operation to acquire image/video and audio data. The pre-processor further performs image stitching, rotation, projection and/or region-wise packing and generating metadata.

In accordance with embodiments, the pre-processor can correspond to a hardware, a software, a processor which can be operated by a hardware and/or a software.

The encoder performs audio encoding, video encoding and/or image encoding.

The encapsulator performs encapsulating encoded audio(s), encoded video(s) and/or encoded image(s) into a format of File and/or a format of Segment. The file and/or the segment can be delivered based on a delivery method which is based on DASH, an internet method and/or a physical method.

An apparatus for receiving a video in accordance with embodiments includes a decapsulator, a head/eye tracker, a decoder, a renderer and/or a displayer. The apparatus for receiving a video performs an inverse operation of the apparatus for transmitting a video in accordance with embodiments.

The decapsulator decapsulates File(s) Segment(s) and/or Metadata in the received video.

The decoder performs audio decoding, video decoding and/or image decoding with respect to the decapsulated audio(s), the decapsulated video(s) and/or the decapsulated image(s).

The renderer performs audio rendering and/or image rendering with respect to the decoded audio, the decoded video and/or the decoded image based on Metadata.

The displayer displays the rendered image. The rendered audio is output via loudspeakers and/or headphones.

The head/eye tracker can acquire information related to an user, for example orientation information and/or viewport metadata in order to provide information related to an user to a receiver (a decapsulator, a decoder and/or a renderer) and/or a transmitter (an encapsulator, an encoder and/or a pre-processor). Therefore, in accordance with embodiments, each operation of a transmitter and a receiver is performed with respect to all video data (including an audio, an image, a video) and/or a specific video data (including an audio, an image, a video) related to orientation information and/or viewport metadata more efficiently.

In accordance with embodiments, the content flow process for omnidirectional media with projected video of conventional 3DoF service is described.

A real-world audio-visual scene (A) is captured by audio sensors as well as a set of cameras or a camera device with multiple lenses and sensors. The acquisition results in a set of digital image/video (Bi) and audio (Ba) signals. The cameras/lenses typically cover all directions around the centre point of the camera set or camera device, thus the name of 360-degree video.

The images (Bi) of the same time instance are stitched, possibly rotated, projected, and mapped onto a packed picture (D).

The packed pictures (D) are encoded as coded images (Ei) or a coded video bitstream (Ev). The captured audio (Ba) is encoded as an audio bitstream (Ea). The coded images, video, and/or audio are then composed into a media file for file playback (F) or a sequence of an initialization segment and media segments for streaming (Fs), according to a particular media container file format. In this document, the media container file format is the ISO Base Media File Format specified in ISO/IEC 14496-12. The file encapsulator also includes metadata into the file or the segments, such as projection and region-wise packing information assisting in rendering the decoded packed pictures.

The segments Fs are delivered using a delivery mechanism to a player.

The file that the file encapsulator outputs (F) is identical to the file that the file decapsulator inputs (F′). A file decapsulator processes the file (F′) or the received segments (F's) and extracts the coded bitstreams (E′a, E′v, and/or E′i) and parses the metadata. The audio, video, and/or images are then decoded into decoded signals (B′a for audio, and D′ for images/video). The decoded packed pictures (D′) are projected onto the screen of a head-mounted display or any other display device based on the current viewing orientation or viewport and the projection, spherical coverage, rotation, and region-wise packing metadata parsed from the file. Likewise, decoded audio (B′a) is rendered, e.g. through headphones, according to the current viewing orientation. The current viewing orientation is determined by the head tracking and possibly also eye tracking functionality. Besides being used by the renderer to render the appropriate part of decoded video and audio signals, the current viewing orientation may also be used by the video and audio decoders for decoding optimization.

The process described above is applicable to both live and on-demand use cases.

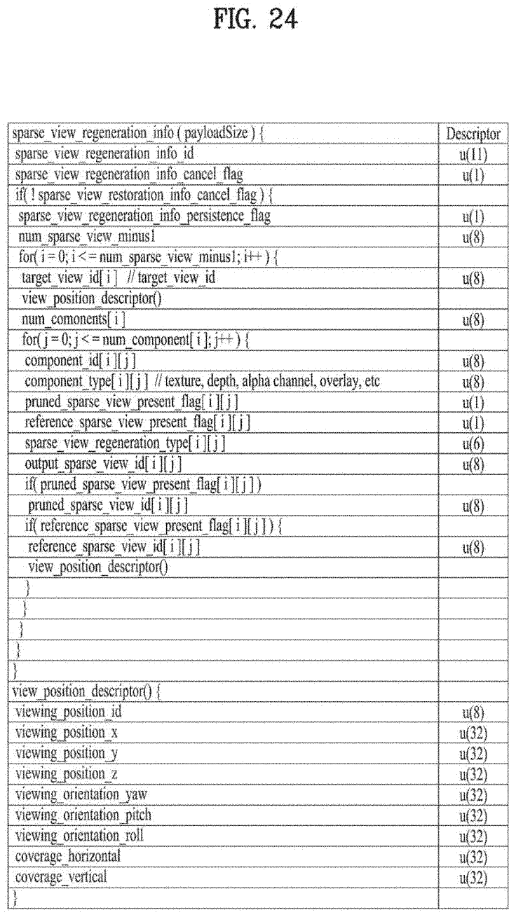

FIG. 24 is sparse view regeneration information SEI message syntax in accordance with embodiments.

An apparatus for transmitting a video and an apparatus for receiving a video in accordance with embodiments use (transmit/receive) sparse view regeneration information which can be referred to as signaling information and/or metadata in order to regenerate texture and depth pictures for a viewing positions.

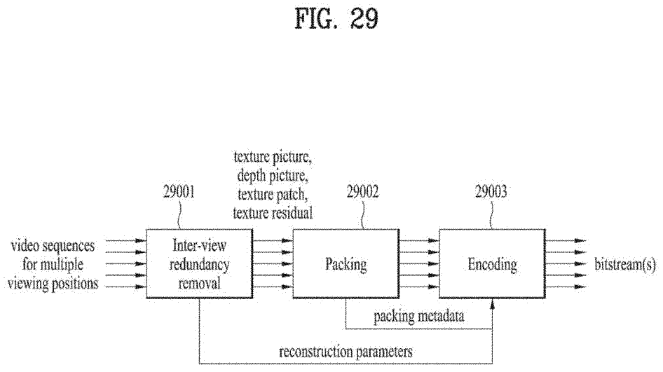

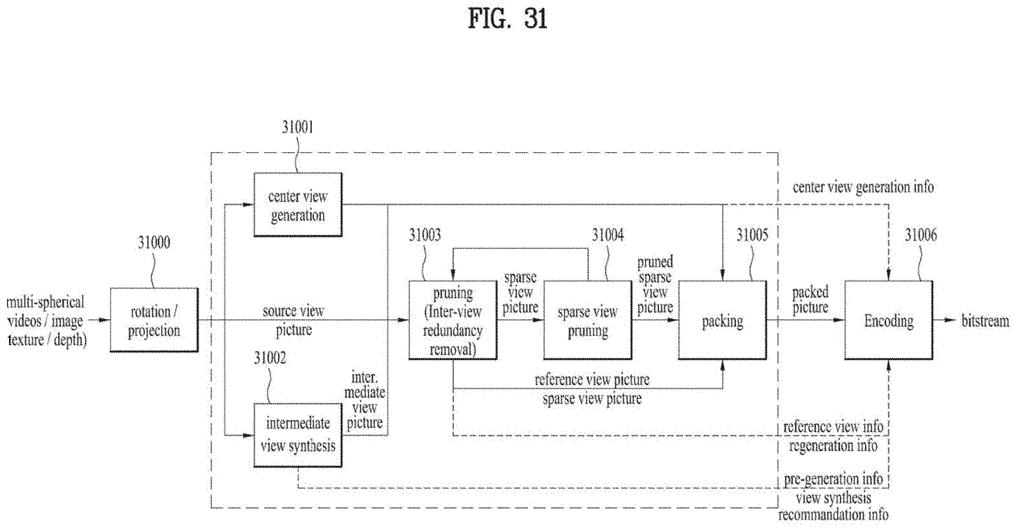

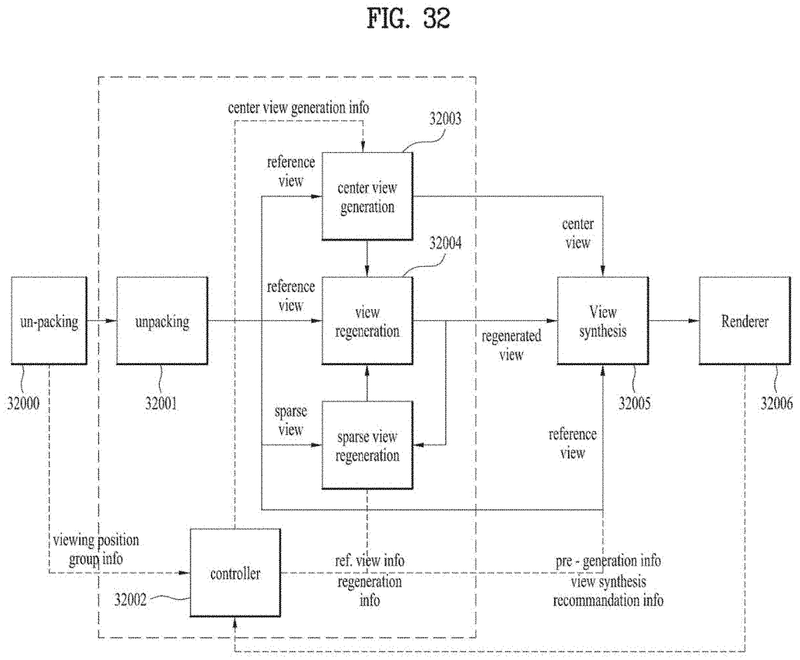

Signaling information (sparse view regeneration information) in accordance with embodiments can be generated in a process of sparse view pruning which is more specifically described in FIG. 31. Signaling information (sparse view regeneration information) in accordance with embodiments can be used in a process of sparse view regeneration which is more specifically described in FIG. 32. In accordance with embodiments, Signaling information (sparse view regeneration information) is used in FIGS. 29 to 42.

The configuration, operation and other features of the disclosure be understood by embodiments of the disclosure described with reference to the accompanying drawings.

In the following, multiple methodologies to support efficient delivery of multiple spherical images which represent different viewing position of a viewpoint are provided. The detailed description includes the view regeneration information SEI message or Multiview packing and view regeneration information SEI message.

The sparse view regeneration information SEI message provides information to enable regeneration of the sparse view that is used to regenerate the texture and depth pictures for a viewing positions.

sparse_view_regeneration_info_id contains an identifying number that may be used to identify the purpose of sparse view regeneration. The value of sparse_view_regeneration_info_id may be used to indicate the different use cases of this SEI message, to support different receiver capabilities, or to indicate the different sparse view regeneration methods, or to indicate the different viewing positions that need sparse view regeneration process before the view regeneration of the texture or depth etc.

When more than one sparse view regeneration information SEI message is present with the same value of sparse_view_regeneration_info_id, the content of these sparse view regeneration information SEI messages shall be the same. When sparse view regeneration information SEI messages are present that have more than one value of sparse_view_regeneration_info_id, this may indicate that the information indicated by the different values of sparse_view_regeneration_info_id are alternatives that are provided for different purposes, for different component (such as texture, depth, etc.) or that a cascading of correction. The value of sparse_view_regeneration_info_id shall be in the range of 0 to 2¹²−1, inclusive.

sparse_view_regeneration_info_cancel_flag equal to 1 indicates that the sparse view regeneration information SEI message cancels the persistence of any previous sparse view regeneration information SEI message in output order that applies to the current layer.

sparse_view_regeneration_info_cancel_flag equal to 0 indicates that sparse view regeneration information follows.

sparse_view_regeneration_info_persistence_flag specifies the persistence of the sparse view regeneration information SEI message for the current layer.

sparse_view_regeneration_info_persistence_flag equal to 0 specifies that the sparse view regeneration information applies to the current decoded picture only.

Let picA be the current picture. sparse_view_regeneration_info_persistence_flag to 1 specifies that the sparse view regeneration information SEI message persists for the current layer in output order until any of the following conditions are true:

A new CLVS of the current layer begins.

The bitstream ends.

A picture picB in the current layer in an access unit containing a sparse view regeneration information SEI message that is applicable to the current layer is output for which PicOrderCnt (picB) is greater than PicOrderCnt (picA), where PicOrderCnt (picB) and PicOrderCnt (picA) are the PicOrderCntVal values of picB and picA, respectively, immediately after the invocation of the decoding process for the picture order count of picB.

num_sparse_view_minus1 plus 1 specifies the number of views that needs sparse view regeneration process to generate the component of the viewing position by this SEI message.

target_view_id specifies the i-th identifying number of the viewing position or head position of the sparse view regeneration process. This value should be one of the pre-defined identifying number of a viewing positions of a 3DoF+ video specified in the same or in the other SEI message, such as mrwp_view_id specified in the multiview region-wise packing SEI message, viewing_position_id specified in the viewing position group information SEI message.

In accordance with embodiments, target view id [i] represents identifier information for a target view.

num_components[i] specifies the number of the components that are related to the i-th view.

component_id[i][j] specifies the identifying number of the j-th component of a reference viewing position or head position that is used to estimate (to regenerate, to reconstruct, or to predict) the i-th component. This value should be one of the pre-defined identifying number of a component that belongs to a viewing positions of a 3DoF+ video specified in the same or in the other SEI message, such as mrwp_component_id specified in the multiview region-wise packing SEI message.

component_type[i][j] specifies the type of the i-th component.

component_type[i][j] equal to 0 indicates the type of the component is unspecified.

component_type[i][j] equal to 1 indicates the component is a video or texture component

component_type[i][j] equal to 2 indicates the component is a depth map.

component_type[i][j] equal to 3 indicates the component is an alpha channel. When the value of a pixel equals to 1, the value in a texture picture at the corresponding pixel location is not transparent. When the value of a pixel equals to 0, the value in a texture picture at the corresponding pixel location is transparent.

component_type[i][j] equal to 4 indicates the component is an indication map for usability indication. When the value of a pixel equals to 1, the value in a texture or depth picture at the corresponding pixel location is used for occlusion enhancement process. When the value of a pixel equals to 1, the value in a texture or depth picture at the corresponding pixel location is not used for occlusion enhancement process.

component_type[i][j] equal to 5 indicates the component is a overlay.

component_type[i][j] from 6 to 15, inclusive, are reserved for future use.

In accordance with embodiments, component type information represents a texture, a depth, a alpha channel, overlay, etc.

pruned_sparse_view_present_flag[i][j] equal to 1 specifies the pruned_sparse_view is present for the j-th component of the i-th viewing position. pruned_sparse_view_present_flag[i][j] equal to 0 specifies the pruned_sparse_view is not present for the j-th component of the i-th viewing position so sparse view regeneration process shall be processed without additional information, e.g., prediction of reference sparse view or directly predict the sparse view from the reference views.

reference_sparse_view_present_flag[i][j] equal to 1 specifies the reference sparse view is present for the j-th component of the i-th viewing position. reference_sparse_view_present_flag[i][j] equal to 0 specifies the reference sparse view is not present for the j-th component of the i-th viewing position so the view regeneration of the.

sparse_view_regeneration_type[i][j] specifies the indicator of the recommended sparse view regeneration process for the j-th component of the i-th viewing position.

sparse_view_regeneration_type[i][j] equal to 0 indicates the type of the recommended sparse view regeneration is unspecified.

sparse_view_regeneration_type[i][j] equal to 1 indicates that the sparse view regeneration scheme 1 is recommended. In this document, type 1 could be a scheme that uses both reference sparse view and pruned sparse view to regenerate the sparse view of the j-th component of the i-th viewing position.

sparse_view_regeneration_type[i][j] equal to 2 indicates that the sparse view regeneration scheme 2 is recommended. In this document, type 2 could be the scheme that predicts the sparse view from the reference sparse view without pruned sparse view of the j-th component of the i-th viewing position.

sparse_view_regeneration_type[i][j] equal to 3 indicates that the sparse view regeneration scheme 3 is recommended. In this document, type 3 could be the scheme that predicts the sparse view from the regenerated view without pruned sparse view of the j-th component of the i-th viewing position.

sparse_view_regeneration_type[i][j] equal to 4 indicates that the sparse view regeneration scheme 4 is recommended. In this document, type 4 could be the scheme that predicts the regenerated view with the adjacent regenerated view.

Other values of sparse_view_regeneration_type[i][j] are reserved for future use cases.

pruned_sparse_view_id[i][j] and reference_sparse_view_id[i][j] specifies the identifying number of the pruned sparse view and reference sparse view those are related to the sparse view regeneration of the j-th component of the i-th viewing position or head position.

This value should be one of the pre-defined identifying number of a component that belongs to a viewing positions of a 3DoF+ video specified in the same or in the other SEI message, such as mrwp_component_id specified in the multiview region-wise packing SEI message, or picture_id specified in the viewing position group information SEI message.

In the other implementation of the sparse view regeneration, the identifier could be managed within the receiver decoder post-processing so that could provide linkage between pictures generated from unpacking process and the pictures used for the view regeneration including sparse view regeneration or view synthesis and viewport renderer.

In case of reference sparse view, the view position could be provided to use the disparity between the current and the reference viewing positions.

For the sparse view regeneration process, the identifier of texture and/or depth of the current and/or other viewing position could be provided to utilize the information in the other component type.

In each of the j-th component of the i-th viewing position, detailed parameter values which could be used in the sparse view regeneration process, such as location of each patches, global/local disparity values between pictures/patches, weighting functions, etc, could be provided.

viewing_position_id indicate the identifier of a viewing position that is described by the viewing position, orientation and coverage, specified by viewing_position_x, viewing_position_y, and viewing_position_z, viewing_orientation_yaw, viewing_orientation_pitch, and viewing_orientation_roll, and coverage_horizontal and coverage_vertical, respectively. The parameters or features which describe the viewing position could be added to differentiate different viewing positions.

viewing_position_x, viewing_position_y, and viewing_position_z indicate the (x,y,z) location of viewing position corresponding to the decoded picture in the units of 2⁻¹⁶ millimeters, respectively The range of viewing_position_x, viewing_position_y and viewing_position_z shall be in the range of −32768*2¹⁶−1 (i.e., −2147483647) to 32768*2¹⁶ (i.e., 2147483648), inclusive.

The value of viewing_position_x, viewing_position_y and viewing_position_z could be represented by absolute position in the XYZ coordinate or relative position corresponding to the anchor location.

viewing_orientation_yaw, viewing_orientation_pitch, and viewing_orientation_roll indicate the yaw, pitch, and roll orientation angles in units of 2⁻¹⁶ degrees, respectively. The value of viewing_orientation_yaw shall be in the range of −180*2¹⁶ (i.e., −11796480) to 180*2¹⁶−1 (i.e., 11796479), inclusive, the value of viewing_orientation_pitch shall be in the range of −90*2¹⁶ (i.e., −5898240) to 90*2¹⁶ (i.e., 5898240), inclusive, and the value of viewing_orientation_roll shall be in the range of −180*2¹⁶ (i.e., −11796480) to 180*2¹⁶−1 (i.e., 11796479), inclusive.

Depending on the applications, viewing_orientation_yaw, viewing_orientation_pitch, and viewing_orientation_roll could be used to indicate azimuth, elevation, and tilt, respectively. Also, viewing_orientation_yaw, viewing_orientation_pitch, and viewing_orientation_roll could represent the rotation that is applied to the unit sphere of head position corresponding to the decoded picture to convert the local coordinate axes to the global coordinate axes, respectively.

coverage_horizontal and coverage_vertical specifies the horizontal and vertical ranges of the coverage of the viewing position corresponding to the decoded picture, in units of 2⁻¹⁶ degrees, respectively.

An apparatus for transmitting a video and an apparatus for receiving a video in accordance with embodiments can provide effects of decreasing/removing redundancy between reference views due to signaling information in accordance with embodiments. Furthermore, An apparatus for transmitting a video and an apparatus for receiving a video in accordance with embodiments can provide effects of decreasing/removing redundancy between sparse views due to signaling information in accordance with embodiments. Therefore, embodiments can regenerate, encode and/or decode 3DoF+ VR video data more efficiently.

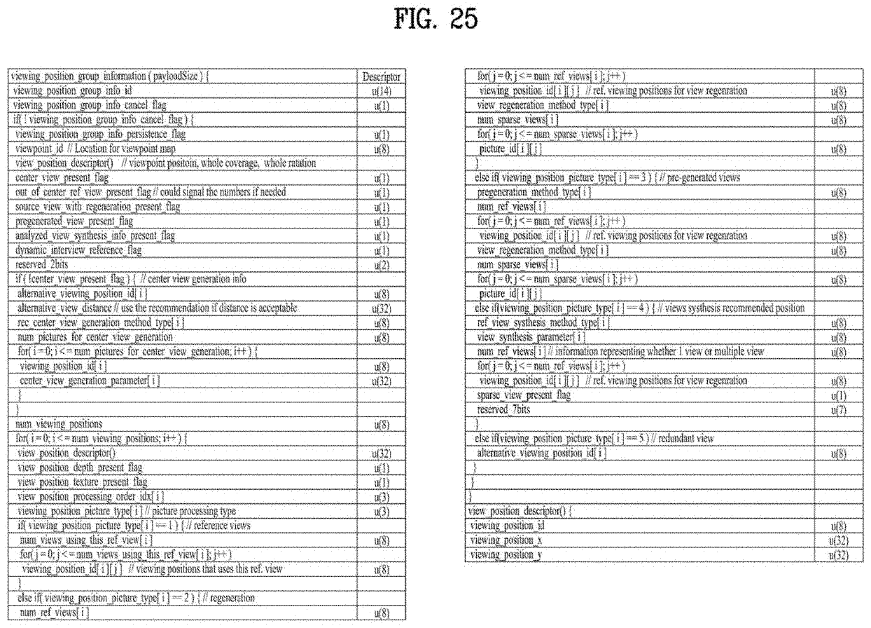

FIG. 25 is Viewing position group information SEI message syntax in accordance with embodiments.

An apparatus for transmitting a video and an apparatus for receiving a video in accordance with embodiments use (transmit/receive) a Viewing position group information SEI message which can be referred to as signaling information.

In accordance with embodiments, Viewing position group information includes packing metadata, reconstruction parameters, view synthesis parameters, center view generation information, reference view information, regeneration information, pre-generation information and/or view synthesis recommendation information as depicted FIGS. 29 to 31.

In accordance with embodiments, an apparatus for transmitting a video transmits signaling information including Viewing position group information via bitstreams and an apparatus for receiving a video receives signaling information including Viewing position group information via bitstreams.

The Viewing position group information SEI message provides information of the a viewing position group and the relationship between them in the 3D virtual space and post-decoding process (e.g., regeneration process to restore pictures of intended viewing positions) corresponding to a viewpoint (or center/anchor viewing position).

viewing_position_group_info_id contains an identifying number that may be used to identify the purpose of the viewing position group information. The value of viewing_position_group_info_id may be used to indicate the different use cases of this SEI message, to support different receiver capabilities, or to indicate different level of information contained in the SEI message, different viewpoint, or different group of viewpoints, etc.

When more than one viewing position information SEI message is present with the same value of viewing_posidion_group_info_id, the content of these viewing position group information SEI messages shall be the same. When viewing position group information SEI messages are present that have more than one value of viewing_position_group_info_id, this may indicate that the information indicated by the different values of viewing_posidion_group_info_id are alternatives that are provided for different purposes or that a cascading of correction to be applied in a sequential order (an order might be specified depending on the application). The value of viewing_posidion_group_info_id shall be in the range of 0 to 2¹²−1, inclusive.

viewing_position_group_info_cancel_flag equal to 1 indicates that the viewing position group information SEI message cancels the persistence of any previous viewing position group information SEI message in output order that applies to the current layer. viewing_position_group_info_cancel_flag equal to 0 indicates that viewing position group information follows.

viewing_position_group_info_persistence_flag specifies the persistence of the viewing position group information SEI message for the current layer.

viewing_position_group_info_persistence_flag equal to 0 specifies that the viewing position group information applies to the current decoded picture only.

Let picA be the current picture. viewing_position_group_info_persistence_flag to 1 specifies that the viewing position group information SEI message persists for the current layer in output order until any of the following conditions are true:

A new CLVS of the current layer begins.

The bitstream ends.

A picture picB in the current layer in an access unit containing a viewing position group information SEI message that is applicable to the current layer is output for which PicOrderCnt (picB) is greater than PicOrderCnt (picA), where PicOrderCnt (picB) and PicOrderCnt (picA) are the PicOrderCntVal values of picB and picA, respectively, immediately after the invocation of the decoding process for the picture order count of picB.

viewpoint_id specifies the identifier that indicates the viewpoint of the viewing position group that is described in this SEI message. The viewpoint_id might be defined in the other SEI message to describe the overall viewpoints that consists the overall VR/AR environment or subset of viewpoints those are related to each other with spatially or conceptually adjacent so that user could switch from one position to the other positions.

The viewpoint could be one of the viewing positions, such as center viewing position or anchor viewing position, which could represent the viewing position group.

The details of viewpoint could be described by XYZ position, viewing orientation (yaw, pitch, and roll), and horizontal and vertical coverage described in view_point_descriptor( ). In this case, the viewing_position_id could indicate one of the viewing position defined in this SEI message.

In accordance with embodiments, view point id information represents location information with respect to viewpoint map information that is present.

view_position_descriptor( ) represents viewpoint information, coverage information and/or rotation information and includes viewing_position_id, viewing_position_x, viewing_position_y, viewing_position_z, viewing_position_yaw, viewing_position_pitch, viewing_position_roll, coverage_horizontal and/or coverage_vertical, etc. center_view_present_flag equal to 1 indicate that the video corresponding to the center (or anchor or representative) viewing position is present in the group of videos for this viewpoint corresponding to viewpoint_id. center_view_present_flag equal to 0 indicate that the video the corresponding to the center (or anchor or representative) viewing position is not present in the group of videos for this viewpoint corresponding to viewpoint_id.

center_view_present_flag might be set equal to 1 when at least one viewing position whose viewing_position_picture_type[i] equal to 0 is present in the current SEI message.

out_of_center_ref_view_present_flag equal to 1 indicate that the video that are not corresponding to the center (or anchor or representative) viewing position is present in the group of videos for this viewpoint corresponding to viewpoint_id. out_of_center_ref_view_present_flag equal to 0 indicate that the video that are not corresponding to the center (or anchor or representative) viewing position is not present in the group of videos for this viewpoint corresponding to viewpoint_id.

In accordance with embodiments, out_of_center_ref_view_present_flag could signal the numbers if needed.

out_of_center_ref_view_present_flag might be set equal to 1 when at least one viewing position whose viewing_position_picture_type[i] equal to 1 is present in the current SEI message.

source_view_with_regeneration_present_flag equal to 1 indicate that viewing position that needs additional processing(s) to reconstruct a intended picture is included in the set of viewing positions of a viewpoint that corresponding to the current viewpoint_id. source_view_with_regeneration_present_flag equal to 0 indicate that viewing position that needs additional processing(s) to reconstruct a intended picture is not included in the set of viewing positions of a viewpoint that corresponding to the current viewpoint_id.

source_view_with_regeneration_present_flag might be set equal to 1 when at least one viewing position whose viewing_position_picture_type[i] equal to 2 is present in the current SEI message.

pregenerated_view_present_flag equal to 1 indicate that viewing position that are not originally captured but generated before encoding is present in the set of viewing positions of a viewpoint that corresponding to the current viewpoint_id. pregenerated_view_present_flag equal to 0 indicate that viewing position that are not originally captured but generated before encoding is not present in the set of viewing positions of a viewpoint that corresponding to the current viewpoint_id.

pregenerated_view_present_flag might be set equal to 1 when at least one viewing position whose viewing_position_picture_type[i] equal to 3 is present in the current SEI message.

analyzed_view_synthesis_info_present_flag equal to 1 indicate that viewing position that additional information that could be used in the view synthesis of a intermediate view or determine the process of the intermediate view generation is present in the set of viewing positions of a viewpoint that corresponding to the current viewpoint_id. analyzed_view_synthesis_info_present_flag equal to 0 indicate that viewing position that additional information that could be used in the view synthesis of a intermediate view or determine the process of the intermediate view generation is not present in the set of viewing positions of a viewpoint that corresponding to the current viewpoint_id.

analyzed_view_synthesis_info_present_flag might be set equal to 1 when at least one viewing position whose viewing_position_picture_type[i] equal to 4 is present in the current SEI message.

dynamic_interview_reference_flag equal to 1 specifies that the reference pictures of the reconstruct/regenerate process of a viewing position could vary when time changes. dynamic_interview_reference_flag equal to 0 indicate that the reference pictures of the reconstruct/regenerate process of a viewing position does not vary when time changes so the reference picture relationship could be utilized in whole video sequences.

Center view generation information in accordance with embodiments includes information as follows:

alternative_viewing_position_id specifies the viewing position that could be used alternative to the center/anchor reference viewing position. The value of alternative_viewing_position_id shall be one of the viewing position indicated by viewing_position_id in this SEI message or related SEI message.

alternative_view_distance specifies the distance of the alternative viewing position corresponding to the alternative_viewing_position_id, in the units of 2⁻¹⁶ millimeters.

In accordance with embodiments, alternative_view_distance uses the recommendation if distance is acceptable.

rec_center_view_generation_method_type specifies the method to generate the center view when center view is not present in this SEI message. rec_center_view_generation_method_type equal to 0 represent the view synthesis method that uses given viewing positions by viewing_position_id with different weights given by center_view_generation_parameter. rec_center_view_generation_method_type equal to 1 could represent image stitching method with given viewing positions by viewing_position_id with different weights given by center_view_generation_parameter.

viewing_position_id indicates the viewing position that is used for the center view position. The value of viewing_position_id shall be one of the viewing position indicated by viewing_position_id in this SEI message or related SEI message.

center_view_generation_parameter specifies the viewing position dependent parameter that is recommended to be used in the center view generation methods indicated by rec_center_view_generation_method_type.

rec_center_view_generation_method_type, viewing_position_id, and center_view_generation_parameter are used to indicate the recommended method of center view generation. Otherwise, rec_center_view_generation_method_type, viewing_position_id, and center_view_generation_parameter could be used to indicate the method and its corresponding parameters that were used to generate the center view picture in the pre-processing before encoding. In this case, a new flag to indicate the presence of this information should be defined and used instead of center_view_present_flag not present flag.

num_viewing_position specifies the total number of viewing positions that are related to the viewpoint or center viewing position that is indicated by viewpoint_id.

view_position_depth_present_flag and view_position_texture_present_flag equal to 1 specify the depth or texture is present for the i-th viewing position, respectively. If there is other component, such as alpha channel to indicate the opacity of the pixel values at each pixel position or other layers such as overlay, logos, they could be indicated by defining flags corresponding to component.

view_position_processing_order_idx specify the processing order of the multiple viewing positions. The lower the number is, the faster the processing order. If two different viewing positions have same view_position_processing_order_idx, there is no preference in processing order.

The example use case of the view_position_processing_order_idx is the center viewing position or mostly referenced viewing position in view regeneration process. As the reference pictures are used to restore the other pictures in the view regeneration process, the reference pictures could be assigned with lower view_position_processing_order_idx compared to the non-referenced pictures. When the reference relationship is happened between non-referenced pictures or reference pictures, they could be indicated with different view_position_processing_order_idx according to the processing order.

viewing_position_picture_type specifies the picture type of the i-th viewing position in terms of picture generation.

When viewing_position_picture_type equal to 0, the i-th viewing position is a center view.

When viewing_position_picture_type equal to 1, the picture of the i-th viewing position is used as a reference picture in the view regeneration process. (representing reference views)

When viewing_position_picture_type equal to 2, the picture of the i-th viewing position will be generated from the view regeneration process. (representing regeneration)

When viewing_position_picture_type equal to 3, the picture of the i-th viewing position is pre-generated view in the encoding pre-process. (representing pre-generated views)

When viewing_position_picture_type equal to 4, the picture of the i-th viewing position might not be present in the decoded pictures but a view synthesis method is recommended with additional information. This could be used to reduce the time consumption process with regard to view synthesis. (representing views synthesis recommended position)

When viewing_position_picture_type equal to 5, the picture of the i-th viewing position might not be present in the decoded pictures but alternative picture from other viewing position is present. (representing a redundant view)

In accordance with embodiments, viewing_position_picture_type represents a picture processing type.

num_views_using_this_ref_view specifies the number of viewing positions that uses the picture of the i-th viewing position as the reference view in the regeneration process. The viewing positions that uses this reference view are indicated by viewing_position_id.

num_ref_views specifies the number of reference views that are used for the regeneration of the picture corresponding to the i-th viewing position. The reference viewing positions are indicated by the viewing_position_id.

In accordance with embodiments, num_ref_views represents whether view is 1 view or multiple views (When viewing_position_picture_type equal to 4)

view_regeneration_method_type specifies the type of view regeneration method that is used to restore the picture of the i-th viewing position. When view_regeneration_method_type equal to 0, view synthesis based prediction method is used. When view_regeneration_method_type equal to 1, block disparity prediction method is used.

num_sparse_views specifies the number of sparse views used to regenerate the picture corresponding to the i-th viewing position.

picture_id specifies the identifier which contains the j-th sparse view that is used to reconstruct the picture corresponding to the i-th viewing position.

pregeneration_method_type specifies the view generation method that is used to generate the picture corresponding to the i-th viewing position. When pregeneration_method_type equal to 0, the reference view synthesis algorithm is used. when pregeneration_method_type equal to 1, the view generation algorithm A is used.

ref_view_synthesis_method_type specifies the view synthesis method that is recommended to generate the picture corresponding to the i-th viewing position. When ref_view_synthesis_method_type equal to 0, the reference view synthesis algorithm is recommended. when ref_view_synthesis_method_type equal to 1, the view synthesis algorithm A is recommended.

alternative_view_position_id specifies the identifier that is recommended to be used as an alternative viewing position of the i-th viewing position.

In accordance with embodiments, alternative_view_position_id represents a redundant view (When viewing_position_picture_type equal to 5).

viewing_position_id indicate the identifier of a viewing position that is described by the viewing position, orientation and coverage, specified by viewing_position_x, viewing_position_y, and viewing_position_z, viewing_orientation_yaw, viewing_orientation_pitch, and viewing_orientation_roll, and coverage_horizontal and coverage_vertical, respectively. The parameters or features which describe the viewing position could be added to differentiate different viewing positions.

In accordance with embodiments, viewing_position_id represents viewing positions that uses this reference view.

In accordance with embodiments, viewing_position_id represents reference viewing positions for view regeneration (When viewing_position_picture_type equal to 2)

In accordance with embodiments, viewing_position_id represents reference viewing positions for view regeneration (When viewing_position_picture_type equal to 3).

In accordance with embodiments, viewing_position_id represents reference viewing positions for view regeneration ((When viewing_position_picture_type equal to 4).

viewing_position_x, viewing_position_y, and viewing_position_z indicate the (x,y,z) location of viewing position corresponding to the decoded picture in the units of 2⁻¹⁶ millimeters, respectively The range of viewing_position_x, viewing_position_y and viewing_position_z shall be in the range of −32768*2¹⁶−1 (i.e., −2147483647) to 32768*2¹⁶ (i.e., 2147483648), inclusive.

The value of viewing_position_x, viewing_position_y and viewing_position_z could be represented by absolute position in the XYZ coordinate or relative position corresponding to the anchor location.

viewing_orientation_yaw, viewing_orientation_pitch, and viewing_orientation_roll indicate the yaw, pitch, and roll orientation angles in units of 2⁻¹⁶ degrees, respectively. The value of viewing_orientation_yaw shall be in the range of −180*2¹⁶ (i.e., −11796480) to 180*2¹⁶−1 (i.e., 11796479), inclusive, the value of viewing_orientation_pitch shall be in the range of −90*2¹⁶ (i.e., −5898240) to 90*2¹⁶ (i.e., 5898240), inclusive, and the value of viewing_orientation_roll shall be in the range of −180*2¹⁶ (i.e., −11796480) to 180*2¹⁶−1 (i.e., 11796479), inclusive.

Depending on the applications, viewing_orientation_yaw, viewing_orientation_pitch, and viewing_orientation_roll could be used to indicate azimuth, elevation, and tilt, respectively. Also, viewing_orientation_yaw, viewing_orientation_pitch, and viewing_orientation_roll could represent the rotation that is applied to the unit sphere of head position corresponding to the decoded picture to convert the local coordinate axes to the global coordinate axes, respectively.

coverage_horizontal and coverage_vertical specifies the horizontal and vertical ranges of the coverage of the viewing position corresponding to the decoded picture, in units of 2⁻¹⁶ degrees, respectively.

Due to Viewing position group information, embodiments may perform decoding, unpacking, view regeneration, view synthesis, center view generation, view regeneration, sparse view regeneration and/or view synthesis operation.

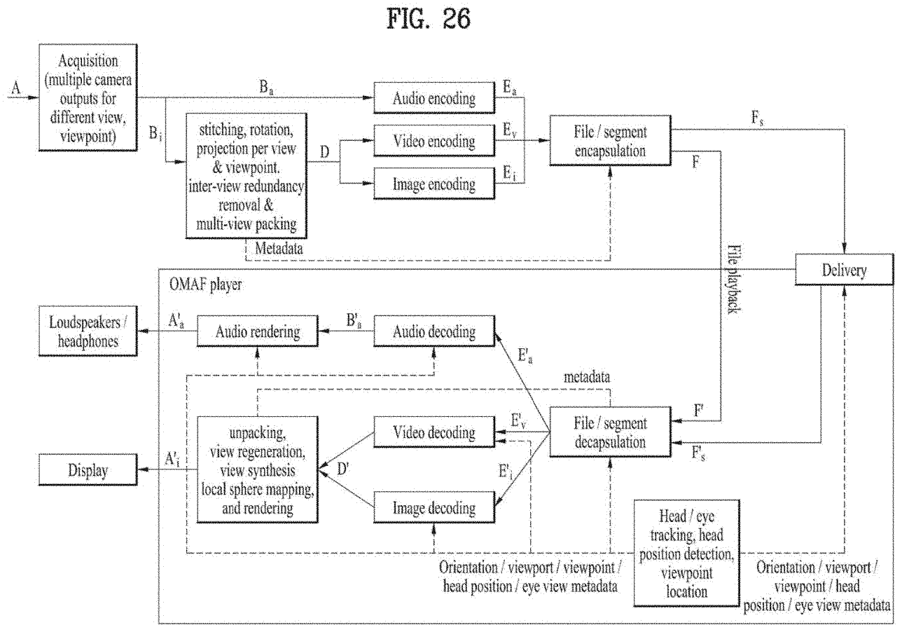

FIG. 26 is an example end-to-end flow chart of multi-view 3DoF+ video in accordance with embodiments.

An example usage of view regeneration information is VR/AR applications for 3DoF, 3DoF+ or higher. In Figure, end-to-end flow chart of multi-view 3DoF+ video is described which is composed by multi-view packing and inter-view redundancy removal before the encoding process and unpacking and view regeneration after the decoding process, including selection.

A real-world audio-visual scene (A) is captured by audio sensors as well as a set of cameras or a camera device with multiple lenses and sensors. The acquisition results in a set of digital image/video (Bᵢ) and audio (Bₐ) signals. The cameras/lenses typically cover all directions around the centre point of the camera set or camera device, thus the name of 360-degree video.

The images (Bi) captured by texture/depth camera lenses at the same time instance and/or different head position and/or different viewpoint are stitched, possibly rotated, projected per view and/or viewpoint. In addition, to increase the bit efficiency of the encoded videos, inter-view redundancy due to the adjacent views are removed and then mapped onto a packed picture (D).

The packed pictures (D) are encoded as coded images (Eᵢ) or a coded video bitstream (Eᵥ). The captured audio (Bₐ) is encoded as an audio bitstream (Eₐ). The coded images, video, and/or audio are then composed into a media file for file playback (F) or a sequence of an initialization segment and media segments for streaming (Fₛ), according to a particular media container file format. The media container file format might be the ISO Base Media File Format. The file encapsulator also includes metadata into the file or the segments, such as view regeneration information and multi-view region-wise packing information assisting in rendering the decoded packed pictures.

The metadata in the file includes:
the location and rotation of a local sphere coordinate representing a view or a head position,
the location and rotation difference of a local sphere of a view or a head position from the anchor view,
the projection format of the projected picture of a view or a head position,
the coverage of the projected picture of a view or a head position,
multi-view region-wise packing information,
view regeneration information,
texture depth regeneration information and
region-wise quality ranking.

The segments Fₛ are delivered using a delivery mechanism to a player.

The file that the file encapsulator outputs (F) is identical to the file that the file decapsulator inputs (F′). A file decapsulator processes the file (F′) or the received segments (F′ₛ) and extracts the coded bitstreams (E′ₐ, E′ᵥ, and/or E′ᵢ) and parses the metadata. The audio, video, and/or images are then decoded into decoded signals (B′ₐ for audio, and D′ for images/video). The decoded packed pictures (D′) are unpacked to each viewing position and then reconstruct each view with view regeneration process. Then a view which corresponding to the viewer's viewing position is constructed with view synthesizer. The generated view is then projected onto the screen of a head-mounted display or any other display device based on the current viewing orientation or viewport and/or view (head position) and/or viewpoint and the projection, spherical coverage, rotation. Likewise, decoded audio (B′ₐ) is rendered, e.g. through headphones, according to the current viewing orientation. The current viewing orientation is determined by the head tracking and possibly also eye tracking functionality. Besides being used by the renderer to render the appropriate part of decoded video and audio signals, the current viewing orientation may also be used by the video and audio decoders for decoding optimization.

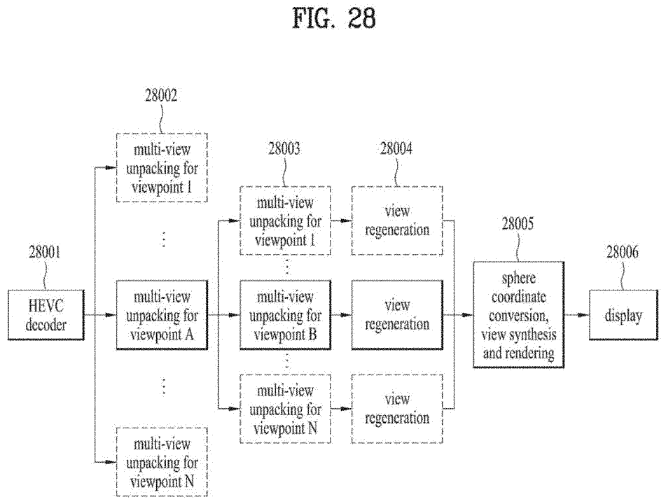

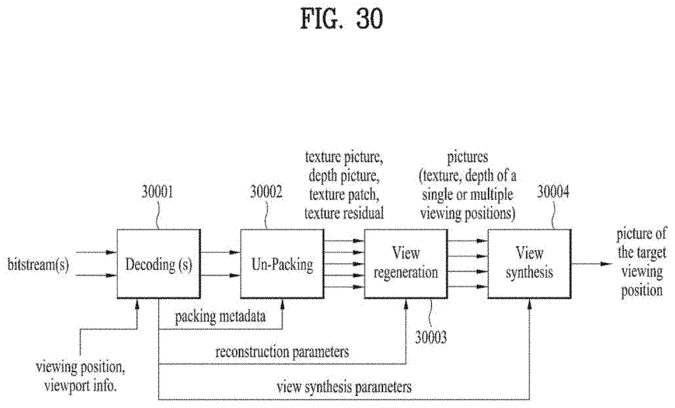

In accordance with embodiments, the inter-view redundancy removal and multi-view packing and the metadata are more specifically described in FIGS. 28, 30, etc.

In accordance with embodiments, the unpacking, view regeneration, view synthesis and the metadata are more specifically described in FIGS. 29, 31, etc.

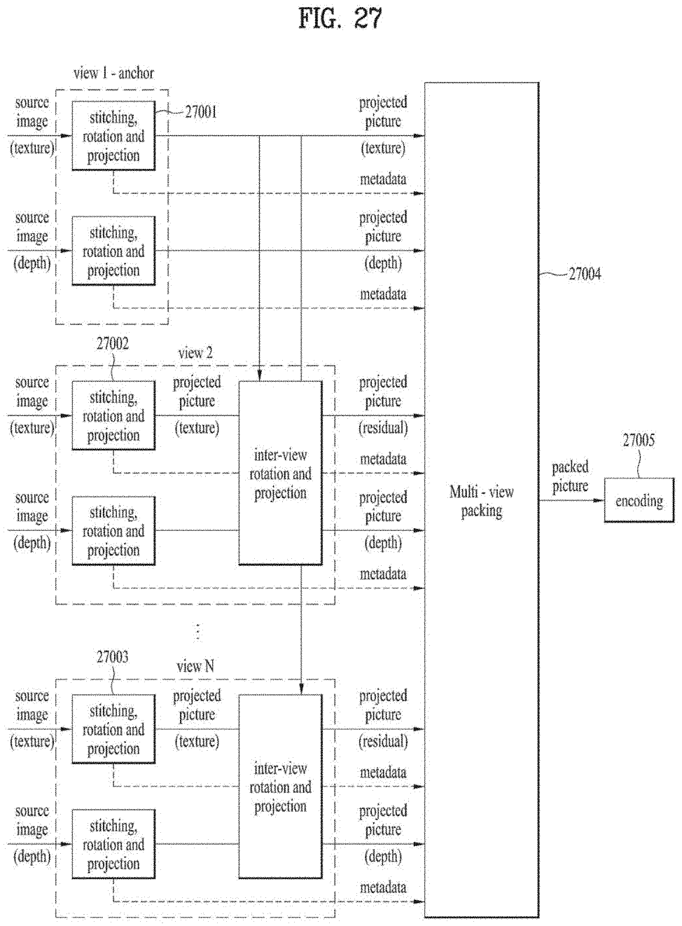

FIG. 27 is an example implementation of pre-encoding process for multi-views 3DoF+ video in accordance with embodiments.

The apparatus for transmitting a video according to embodiments performs multi-view packing the pictures into a packed picture and each view for the picture includes different types of a texture and a depth map, and a residual of texture and a depth map are generated for a subsidiary view based on redundancy between each view.

The Multi-view packing packs the multi-views. The multi-views include the view 1, the view 2, . . . , the view N. The view 1 can be an anchor view.

The view 1 includes a texture and/or a depth which correspond to the source image. The stitching, rotation and projection are performed on each image. The projected picture and the metadata are generated.

The view2 includes a texture and/or a depth. The stitching, rotation and projection are performed on the texture and/or the depth. The inter-view redundancy removal removes the redundancy for the inter-view, for example, between the view1 and the view 2. The projected picture which can correspond to the residual is generated for the texture.

The viewN includes a texture and/or a depth. The stitching, rotation and projection are performed on the texture and/or the depth. The projected pictures (the texture and the depth) and metadata are generated. The inter-view redundancy removal removes the redundancy for the inter-view. The projected picture (residual) and the projected picture (depth) are generated.

The encoding encodes the packed picture from the multi-view packing.

In Figure, an example pre-encoding processing for the multi-view video for 3DoF+ or head motion parallax is described. As shown in the figure, each view could be composed by different components, texture and depth map, which are produced into a projected picture of each component of each view by stitching, rotation, projection and multi-view packing process. In addition, using redundancy between views, for example between anchor view and the right head motion view, the residual of texture, also depth or other components if possible, could be generated for subsidiary views. This could increase bit efficiency by eliminating redundant information between views. Ones the projected pictures of each view including texture, residual, and depth, they are packed into a single 2D image plane and then the video is encoded using single layer video encoder, such as HEVC or future video codec.

FIG. 28 is an example implementation of post-decoder process for multi-views 3DoF+ video in accordance with embodiments.

In accordance with embodiments, a concept of post-decoder process of multi-views 3DoF+ video is described. After decoding, the decoder post-processor could generate multiple projected pictures per view for each viewpoint. However, since not all the images are played on the display device, target projected pictures could be generated based on the viewer's viewpoint and viewing position. In this example, view B of viewpoint A is assumed to be selected and the related projected pictures, such as texture, residual, and depth map, could be inputs to the renderer before display. When the selected view is not a full view, view regeneration process is performed to reconstruct a view from the given pictures and additional information from patch or residual.

HEVC decoder decodes bitstream including pictures for multi viewpoints (viewpoint 1, . . . , viewpoint N) of multi views (view1, . . . , view N).

The multi-view unpacking for viewpoint(s) performs unpacking for each viewpoint. For example, with respect to the viewpoint A, pictures for the viewpoint A include pictures for multi views (view 1, . . . , viewN).

The multi-view unpacking for view(s) unpacks pictures for each view.

View regeneration regenerates a full picture from the given pictures and additional information from patch or residual.

Sphere coordinate conversion, view synthesis and rendering converts pictures into sphere coordinate data and synthesizes a view in order to render the view.

Display displays the view.

In Figure, a concept of post-decoder process of multi-views 3DoF+ video is described. After decoding, the decoder post-processor could generate multiple projected pictures per view for each viewpoint. However, since not all the images are played on the display device, target projected pictures could be generated based on the viewer's viewpoint and viewing position. In this example, view B of viewpoint A is assumed to be selected and the related projected pictures, such as texture, residual, and depth map, could be inputs to the renderer before display. When the selected view is not a full view, texture depth regeneration process or/and view regeneration process is performed to reconstruct a view from the given pictures and additional information from patch or residual.

FIG. 29 is an example block diagram of encoder pre-processing in accordance with embodiments.

An apparatus for transmitting a video in accordance with embodiments includes an inter-view redundancy remover, a packet and/or an encoder.

The inter-view redundancy remover (29000)(or inter-view redundancy removing) receives video sequences for multiple viewing positions which can be referred to as video data, 360 video data, 3DoF+ VR data, etc. The video sequences consist of multiple pictures.

The inter-view redundancy remover (29000) removes redundancy between each inter-view. For example, adjacent pictures for adjacent viewing position can include redundancy data. To increase the performance of encoding and/or transmitting data, the inter-view redundancy remover removes redundancy.

The inter-view redundancy remover (29000) can generate reconstruction parameters which can be referred to as signaling information and/or metadata. reconstruction parameters in accordance with embodiments may include information related to removing redundancy which may be used to regenerate pictures efficiently. Reconstruction parameters in accordance with embodiments, for example are included in view regeneration information SEI message or texture depth regeneration information SEI message and/or signaling information including Sparse view regeneration information SEI message.

As a result of inter-view redundancy removing, texture pictures, depth picture, texture patch and/or texture residual may be generated.

The packing (29001)(or a packer) packs pictures including texture pictures, depth picture, texture patch and/or texture residual into packed pictures and generates packing metadata which can be referred to as signaling information. Packing metadata in accordance with embodiments includes information related to the packing, for example, size, type, and the viewing position of a picture and/or a target picture, size, type, location of each region, etc. The packing metadata may be used to unpack at a receiver (a decoder) in accordance with embodiments. In accordance with embodiments, packing metadata is carried in signaling information for multiview region-wise packing SEI message and/or signaling information including Sparse view regeneration information SEI message.

The encoding (29002)(or an encoder) encodes the packed pictures. The encoding further encodes signaling information including the packing metadata and/or the reconstruction parameters.

Bitstream(s) including the encoded data is transmitted.

In Figures, block diagram of encoder pre-processing for multi-views 3DoF+ video is described. Based on the high correlation between pictures in the adjacent viewing positions, the redundant pixel information between pictures is removed. After this process, less number of pictures which are used to estimate the removed pixel information is preserved while partial regions or residual of the regions which could not be predicted by the reserved pictured are remained with reduced size of data. The information which viewing position is reserved for full picture, which kind of information is remained in the other viewing positions, how the removed information could be derived, and how the picture of the viewing position could be regenerated is delivered with reconstruction parameter, such as view regeneration information SEI message or texture depth regeneration information SEI message. When the redundancy is removed, the remaining picture, patches, and residuals, etc are paced into one or multiple pictures. The packing information, such as the location and size of the picture, patches, and residuals, the type of the pixels in the region, the location and size of the region in the original picture, the size of the original picture, etc are delivered with the packing metadata, such as Multiview region-wise packing information SEI message.

An apparatus for transmitting video data in accordance with embodiments includes a packer configured to pack pictures in video data for viewing positions and/or an encoder configured to encode the packed pictures based on signaling information.

In accordance with embodiments, an encoder may be referred to as a transmitter to encode video data and/or signaling information in accordance with embodiments. The encoder may be interpreted on the ground of some embodiments of the disclosure and can provide effects of efficient encoding performance and transmitting performance.

FIG. 30 is an example block diagram of decoder post-processing in accordance with embodiments.

An apparatus for receiving a video in accordance with embodiments includes a decoder, an unpacker, a view regenerator and/or view synthesizer.

The decoder (30000)(or decoding) receives bitstream(s) which is transmitted from a transmitter (an encoder). The decoder further receives viewing position and/or viewport information from a transmitter (an encoder) and/or an user in order to efficiently decode and provide data for an viewing information and/or viewport information related to an user.

The decoder (30000) decodes the bitstream(s), the viewing position and/or the viewport information. The decoded data includes pictures which are packed in a transmitter and/or signaling information, for example, packing metadata, reconstruction parameters and/or view synthesis parameters.

The unpacker (30001)(or unpacking) unpacks packed pictures in the received bitstream(s), for example, a picture is unpacked into a number of pictures. The packing metadata is used in the unpacker, for example, a picture is unpacked into a number of pictures based on the packing metadata.

As a result of operation of the unpacker, a texture picture, a depth picture, a texture patch, a texture residual may be generated.

The view regenerator (30002)(or view regenerating) regenerates pictures corresponding to texture, depth of a single or multiple viewing positions from unpacked pictures based on signaling information including the reconstruction parameters.

In accordance with embodiments, reconstruction parameters includes information related to a view regeneration information SEI message or texture depth regeneration information SEI message and/or signaling information including Sparse view regeneration information SEI message.

The view synthesizer (30003)(or view synthesizing) synthesizes a picture of a target viewing position based on signaling information including the view synthesis parameters. Specific operations related to the view synthesizer in accordance with embodiments are more specifically described in FIG. 31.

In accordance with embodiments, reconstruction parameters includes information for performing sparse view regeneration. In Figure, block diagram of decoder post-processing for multi-views 3DoF+ video is described. When the bitstreams are decoded, the decoded output pictures are unpacked by using the packing metadata. In the metadata, the size, type, and the viewing position of the target picture, the size, type, location of each region are described. After the un-packing process, pictures in the missing viewing position are restored by the view regeneration process (or texture depth regeneration process) in aid of the reconstruction parameters. In this metadata, the size and the location of the patches and residuals, the method of estimating the removed pixel values, how to regenerate the missing pixel values, and post-filtering parameters for block boundary removal is described. With the regenerated and delivered pictures for multiple viewing positions, a single view corresponding to the viewer's viewing position is synthesized by view synthesis module.

An apparatus for receiving a video in accordance with embodiments includes a decoder configured to decode a bitstream based on viewing position information and viewport information, an un-packer configured to un-pack pictures in the decoded bitstream based on packing metadata, a view regenerator configured to regenerate pictures for viewing position from the un-packed pictures based on reconstruction parameters, and/or a view synthesizer configured to synthesize a picture of a target viewing position from the regenerated pictures based on view synthesis parameters.

In accordance with embodiments, a decoder may be referred to as a receiver to decode video data and/or signaling information in accordance with embodiments. The decoder may be interpreted on the ground of some embodiments of the disclosure and can provide effects of efficient decoding performance and regenerating view performance.

FIG. 31 is an example block diagram of encoder pre-processing: detailed description of inter-view redundancy removal in accordance with embodiments.

An apparatus for transmitting a video in accordance with embodiments includes a rotator/projector, a center view generator, an intermediate view synthesizer, a pruner, a sparse view pruner, a packer and/or an encoder.

The rotator/projector (31000)(or rotating/projecting) performs rotating and/or projecting multi-spherical video/image including a texture/a depth. Picture(s) in the multi-spherical videos/image (texture/depth) may be rotated and/or projected. Outputs of the rotator/projector are pictures (texture/depth) and/or the rotated/projected pictures which can be referred to as source view picture(s) in accordance with embodiments.

The center view generator (31001)(or center view generating) generates a center view picture from the rotated/projected pictures and/or pictures (texture/depth) and signaling information including center view generation information related to profile/properties for the center view picture.

The intermediate view synthesizer (31002)(or intermediate view synthesizing) synthesize an intermediate view picture from the rotated/projected pictures and/or pictures (texture/depth) (a source view picture) and generate signaling information including pre-generation information and/or view synthesis recommendation information which may be used to decode data in a receiver (a decoder).

The pruner (31003)(or pruning) prunes redundancy between pictures. The pruning represents removing redundancy between views. This procedure may be referred to as an inter-view redundancy removal. In accordance with embodiments, inputs of the pruner include a center view picture, source view picture and/or an intermediate view picture. Furthermore, pruned sparse view(s) may be input to the pruner. The pruner generates signaling information including reference view information and/or regeneration information which may be used to decode data in a receiver (a decoder). The signaling information includes information related to the pruning in order to regenerate views. In accordance with embodiments, outputs of the pruning include a sparse view picture, a reference view picture and/or a sparse view picture. In accordance with embodiments, a view may be referred to as a view picture.

The sparse view pruner (31004)(or sparse view pruning) prunes redundancy between pictures. The sparse view pruning represents removing redundancy between sparse views (sparse view pictures). In accordance with embodiments, the pruning removes redundancy between reference views whereas the sparse view pruning removes redundancy between sparse views. Due to the sparse view pruning, redundancy per view can be more efficiently removed so that the performance and the efficiency of encoding and/or transmitting can be increased. In accordance with embodiments, outputs of the sparse view pruning are pruned sparse view pictures and some pruned sparse view picture can be provided to the inputs of the pruning.

The packer (31005)(or packing) packs pictures, for example, a center view picture, a pruned sparse view picture, a reference view picture and/or a sparse view picture. Outputs of the packing are packed picture(s).

The encoder (31006)(or encoding) encodes data, for example, a packed picture and/or signaling information including the center view generation information, reference view information, regeneration information, pre-generation information and/or view synthesis recommendation information. In accordance with embodiments, the encoded data is transmitted as a format of bitstream(s).

In accordance with embodiments, a pre-processor performs operations as mentioned above including rotation/projection, center view generation, intermediate view synthesis, pruning, sparse view pruning, packing and/or encoding.

In accordance with embodiments, a center view picture means spherical video/image for a center location of multi-spherical video/image. In accordance with embodiments, a center view picture may be included in input data or be generated from virtual viewpoint generation.

In accordance with embodiments, an intermediate view picture means a picture which is virtually generated. The intermediate view picture is not included in input data, for example, multi-spherical video/image. In accordance with embodiments pre-generation information and/or view synthesis recommendation information include information included in Viewing position group information SEI message syntax related to viewing_position_picture_type[i]==3, 4 in accordance with embodiments.

In accordance with embodiments, source view pictures and/or intermediate view pictures are used for pruning. Reference view information and/or regeneration information in accordance with embodiments include information included in Viewing position group information SEI message syntax related to viewing_position_picture_type[i]==1 in accordance with embodiments.

In accordance with embodiments, a Viewing position group information SEI message is transmitted by an encoder and received by a receiver as signaling information. The viewing position group information SEI message includes viewing_position_picture_type.

In accordance with embodiments, viewing_position_picture_type specifies the picture type of the i-th viewing position in terms of picture generation. When viewing_position_picture_type equal to 0, the i-th viewing position is a center view. When viewing_position_picture_type equal to 1, the picture of the i-th viewing position is used as a reference picture in the view regeneration process. When viewing_position_picture_type equal to 2, the picture of the i-th viewing position will be generated from the view regeneration process. When viewing_position_picture_type equal to 3, the picture of the i-th viewing position is pre-generated view in the encoding pre-process. When viewing_position_picture_type equal to 4, the picture of the i-th viewing position might not be present in the decoded pictures but a view synthesis method is recommended with additional information. This could be used to reduce the time consumption process with regard to view synthesis. When viewing_position_picture_type equal to 5, the picture of the i-th viewing position might not be present in the decoded pictures but alternative picture from other viewing position is present.

In accordance with embodiments, a sparse view picture means a picture including information which can be not predictable when a current viewpoint is predicted based on surrounding viewpoint(s). For example, gray or black region(s) means duplicated information between a picture for a current viewpoint and a picture for surrounding viewpoint(s). In accordance with embodiments, the duplicated information means predictable information. Therefore, a sparse view picture includes unpredictable information.

In accordance with embodiments, a reference view picture means a picture for surrounding viewpoints that is used to predict a picture for a current viewpoint. In accordance with embodiments source view picture/image and/or picture/image generated by virtual viewpoint generation can be used.

In accordance with embodiments, sparse view pruning generates signaling information for sparse view and/or metadata for indicating the target viewing position, reference sparse view, and the sparse view regeneration method type, such as target_view_id, component_id, component_type, pruned_sparse_view_present_flag, reference_sparse_view_present_flag sparse_view_regeneration_type, output_sparse_view_id, pruned_sparse_view_id, and reference_sparse_view_id, etc.

In accordance with embodiments, sparse view pruning generates Sparse view regeneration information in FIG. 24

In Figure, the detailed description of the inter-view redundancy removal in the encoder pre-processing is described.
Center view generation: generate a view that could represent the center view of this group of viewing positions. It could produce center view picture itself and/or the center view generation information.
Intermediate view synthesis: if the processor uses generated views on top of the provided views (or source view), intermediate view could be synthesized. The output of this process is intermediate views with additional information of pre-generation information. In addition, information that could be used in the view synthesis in the decoder post-processing could be delivered.
Pruning: given multiple videos corresponding to the viewing position that are in the same group, consist of source view, intermediate view, and center view, the redundancy between view are removed in this step. The output of this process is sparse view pictures, conceptually unique information/pixels in a viewing position, reference view pictures, a picture that could provide a base information/picture to the others. In addition reference view information and/or regeneration information could be produced.
Sparse view pruning: given full picture views and sparse views to be delivered, the redundancy between the sparse view is removed in this step. The output of this process is pruned sparse view and the metadata which indicate the target viewing position, reference sparse view, and the sparse view regeneration method type, such as target_view_id, component_id, component_type, pruned_sparse_view_present_flag, reference_sparse_view_present_flag sparse_view_regeneration_type, output_sparse_view_id, pruned_sparse_view_id, and reference_sparse_view_id.

An apparatus for transmitting a video in accordance with embodiments includes a pre-processor before encoding video data. The pre-processor in accordance with embodiments performs generating a center view picture from the video data for the viewing positions and center view generation information, synthesizing an intermediate view picture from the video data and generating pre-regeneration information, pruning redundancy between the center view, a source view picture or an intermediate view picture, the redundancy-pruned pictures including sparse view pictures and/or a reference view picture, spars view pruning redundancy between the sparse view pictures and generating sparse view regeneration information, packing the pruned sparse view picture and the reference view picture and/or encoding the packed pictures, the center view generation information, the pre-regeneration information and the sparse view regeneration information.

An apparatus for transmitting a video in accordance with embodiments performing: generating a center view picture from the video data for the viewing positions and center view generation information, synthesizing an intermediate view picture from the video data and generating pre-regeneration information, pruning redundancy between the center view, a source view picture or an intermediate view picture, the redundancy-pruned pictures including sparse view pictures and a reference view picture, sparse view pruning redundancy between the sparse view pictures and generating sparse view regeneration information, packing the pruned sparse view picture and the reference view picture and/or encoding the packed pictures, the pre-regeneration information and the sparse view regeneration information.

In accordance with embodiments, an encoder can provide effects of efficient transmission of pictures to be regenerated in a decoder. For example, by using reference views, pruning (removing redundancy, sparse view pruning) and/or packing. Reference views are view(s) to be used for referencing a view(s) to be regenerated and for example include a center view, an intermediate view(s), a source view(s), a sparse view(s).

FIG. 32 is detailed description of view regeneration in the post-processing in accordance with embodiments.

An apparatus for receiving a video in accordance with embodiments includes a decoder, an unpacker, a controller, a center view generator, a view regenerator, a sparse view regenerator, a view synthesizer and/or a renderer/viewport generator.

The decoder (32000)(or decoding) decodes received data, for example, including pictures in the bitstreams and signaling information (including viewing position group information).

The unpacker (32001)(or unpacking) unpacks pictures, for example, packed pictures in the bitstreams.

The controller (32002)(or controlling) controls signaling information in the bitstreams, for example, viewing position group information, center view generation information, reference view information, regeneration information, pre-generation information and/or view synthesis recommendation information in order to provide signaling information to each operation in the post-processing.

The center view generator (32003)(or center view generating) generates a center view picture based on center view generation information. In accordance with embodiments, when the viewing_position_picture_type in signaling information in accordance with embodiments equal to 0 or center_view_present_flag in signaling information in accordance with embodiments equal to 0, the center view generation is processed. The reference viewing positions and the parameters for each viewing position is given by viewing_position_id, center_view_generation_parameter. In other case, if the computational complexity is huge burden to the receiver, alternative viewing position could be used by the information given alternative_viewing_position_id, alternative_view_distance, rec_center_view_generation_method_type.

The view regenerator (32004)(or view regenerating) regenerates a regenerated view based on a reference view(s) and/or a sparse view(s). In accordance with embodiments, sparse views may be transmitted in the bitstreams or sparse view may be generated by sparse view regeneration.

In accordance with embodiments, when viewing_position_picture_type equal to 1, the picture could be used as a reference picture to the other viewing position. In this case, decoder could store the picture in the buffer with the information of viewing position that uses this picture given by viewing_position_id. When viewing_position_picture_type equal to 2, view generation shall be used to restore the picture of this viewing position. The reference views and the sparse view that are needed to the regeneration process are indicated by viewing_position_id and picture_id, respectively. The receiver shall use the regeneration process method given by view_regeneration_method_type to restore the viewing position intended by the encoder.

The sparse view regenerator regenerates a sparse view picture(s) based on sparse view pictures in the bitstreams and signaling information.

The view synthesizer (32005)(or view synthesizing) synthesizes a picture and/or a picture for a target viewing position based on a center view (e.g., for center location), a regenerated view picture, reference view pictures (e.g., for surrounding viewpoints and/or signaling information including pre-generation information and/or view synthesis recommendation information.

In accordance with embodiments, when viewing_position_picture_type equal to 3, the picture is not a source picture but pre-generated views. Receivers could determine whether it uses this picture or synthesize a new picture with the regenerated views. In the determination, the processed method could be one of the determination criteria given by pregeneration_method_type. If the receiver uses this picture, reference pictures given by viewing_position_id and the sparse view given by picture_id are used with the regeneration method.

In accordance with embodiments, when viewing_position_picture_type equal to 4, recommended view synthesis information is provided for this viewing position. They are the synthesis method, parameter, reference viewing position indicator, and sparse view present flag, given by ref_view_systhesis_method_type, view_synthesis_parameter, viewing_position_id, sparse_view_present_flag, respectively.

In accordance with embodiments, when viewing_position_picture_type equal to 5, the viewing position could be replaced by other view from the source view, regenerated view, or synthesized views, indicated by alternative_viewing_position_id.

The renderer/viewport generator (32006)(or rendering/viewport generating) renders a view that is generated by the view synthesis and generate viewport information for a user viewport that is acquired from a user, displayer or a receiver. Viewport information in accordance with embodiments is provided to controller.

In accordance with embodiments, a post-processor performs operations as mentioned above including decoding(s), unpacking, center view generation, view regeneration, sparse view regeneration, controlling, view synthesis and/or rendering/viewport generation.

According to the viewpoint of the viewer, the viewing positions that are needed by the view synthesizer could be determined. Then, decoder post-processer could determine the process that is needed for each viewing position and the process order in the receiver. When sparse view regeneration SEI message is present, the sparse view regeneration process shall be enabled according to the sparse_view_regeneration_type for each viewing position. For the following process, all components indicated by component_id and component_type corresponding to target_view_id shall be processed
When sparse_view_regeneration_type equal to 1, the sparse view regeneration process described in FIG. 16 is revoked where the reference sparse view and the pruned sparse view are indicated by reference_sparse_view_id and pruned_sparse_view_id, respectively. In the prediction of the sparse view, the disparity between the views are calculated by the location, rotation and coverage of the reference sparse view and the target view indicated by the view_position_descriptor( ) corresponding to the reference_sparse_view_id and target_view_id, respectively.
When sparse_view_regeneration_type equal to 2, the sparse view regeneration process described in FIG. 17 is revoked where the reference sparse view is indicated by reference_sparse_view_id. In the prediction of the sparse view, the disparity between the views are calculated by the location, rotation and coverage of the reference sparse view and the target view indicated by the view_position_descriptor( ) corresponding to the reference_sparse_view_id and target_view_id, respectively.
When sparse_view_regeneration_type equal to 3, the sparse view regeneration process described in FIG. 18 is revoked where the reference sparse view is indicated by reference_sparse_view_id. In addition to the sparse view regeneration process, the view regeneration process also revoked to temporally generate the reference view. In the prediction of the sparse view, the disparity between the views are calculated by the location, rotation and coverage of the reference sparse view and the target view indicated by the view_position_descriptor( ) corresponding to the reference_sparse_view_id and target_view_id, respectively.
When sparse_view_regeneration_type equal to 4, the view regeneration process described in FIG. 19 is revoked where the reference sparse view is indicated by reference_sparse_view_id. After regenerate the reference view, the target view is regenerated by the view synthesis process, where the disparity between the views are calculated by the location, rotation and coverage of the reference sparse view and the target view indicated by the view_position_descriptor( ) corresponding to the reference_sparse_view_id and target_view_id, respectively.

The metadata, view position group information given by the encoder pre-processing, is parsed by controller. In this module, the whole viewport generation process is controlled by determining which viewing position shall be generated, which process module shall be worked, and in which order the modules shall be processed. For example, if a viewing position that viewer want to watch is a center position or a picture position that is exactly same with the reference picture position, only the picture of that position could be selected from the unpacked picture. However if the center position is not generated in the encoder pre-processor, the center view generation module could be processed with the reference pictures in the packed picture. In other cases, if the viewing position is not a full picture so additional process is needed, the processing modules, such as view regeneration or center view generation, shall be turned on and the method which is indicated in the metadata, which means intended by the encoder pre-processor, is used to generate picture of a viewing position from reference pictures and sparse pictures. In this step, it is general to use the center view or reference views to generate the other views, so center view or reference view generation shall be processed precedent to the view regeneration. If the viewing position is not match with the viewing positions provided or regenerated from the decoded picture, the picture shall be synthesized using given viewing positions. As the view synthesis module produces a new view by using other views, view regeneration module shall be precedent to the view synthesis model for all viewing positions that are needed to generate the synthesized view. The relationship or the processing order is given by viewing_position_picture_type and view_position_processing_order_idx. the relationship between the viewing positions depending on the processing order is described with the input output description of the center view generation, view regeneration and view synthesis processing modules.

An apparatus for receiving a video in accordance with embodiments includes a view regenerator performing generating a center view from a reference view in the un-packed pictures based on center view generation information in the viewing position information, and/or regenerating a regenerated view from a reference view and the center view and a sparse view in the un-packed pictures.

An apparatus for receiving a video in accordance with embodiments can efficiently receive pictures by sparse view pruning and regenerate pictures by sparse view regeneration.

In accordance with embodiments, a decoder can synthesize a precise view via less pictures required since center view generating can generate a center view from received pictures, view regeneration can regenerate a view from reference views and also regenerated sparse views.

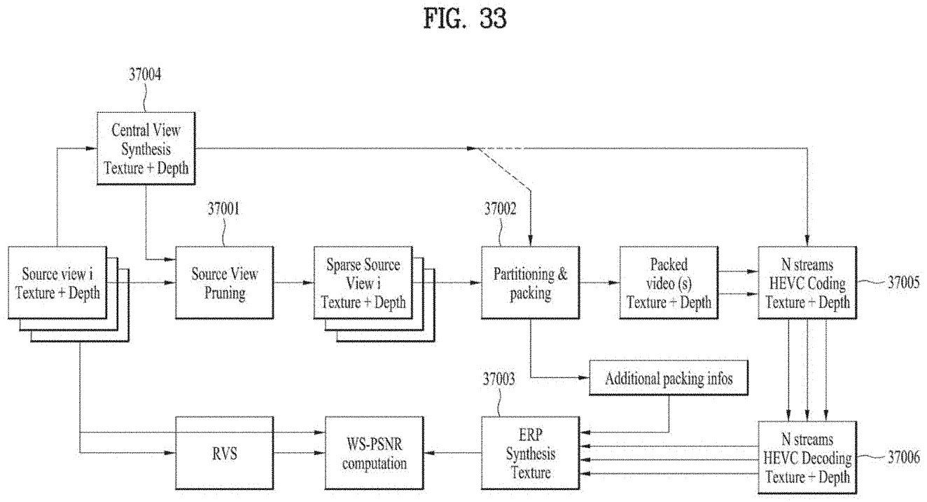

FIG. 33 is block diagram of 3DoF+ SW platform in accordance with embodiments.

In accordance with embodiments, Central View Synthesis module, Source View Pruning module, Partitioning & packing module and/or View synthesis module may be corresponding to a hardware, a software and/or a processor at a transmitter side.

In accordance with embodiments, Central View Synthesizer generates a center view picture from source view pictures that is acquired from source view pictures or generated from source view pictures virtually.

In accordance with embodiments, Source View Pruner prunes (e.g., removes) redundancy between source view pictures and/or source view pictures and a center view picture. Outputs of source view pruning are a number of sparse source views (including texture and/or depth), for example, sparse source view #0, . . . , sparse source view #i.

In accordance with embodiments, sparse views are further pruned by sparse view pruning.

In accordance with embodiments, Practitioner & packer packs sparse source views and/or sparse views into packed video(s) including texture and/or depth and generates additional packing information that is related to signaling information in accordance with embodiments.

In accordance with embodiments, a number of bitstreams, for example, N streams are encoded by a HEVC coding scheme.

In accordance with embodiments, N streams and/or signaling information are transmitted.

In accordance with embodiments, the N streams (including texture and/or depth) and/or the signaling information are received at a receiver side.

In accordance with embodiments, ERP synthesizer synthesis a view based on signaling information and N streams. A view for a target viewing position may be regenerated (predicted).

Central View Synthesis Module:
This module will generate a plain and full ERP (texture+depth) view in charge of conveying most of the visual information. The parameters of this module will be at minimum: Resolution of the related stream, Exact position of the central view

Source View Pruning Module:
This module will make use of the depth buffer output by the Central View Synthesis module, and discard any pixel already projected. The parameters of this module will be at minimum: Resolution of the related stream, QP for the texture and QP for the depth

Partitioning & Packing Module:
When activated, this module browses the totality of the sparse source views, and implements the following: partitions each sparse source views, discards empty partitions, packs them in a patch atlas on one or more streams, generates additional informations accordingly.

View Synthesis Module:
This module generates the final viewport just as RVS does, but accepts as input a heterogeneous set of texture+depth videos complemented with the previously generated additional informations. It then synthetizes the view in ERP or perspective mode.

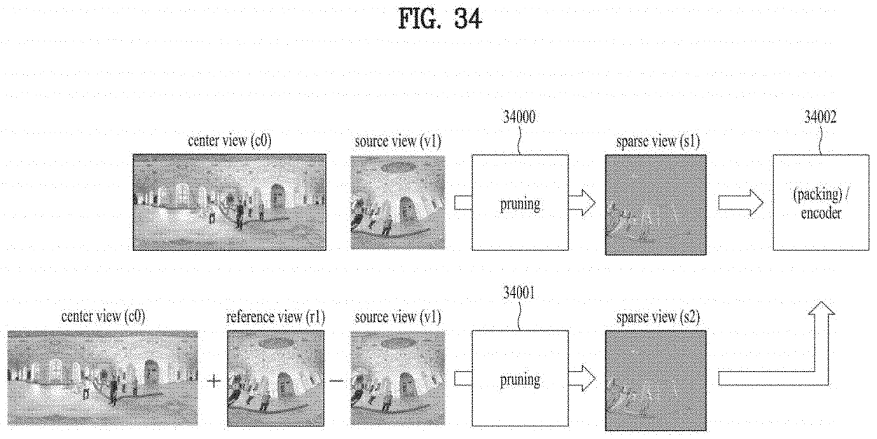

FIG. 34 is an example of encoder pre-processing scheme with pruning module in accordance with embodiments.

In FIG. 34 to FIG. 42, to reduce the amount of the data size delivered to the receiver, pruning module which aims to remove the redundant visual information that is caused by the spatial relationship between views is used in the encoder pre-processing step. When this is used, inverse processing which aims to restore the original views shall be performed called view regeneration. For those steps, the information of reference and source views and the method to be used in the view regeneration process should be provided by Texture depth regeneration information SEI message or View regeneration information SEI message where the details are addressed in the other documents.

Pruning module may correspond to pruning of FIG. 31 in accordance with embodiments. In accordance with embodiments, pruning module can be referred to as pruner.

In accordance with embodiments, pruning (34000)(or pruner) generates a sparse view, for example, s1 or a first sparse view, based on a center view (c0) and a source view (v1). In accordance with embodiments, a sparse view (s1) is generated by subtracting a source view (v1) from a center view (c0) and or a center view (c0) from a source view (v1). The sparse view (s1) is a picture including unpredictable data and gray or black marked region in the sparse view (s1) is duplicated data or redundancy between the center view (c0) and the source view (s1). By generating the sparse view (s1), the performance and the efficiency of encoding or transmitting data can be increased.

Pruning (34001)(or pruner) generates a sparse view (s2) based on a center view (c0), a reference view (r1) and/or a source view (v2). For example, the center view (c0) is added to the reference view (r1) and the added picture is subtracted with the source view (v2).

Packing/encoding (34002)(or a packer/encoder) packs/encodes a sparse view (s1) and/or a sparse view (s2).

In accordance with embodiments, a number of sparse views including s1 and s2 may be generated based on pruning to encode/transmit data including pictures.

For example, a sparse view (s2) that is for one of multiple viewing positions (a viewpoint for s2) may be generated by pruning a center view (c0), reference view (r1) that is for a viewpoint for r1 and/or a sparse view (v2). In accordance with embodiments, pruning adds the center view (c0), and the reference view (r1) and subtracts the source view (v2) that is for a viewpoint for v2.

In accordance with embodiments, sparse views may be packed and/or encoded. For example, a sparse view (s1) and a sparse view (s2) (or including more sparse views) are packed and/or encoded.

In accordance with embodiments, the term c0 is a center viewpoint/viewing position picture, the term v1 is a first viewpoint/viewing position source view picture, the term s1 is a first viewpoint/viewing position sparse view picture, the term r1 is a first viewpoint/viewing position reference view picture, the term v2 is a second viewpoint/viewing position source view picture, the term s2 is a second viewpoint/viewing position sparse view picture and/or etc. it can be interpreted similar ways in accordance with embodiments.

In Figure, an example of encoder pre-processing scheme with pruning module is described where different types of pruning input/output are used. In the first example, the source view v1 is predicted using one reference view, called center view c0, and a sparse view s1 of viewing position v1 is produced. In the second example, the source view v2 is predicted by using multiple reference views, e.g., center view c0 and reference view v1, and a sparse view s2 is produced. After the pruning process all the pictures that should be delivered to the receiver, highlighted with red solid boundary lines in each pictures, are transferred into packing and encoding modules, sequentially.

In accordance with embodiments, a packet and/or an encoder packs pictures efficiently, for example, one or more sparse views via pruning. In accordance with embodiments a sparse view is a picture for a viewpoint including unpredictable data. The packet and/or encoder performs pruning (generates) a first sparse view based on a center view and a first source view wherein the first source view is subtracted from the center view and/or pruning (generates) a second sparse view based on the center view, a first reference view and/or the source view wherein the second sparse view is subtracted from adding the center view and the first reference view.

In accordance with embodiments, the meaning of the pruning is to remove redundancy views and generates redundancy-removed views.

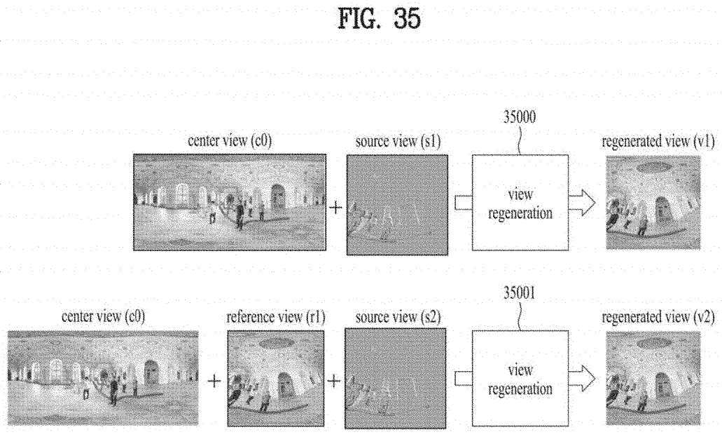

FIG. 35 is an example of decoder post-processing scheme with view generation in accordance with embodiments.

In accordance with embodiments, a decoder perform view regenerating in order to regenerate (or predict) a view(s) from received pictures.

The view regenerating (35000)(or view regenerator) generates (regenerates/predicts) a regenerated view (v1) based on a center view (c0) and a sparse view (s1). In accordance with embodiments, the center view may be transmitted from an encoder or a transmitter in accordance with embodiments. In accordance with embodiments, the center view may be generated by center view generation in accordance with embodiments as depicted in FIG. 32. In accordance with embodiment, the sparse view (v1) is transmitted via packed pictures. Therefore, the view regenerating can generate a view (v1) by using the center view (c0) and the sparse view (s1) that includes unpredictable data.

The view regenerating (35001)(or view regenerator) generates (regenerates/predicts) a regenerated view (v2) based on the center view (c0), a reference view (r1) and a sparse view (s2).

Therefore, with respect to multiple viewing position or viewpoints, views (v1, v2, . . . vN) may be (re)generated based on the center view(s), the sparse view(s) and/or the reference view(s).

In accordance with embodiments, a center view (c0) may be generated by center view generation from received reference view pictures or in accordance with embodiments a center view (c0) is included in received reference view pictures. In accordance with embodiments one or more source views (v1, v2, . . . , vN) or one or more reference views (r1, r2, . . . , rN) are included in received pictures.

In Figure, an example of decoder post-processing scheme with view generation is described where different inputs are used to regenerate views v1 and v2. In the view regeneration process, the target view is predicted by using reference view(s) and the unpredicted areas could be filled with the sparse view. Given the information of the pictures that are used in the view regeneration process, v1 is restored by a reference view c0 and a sparse view s1. In the other case, two reference pictures c0 and r1 and a sparse view are used to regenerate view v2.

A regenerated view in accordance with embodiments is regenerated by using a reference view in the un-packed pictures and unpredicted areas for the regenerated view is filled with the sparse view.

In accordance with embodiments, a decoder performs regenerating (generating) a first regenerated view based on a center view and a first sparse view wherein the center view is added to the first sparse view and/or regenerating (generating) a second regenerated view based on the center view, a first reference view and/or a second sparse view wherein the center view is added to the first reference view and the second sparse view.

In accordance with embodiments, the meaning of the regenerating is to generate/predict a view picture from other view pictures for viewpoints and/or viewing positions. In addition, the meaning of the regenerating represents a decoder in accordance with embodiments perform generating pictures or predicting pictures based on received pictures in a light of a receiver.

In accordance with embodiments, an encoder can encode and transmit pictures without redundancy data by pruning and/or etc. In accordance with embodiments, a decoder can predict views from received pictures by view regenerating and/or etc.

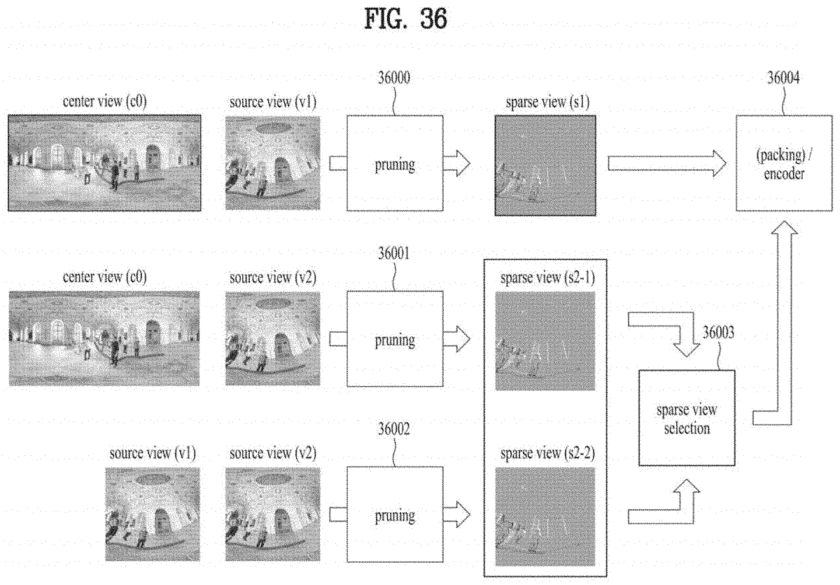

FIG. 36 is an example of encoder pre-processing scheme with pruning module and sparse view selection module in accordance with embodiments.

In accordance with embodiments, a packer and/or an encoder performs pruning and further performs sparse view selecting.

Pruning (36000)(or pruner) prunes a sparse view (s1) based on a center view (c0) and a source view (v1).

Pruning (36001)(or pruner) prunes a sparse view (s2-1) based on a center view (c0) and a source view (v2) for example the source view (v2) is subtracted from the center view (c0).

Pruning (36002)(or pruner) prunes a sparse view (s2-2) based on a source view (v1) and a source view (v2) for example the source view (v2) is subtracted from the source view (v1).

Sparse view selecting (36003)(or sparse view selector) selects a sparse view to be packed or encoded considering which a sparse view is more efficient. For example, if a sparse view (s2-1) has less valid pixels, the sparse view (s2-1) is selected and if a sparse view (s2-2) has less valid pixels, the sparse view (s2-1) is selected.

Packing (36004)(or packer) packs a sparse view (s1) or sparse view (s1) and a selected sparse view.

Regarding Replacement of Reference View:

In Figure, another example of encoder pre-processing scheme with pruning module is described with sparse view selection module. In the sparse view selection step, more data efficient sparse view, for example, a picture with less valid pixels, is selected by comparing different sparse views from different reference view combinations. In this example, source view v1 is more likely to be close view to the source view than center view, so that the sparse view s2-2 is more data efficient that s2-1.

In accordance with embodiments, a packer and/or an encoder performs pruning and further performs sparse view selecting. The pruning prunes (generates) a first sparse view based on a center view and a first source view. The pruning prunes (generates) a second sparse view based on a center view and a second source view wherein the second source view is subtracted from the center view. The pruning prunes (generates) a third sparse view based on a first source view and a second source view. In accordance with embodiments, the meaning of the pruning is to remove redundancy views and generates redundancy-removed views. The sparse view selecting selects a sparse view to be packed based on the first source view and the second source view. The sparse view selecting selects a sparse view having less valid pixels among the first source view and the second source view. The packing packs the first sparse view and the selected sparse view.

Due to the sparse view selection in accordance with embodiments, a packer in accordance with embodiments can transmit data more efficiently by packing close view data and can replace reference views which can provide effects of decreasing burden on the decoder.

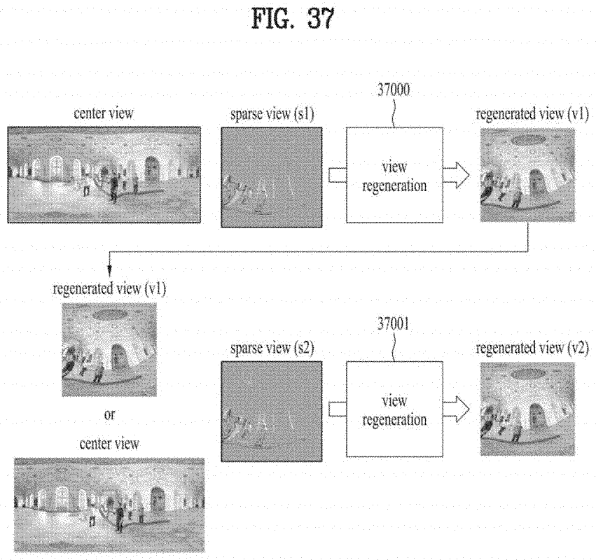

FIG. 37 is an example of efficient decoder post-processing scheme with view generation by replacing reference view with the regenerated view in accordance with embodiments.

In accordance with embodiments, a decoder (or a receiver) performs view regeneration in order to regenerate regenerated views (v1, v2, . . . etc.)

View regenerating (37000)(or view regenerator) regenerates a regenerated view (v1) based on a center view and a sparse view (s1). For example, the regenerated view (v1) may be predicted based on the center view and the sparse view (s1).

View regenerating (37001)(or view regenerating) regenerates a regenerated view (v2) based on a sparse view (s2) and at least one of the regenerated view (r1) or the center view.

Replacement of Reference View:

In Figure, another example of decoder post-processing scheme with view generation is described. When view v1 is indicated as the reference view of the regenerated view v2, the regenerated view v1 could be used as the reference view for the regeneration of v2. By using this approach, the data size that is occupied to deliver reference view v1 could be reduced.

In accordance with embodiments, regenerating generates a first regenerated view based on the center view and a first sparse view from the un-packed pictures, and further generates a second regenerated view based on at least one of the first regenerated view or the center view and a second sparse view from the un-packed pictures.

Due to using a regenerated view for a first viewpoint (or a first viewing position) when regenerating a regenerated view for a second viewpoint (or a second viewing position), a decoder in accordance with embodiments can regenerate data more precisely and efficiently and replace reference views which can provide effects of decreasing burden on the decoder.

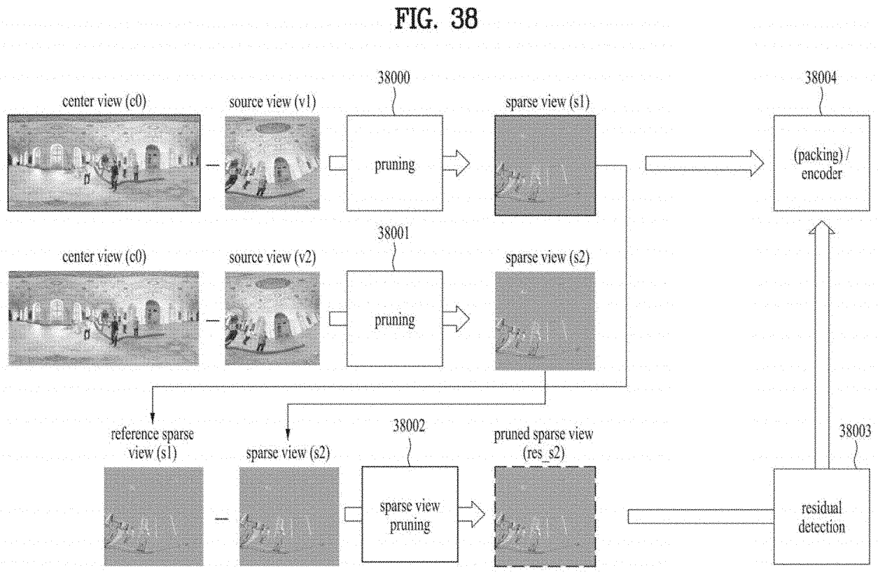

FIG. 38 is an example of encoder pre-processing scheme with pruning module and sparse view pruning in accordance with embodiments.

In accordance with embodiments, an encoder performs pruning, sparse view pruning, residual detecting and/or (packing)encoding.

Pruning (38000)(or pruner) prunes (generates) a sparse view (s1) based on a center view (c0) and a source view (v1). For example, the sparse view (s1) is generated by subtracting the source view (v1) from the center view (c0).

Pruning (38001)(or pruner) prunes a sparse view (s2) based on a center view (c0) and a source view (v2). For example, the sparse view (s2) is generated by subtracting the source view (v2) from the center view (c0).

In accordance with embodiments, Sparse view pruning (38002)(or sparse view pruner) a pruned sparse view (res_s2) based on a reference sparse view (s1) that is the sparse view (s1) generated by the pruning and a sparse view (s2) that is the sparse view (s2) generated by the pruning. For example, the pruned sparse view (res_s2) is generated by subtracting the sparse view (s2) from the reference sparse view (s1).

Residual detecting (38003)(or residual detector) detects residual information in the pruned sparse view (res_s2) in order to determine whether or not the pruned sparse view (res_s2) is packed/encoded.

Packing/encoding (38004)(or a packet/encoder) packs/encodes the sparse view (s1) or the sparse view and the pruned sparse view (res_s2) when the pruned sparse view (res_s2) has data that is useful to encode.

Sparse view Regeneration:

In Figure, an example of encoder pre-processing scheme with pruning module is described with the additional step called sparse view pruning. In this step, the sparse view of one view is compared with the reference sparse views and the redundancy between the sparse views are removed so that only the residual or remaining data that only depends on the sparse view s2 is delivered by pruned sparse view res_s2. If the sparse views s1 and s2 are highly correlated so that one can be estimated from the other, the remaining data in the pruned sparse view res_s2 is very small and it could be assumed to be noise of less useful data. In this case, the data is determined not to be delivered receiver and this is determined by the residual detection module. By using sparse view pruning and residual detection processes, the redundancy remained in the sparse view are removed so that the efficiency of the data is increased.

In accordance with embodiments, an encoder performs pruning, sparse view pruning, residual detecting and/or (packing)encoding. The pruning prunes (generates) a first sparse view based on a center view and a first source view. For example, the first sparse view is generated by subtracting the first source view from the center view. The pruning prunes (generates) a second sparse view based on a center view and a second source view. For example, the second sparse view is generated by subtracting the second source view from the center view. In accordance with embodiments, the sparse view pruning prunes (generates) a first pruned sparse view based on a first reference sparse view that is the first sparse view generated by the pruning and a second sparse view that is the second sparse view generated by the pruning. For example, the first pruned sparse view is generated by subtracting the second sparse view from the first reference sparse view. The residual detecting detects residual information in the first pruned sparse view wherein whether or not the first pruned sparse view is packed/encoded is determined. The packing/encoding packs/encodes the first sparse view or the first sparse view and the first pruned sparse view when the first pruned sparse view has data.

Due to the sparse view pruning in accordance with embodiments, an encoder in accordance with embodiments packs sparse views more efficiently by using the sparse view pruning and the residual detection in accordance with embodiments so that a decoder in accordance with embodiments regenerates and synthesizes a view by using the received sparse views more efficiently and precisely.

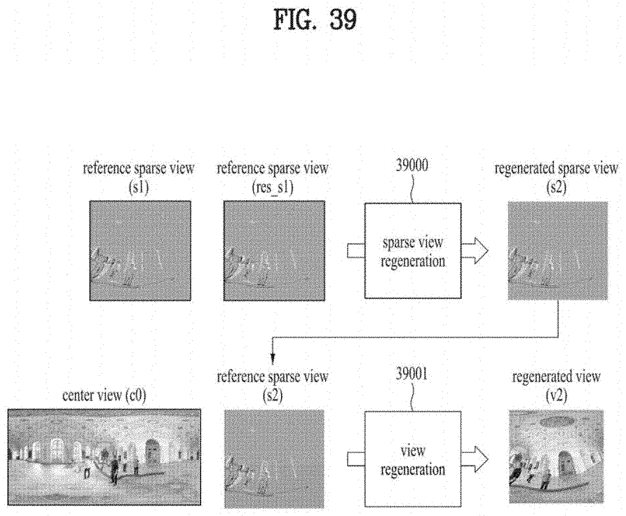

FIG. 39 is an example of decoder post-processing scheme with view regeneration and sparse view regeneration in accordance with embodiments (sparse_view_regeneration_type=1).

In accordance with embodiments, a decoder performs sparse view regeneration and/or view regeneration.

Sparse view regenerating (39000)(or sparse view regenerator) generates (predicts) a regenerated sparse view (s2) based on a reference sparse view (s1) and a pruned sparse view (res_s1) in accordance with embodiments. In a light of the regenerated sparse view (s2) (for a second viewpoint/viewing position), the reference sparse view (s1)(for a first viewpoint/viewing position) can be reference view. For example, a sparse view regenerator in accordance with embodiments regenerates a sparse view from received sparse views in packed pictures in response to sparse view regeneration type information.

View regenerating (39001)(or view regenerator) generates a regenerated view (v2) based on a center view (c0) and the regenerated sparse view (s2). In accordance with embodiments the center view is transmitted or generated in a decoder by using reference views. The regenerated view (v2) may be (re)generated by using the center view and/or the regenerated sparse view.

Sparse View Regeneration:

In Figures in accordance with embodiments, examples of decoder post-processing scheme with view regeneration and sparse view regeneration are described for the different sparse_view_regeneration_type values (as depicted in FIG. 24. This can be referred to as signaling information or sparse view regeneration type information).

When sparse_view_regeneration_type=1, the sparse view s2 is regenerated by using both reference sparse view and pruned sparse view from the decoded or unpacked pictures. When the sparse view s2 is regenerated, the view v2 is regenerated by using the reference view, in this case center view c0, and the sparse view, in this case regenerated sparse view s2. In FIG. 16, the decoder post-processing is described for sparse_view_regeneration_type=1, where the sparse view generation is precedent to the view generation in case of the view v2 regeneration.

An apparatus in accordance with embodiments performs regenerating a regenerated sparse view based on a reference sparse view and a pruned sparse view from the un-packed pictures, and/or regenerating a regenerated view based on the center view and the regenerated sparse view based on signaling information related to sparse views.

Therefore, due to signaling information and an encoder processing related to sparse views, a receiver or a decoder in accordance with embodiments can generate regenerated views by using the signaling information and sparse view operations.

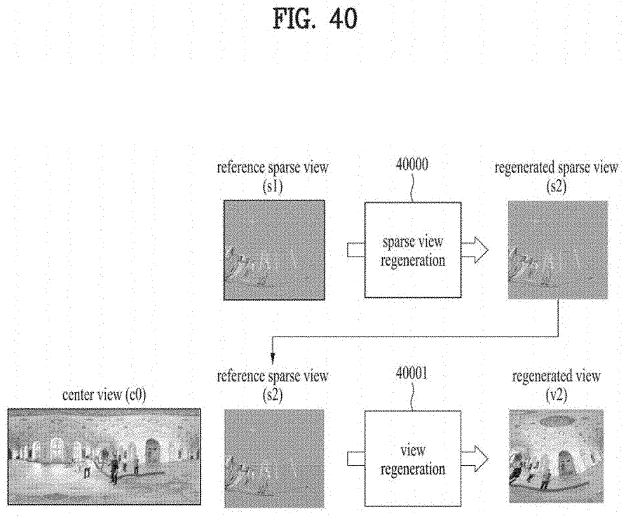

FIG. 40 is an example of decoder post-processing scheme with view regeneration and sparse view regeneration in accordance with embodiments (sparse_view_regeneration_type=2).

In accordance with embodiments, a decoder performs sparse view regenerating and/or view regenerating.

Sparse view regenerating (40000)(or sparse view regenerator) generates a regenerated sparse view (s2) based on a reference sparse view (s1). In accordance with embodiments, reference sparse views (e.g., s1, s3, etc.) can be used to generate a regenerated sparse view (s2) in the sparse view regeneration. In accordance with embodiments, using a single reference sparse view may be the best case. In accordance with embodiments, signaling information related to sparse views may be used in the sparse view regeneration.

View regenerating (400001)(or view regenerator) generates a regenerated view (v2) based on a center view (c0) and the regenerated sparse view (s2) in accordance with embodiments.

Sparse View Regeneration:

In Figure, examples of decoder post-processing scheme with sparse view regeneration for sparse_view_regeneration_type=2 is described. In this case, pruned sparse view is not present in the decoded or unpacked pictures so the sparse view s2 is predicted or estimated only from the reference sparse view s1. After the sparse view s2 is regenerated (or estimated), the view v2 is regenerated by using the reference view, in this example center view c0, and the sparse view, in this example regenerated sparse view s2. As shown in the FIG. 17, the sparse view generation is precedent to the view generation in case of the view v2 regeneration.

An apparatus in accordance with embodiments perform regenerating a regenerated sparse view based on a reference sparse view from the un-packed pictures, and/or regenerating a regenerated view based on the regenerated sparse view and the center view.

Embodiments can provide effects of regenerating a final view by using just reference views including sparse views and/or a center view.

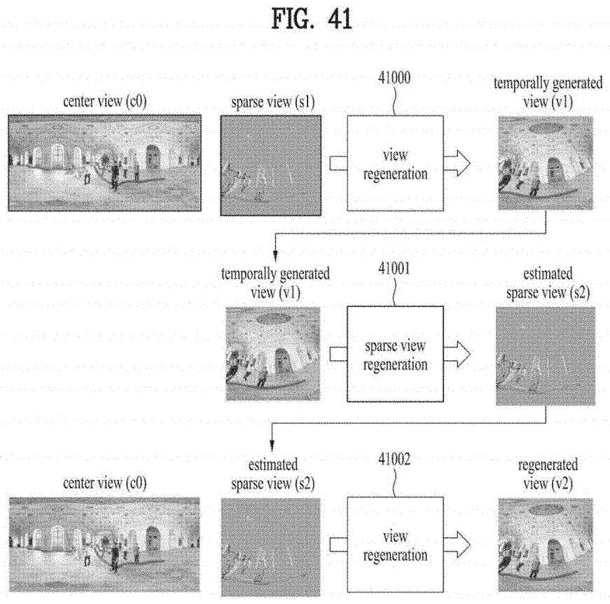

FIG. 41 is an example of decoder post-processing scheme with view regeneration and sparse view regeneration in accordance with embodiments (sparse_view_regeneration_type=3).

In accordance with embodiments, a decoder or a receiver performs view regeneration, sparse view regeneration and/or view regeneration.

View regenerating (41000)(or view regenerator) generates a temporally generated view (v1) based on a center view (c0) and a sparse view (s1). In accordance with embodiments a temporally generated view is a view picture to be used for sparse view regeneration temporally in accordance with embodiments.

Sparse view regenerating (41001)(or sparse view regenerator) generates an estimated sparse view (s2) based on the temporally generated view (v1). In accordance with embodiments, instead of using a received sparse view (s2), a (estimated) sparse view (s2) is generated by regenerating the center view (c0), the sparse view (s1), the temporally generated view (v1).

View regenerating (41002)(or view regenerator) generates a regenerated view (v2) based on the center view (c0) and the estimated sparse view (s2). The regenerated view (v2) is generated by using the center view (c0) and the sparse view (s1).

Sparse View Regeneration:

In Figure, other example of decoder post-processing scheme with sparse view regeneration for sparse_view_regeneration_type=3 is described. In this case, pruned sparse view is not present in the decoded or unpacked pictures so the sparse view s2 is predicted or estimated only from the reference sparse view s1. Different from the case sparse_view_regeneration_type=2, the sparse view regeneration uses the temporally regenerated view v1 to estimate sparse view s2. For this case, the whole view v1 might not be needed as view regeneration of v2 only need information that could not be predicted from the reference view. Therefore, the sparse view generation of estimated sparse view s2 could be included in the view regeneration process. After the sparse view s2 is regenerated (or estimated), the view v2 is regenerated by using the reference view, in this example center view c0, and the sparse view, in this example regenerated sparse view s2. As shown in the FIG. 18, the sparse view generation is precedent to the view generation in case of the view v2 regeneration.

An apparatus in accordance with embodiments performs regenerating a temporally generated view based on the center view and a sparse view from the un-packed pictures, regenerating an estimated sparse view based on the temporally generated view, and/or regenerating a regenerated view based on the estimated sparse view and the center view.

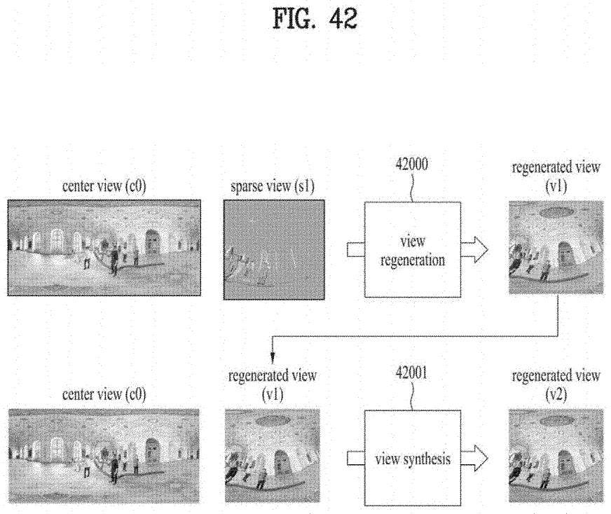

FIG. 42 is an example of decoder post-processing scheme with view regeneration and sparse view regeneration in accordance with embodiments (sparse_view_regeneration_type=4).

In accordance with embodiments, a decoder performs view regeneration and/or view synthesis.

View regenerating (42000)(or view regenerator) generates a regenerated view (v1) based on a center view (c0) and a sparse view (s1).

The view synthesizing (42001)(or view synthesizer) synthesizes a regenerated view (v2) based on a center view (c0) and the regenerated view (v1). In accordance with embodiments, the view synthesis generates a view for a new viewpoint or a target viewpoint.

Sparse View Regeneration:

In Figure, other example of decoder post-processing scheme with sparse view regeneration for sparse_view_regeneration_type=4 is described. In this case, pruned sparse view is not present in the decoded or unpacked pictures so the sparse view prediction is not used but regenerates the view v2 by the view synthesis process from the center view and regenerated view v1.

An apparatus in accordance with embodiments performs: regenerating a regenerated view based on the center view and a sparse view from the un-packed pictures, and/or synthesizing a regenerated view based on the center view and the regenerated view.

Due to embodiments, an apparatus can efficiently generates (synthesizes) a target view by using generating a center view, regenerating one or more view (v1, v2, etc.) that uses the center view, one or more reference views (r1, r2, etc.) and/or one or more sparse views (s1, s2, etc.), regenerating one or more sparse views and/or estimating one or more sparse views with efficient and precise minimum pictures required.

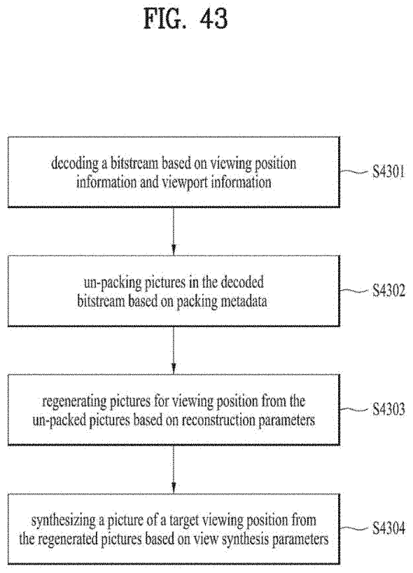

FIG. 43 is a flowchart in accordance with embodiments.

A method for receiving a video in accordance with embodiments includes (S4301) decoding a bitstream based on viewing position information and viewport information, (S4302) un-packing pictures in the decoded bitstream based on packing metadata, (S4303) regenerating pictures for viewing position from the un-packed pictures based on reconstruction parameters, and/or (S4304) synthesizing a picture of a target viewing position from the regenerated pictures based on view synthesis parameters.

A method for receiving a video in accordance with embodiments is performed as depicted in FIGS. 23 and 26, 28, 30, 32, 33, 35, 36, 39 and/or 40-42 etc.

A method for receiving a video in accordance with embodiments uses signaling information in accordance with embodiments including FIGS. 24 and 25.

In accordance with embodiments, an encoder may be referred to as a transmitter to encode video data and/or signaling information in accordance with embodiments. The encoder may be interpreted on the ground of some embodiments of the disclosure and can provide effects of efficient encoding performance and transmitting performance.

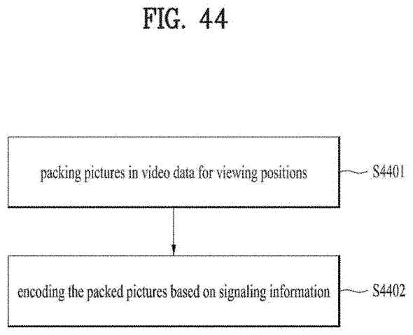

FIG. 44 is a flowchart in accordance with embodiments.

A method for transmitting a video in accordance with embodiments includes (S4401) packing pictures in video data for viewing positions and/or (S4402) encoding the packed pictures based on signaling information.

A method for transmitting a video in accordance with embodiments is performed as depicted in FIGS. 23 and 27, 29, 31, 33, 34, 38 etc.

A method for transmitting a video in accordance with embodiments uses signaling information in accordance with embodiments including FIGS. 24 and 25.

In accordance with embodiments, each block is explained as a hardware, a software and/or a processor.

The various elements of some apparatus in accordance with embodiments are implemented in hardware, software, firmware or a combination thereof. The various elements of some apparatus are implemented on a single chip such as a hardware circuit. In some embodiments, they are, optionally, implemented on separate chips. In some embodiments, at least one of the elements of the XR device may be constructed in one or more processors capable of executing one or more programs including instructions of performing or causing performance of the operations of any of the methods described herein.

It will also be understood that, although the terms first, second, etc. are, in some instances, used herein to describe various elements, these elements should not be limited by these terms. These terms are only used to distinguish one element from another.

The terminology used in the description of the various described embodiments herein is for the purpose of describing particular embodiments only and is not intended to be limiting. As used in the description of the various described embodiments and the appended claims, the singular forms (a), (an) and (the) are intended to include the plural forms as well, unless the context clearly indicates otherwise. It will also be understood that the term (and/or) as used herein refers to and encompasses any and all possible combinations of one or more of the associated listed items. It will be further understood that the terms (includes) (including) (comprises) and/or (comprising) when used in this specification, specify the presence of stated features, integers, steps, operations, elements, and/or components, but do not preclude the presence or addition of one or more other features, integers, steps, operations, elements, components, and/or groups thereof.

As used herein, the term (if) is, optionally, construed to mean (when) or (upon) or (in response to determining) or (in response to detecting) depending on the context. Similarly, the phrase (if it is determined) or (if [a stated condition or event] is detected) is, optionally, construed to mean (upon determining) or (in response to determining) or (upon detecting [the stated condition or event]) or (in response to detecting [the stated condition or event]) depending on the context. Similarly, the phrase (when it is determined) or (when [a stated condition or event] is detected) is, optionally, construed to mean (upon determining) or (in response to determining) or (upon detecting [the stated condition or event]) or (in response to detecting [the stated condition or event]) depending on the context.

In this document, the term (/) and (,) should be interpreted to indicate (and/or) For instance, the expression (A/B) may mean (A and/or B) Further, (A, B) may mean (A and/or B) Further, (A/B/C) may mean (at least one of A, B, and/or C) Also, (A/B/C) may mean (at least one of A, B, and/or C.)

Further, in the document, the term (or) should be interpreted to indicate (and/or). For instance, the expression (A or B) may comprise 1) only A, 2) only B, and/or 3) both A and B. In other words, the term (or) in this document should be interpreted to indicate (additionally or alternatively).

The apparatus for transmitting a video, the apparatus for receiving a video according to embodiments and/or internal modules/blocks thereof may perform the above-described embodiments.

A description will be given of the apparatus and/or the method according to embodiments

The internal blocks/modules, etc. of the apparatus and/or the method described above may correspond to processors that execute continuous operations stored in a memory, or hardware elements positioned inside/outside the apparatuses according to a given embodiment, or software elements.

The above-described modules may be omitted according to a given embodiment or replaced by other modules that perform similar/the same operations.

Although the description is explained with reference to each of the accompanying drawings for clarity, it is possible to design new embodiment(s) by merging the embodiments shown in the accompanying drawings with each other. And, if a recording medium readable by a computer, in which programs for executing the embodiments mentioned in the foregoing description are recorded, is designed in necessity of those skilled in the art, it may belong to the scope of the appended claims and their equivalents.

An apparatus and method according embodiments may be non-limited by the configurations and methods of the embodiments mentioned in the foregoing description. And, the embodiments mentioned in the foregoing description can be configured in a manner of being selectively combined with one another entirely or in part to enable various modifications.

In addition, a method according to embodiments can be implemented with processor-readable codes in a processor-readable recording medium provided to a network device. The processor-readable medium may include all kinds of recording devices capable of storing data readable by a processor. The processor-readable medium may include one of ROM, RAM, CD-ROM, magnetic tapes, floppy discs, optical data storage devices, and the like for example and also include such a carrier-wave type implementation as a transmission via Internet. Furthermore, as the processor-readable recording medium is distributed to a computer system connected via network, processor-readable codes can be saved and executed according to a distributive system.

It will be appreciated by those skilled in the art that various modifications and variations can be made in embodiments without departing from the scope of the inventions. Thus, it is intended that embodiments covers the modifications and variations of this invention provided they come within the scope of the appended claims and their equivalents.

Both apparatus and method inventions are mentioned in this specification and descriptions of both of the apparatus and method inventions may be complementarily applicable to each other.

It will be apparent to those skilled in the art that various modifications and variations can be made in embodiments without departing from the spirit or scope of the inventions. Thus, it is intended that embodiments covers the modifications and variations of this invention provided they come within the scope of the appended claims and their equivalents.

While embodiments has been described and illustrated herein with reference to the preferred embodiments thereof, it will be apparent to those skilled in the art that various modifications and variations can be made therein without departing from the spirit and scope of the invention. Thus, it is intended that embodiments covers the modifications and variations of this invention that come within the scope of the appended claims and their equivalents.

### MODE FOR INVENTION

Various embodiments have been described in the best mode for carrying out the invention.

### INDUSTRIAL APPLICABILITY

The present invention is available in a series of VR fields.

1. An apparatus for receiving a video, the apparatus comprising:
a decoder configured to decode a bitstream based on viewing position information and viewport information;
an un-packer configured to un-pack pictures in the decoded bitstream based on packing metadata;
a view regenerator configured to regenerate pictures for viewing position from the un-packed pictures based on reconstruction parameters; and
a view synthesizer configured to synthesize a picture of a target viewing position from the regenerated pictures based on view synthesis parameters.

2. The apparatus of claim 1, the view regenerator further performs:
generating a center view from a reference view in the un-packed pictures based on center view generation information in the viewing position information; and
regenerating a regenerated view from the center view and a sparse view in the un-packed pictures.

3. The apparatus of claim 2,
wherein the regenerated view is regenerated by using a reference view in the un-packed pictures and unpredicted areas for the regenerated view is filled with the sparse view.

4. The apparatus of claim 2,
wherein the regenerating generates a first regenerated view based on the center view and a first sparse view from the un-packed pictures, and
further generates a second regenerated view based on at least one of the first regenerated view or the center view and a second sparse view from the un-packed pictures.

5. The apparatus of claim 2, the apparatus further performs:
regenerating a regenerated sparse view based on a reference sparse view and a pruned sparse view from the un-packed pictures, and
regenerating a regenerated view based on the center view and the regenerated sparse view.

6. The apparatus of claim 2, the apparatus further performs:
regenerating a regenerated sparse view based on a reference sparse view from the un-packed pictures, and
regenerating a regenerated view based on the regenerated sparse view and the center view.

7. The apparatus of claim 2, the apparatus further performs:
regenerating a temporally generated view based on the center view and a sparse view from the un-packed pictures,
regenerating an estimated sparse view based on the temporally generated view, and
regenerating a regenerated view based on the estimated sparse view and the center view.

8. The apparatus of claim 2, the apparatus further performs:
regenerating a regenerated view based on the center view and a sparse view from the un-packed pictures, and
synthesizing a regenerated view based on the center view and the regenerated view.

9. A method for receiving a video, the method comprising:
decoding a bitstream based on viewing position information and viewport information;
un-packing pictures in the decoded bitstream based on packing metadata;
regenerating pictures for viewing position from the un-packed pictures based on reconstruction parameters; and
synthesizing a picture of a target viewing position from the regenerated pictures based on view synthesis parameters.

10. The method of claim 9, the method further comprising:
generating a center view from a reference view in the un-packed pictures based on center view generation information in the viewing position information; and
regenerating a regenerated view from the center view and a sparse view in the un-packed pictures.

11. An apparatus for transmitting video data, the apparatus comprising:
a packer configured to pack pictures in video data for viewing positions;
an encoder configured to encode the packed pictures based on signaling information.

12. The apparatus of claim 11,
wherein the apparatus further comprising a pre-processor performing:
generating a center view picture from the video data for the viewing positions and center view generation information,
synthesizing an intermediate view picture from the video data and generating pre-regeneration information,
pruning redundancy between the center view, a source view picture or an intermediate view picture, the redundancy-pruned pictures including sparse view pictures,
sparse view pruning redundancy between the sparse view pictures and generating sparse view regeneration information,
packing the pruned sparse view picture,
encoding the packed pictures, the center view generation information, the pre-regeneration information and the sparse view regeneration information.

13. A method for transmitting a video, the method comprising:
packing pictures in video data for viewing positions;
encoding the packed pictures based on signaling information.

14. The method of claim 13, the method further comprising:
generating a center view picture from the video data for the viewing positions and center view generation information,
synthesizing an intermediate view picture from the video data and generating pre-regeneration information,
pruning redundancy between the center view, a source view picture or an intermediate view picture, the redundancy-pruned pictures including sparse view pictures,
sparse view pruning redundancy between the sparse view pictures and generating sparse view regeneration information,
packing the pruned sparse view picture,
encoding the packed pictures, the center view generation information, the pre-regeneration information and the sparse view regeneration information.
